(19) United States
(12) Patent Application Publication
(10) Pub. No.: US 2024/0412598 A1
(43) Pub. Date: Dec. 12, 2024

(54) METHOD AND SYSTEM FOR CONDUCTING A SECONDARY GAME BASED ON AN UNDERLYING, BINGO BASED PRIMARY GAME

(71) Applicant: CASTLE ISLAND IP HOLDING LLC, Charlottesville, VA (US)

(72) Inventors: Daniel FULTON, Charlottesville, VA (US); Alan ROIREAU, Charlottesville, VA (US); Jason SPRINKLE, Charlottesville, VA (US); Barry SCOTT, Charlottesville, VA (US); Daniel MILLIGAN, Charlottesville, VA (US); Thomas ZAHORIK, Charlottesville, VA (US); Joshua LARSON, Charlottesville, VA (US); Paul SUGGS, Charlottesville, VA (US)

(21) Appl. No.: 18/735,860

(22) Filed: Jun. 6, 2024

Related U.S. Application Data
(60) Provisional application No. 63/471,354, filed on Jun. 6, 2023.
(60) Provisional application No. 63/520,758, filed on Aug. 21, 2023.
(60) Provisional application No. 63/590,972, filed on Oct. 17, 2023.
(60) Provisional application No. 63/602,905, filed on Nov. 27, 2023.
(60) Provisional application No. 63/520,753, filed on Aug. 21, 2023.
(60) Provisional application No. 63/583,453, filed on Sep. 18, 2023.
(60) Provisional application No. 63/632,120, filed on Apr. 10, 2024.

(51) Int. Cl. G07F 17/32

(52) U.S. Cl. CPC G07F 17/3267; G07F 17/3211; G07F 17/3262

(57) ABSTRACT

Improved gaming systems, machines, and methods are provided enabling variable gameplay using a primary game underlying a secondary game. A gaming machine includes a display device configured to display an output to a user, an input device configured to accept a wager from the user for a primary game, the primary game being based on a bingo game, a processor coupled to a memory, the input device and the display device. The gaming machine is configured to provide a secondary game to the user, receive an input from the user for the secondary game and convert the user input to the wager for the primary game, determine a result of the wager for the primary game, and provide an output of the secondary game to the user corresponding to the result of the wager.

### CROSS-REFERENCE TO RELATED APPLICATIONS

This application further claims the benefit of and priority to U.S. Provisional Patent Application Ser. No. 63/471,354 filed on 6 Jun. 2023, U.S. Provisional Patent Application Ser. No. 63/520,758 filed on 21 Aug. 2023, U.S. Provisional Patent Application Ser. No. 63/590,972 filed on 17 Oct. 2023, and U.S. Provisional Patent Application Ser. No. 63/602,905 filed on 27 Nov. 2023, which applications are each expressly incorporated herein by reference in their entirety.

This application further claims the benefit of and priority to U.S. Provisional Patent Application Ser. No. 63/520,753 filed on 21 Aug. 2023, U.S. Provisional Patent Application Ser. No. 63/583,453 filed on 18 Sep. 2023, and U.S. Provisional Patent Application Ser. No. 63/632,120 filed on 10 Apr. 2024, which applications are each expressly incorporated herein by reference in their entirety.

### FIELD OF THE DISCLOSURE

The field of the disclosure relates generally to gameplay stations, wagering terminals, and gaming servers, including gaming consoles, gaming machines or networked gaming machines, such as gameplay stations, wagering terminals, and gaming servers found in casinos or betting environments, and related methods of operation.

### BACKGROUND

Within the gambling or gaming industry, including sports betting, esports betting, games of chance, etc., traditional gaming machines include slot machines, poker machines, video lottery terminals, gaming consoles, and similar devices. These traditional gaming machines are configured to provide an interface for wagering on game events and have proven popularity. However, players quickly become tired of various adaptations of existing gaming machines, requiring the development of new and inventive ways to represent or play games on such gaming machines. For this reason, game creators must continually invent new and innovative ways to represent games and gameplay to stimulate players and encourage further interest.

Gaming in the United States is generally categorized into class I, class II and class III for the purposes of regulation, with class I gaming being defined as traditional tribal gaming subject to the least regulation, and class III gaming being subject to the greatest regulation and broadly encompassing all forms of gaming that are neither class I or II (e.g. casino or table games such as slot machines, blackjack, craps, roulette, etc.).

Class II gaming includes the game commonly referred to as bingo, whether or not electronic, computer, or other technological aids are used in connection with the game. In traditional bingo, players purchase cards that include different arrangements of tokens, such as numbers or other symbols, in a grid or other pattern. A caller randomly selects tokens from a token pool and players match the called tokens to their cards. When the matched tokens on a player's card form certain predetermined patterns or arrangements, such as a line, only corners, a completely filled card or other arrangement, the card may be identified as a winning card and scored accordingly, such that a corresponding reward or prize may be disbursed. A number of winning arrangements may be possible, such that a winning card may or may not conclude the game.

The distinction of bingo as class II gaming has two primary implications in the gaming industry. First, class II gaming presents the advantage of less restrictive regulation relative to class III (e.g. slot machines, blackjack, craps, roulette, etc.), allowing for broader accessibility and/or distribution of related gaming systems. Second, while historically popular on its own merit, the expansion of class II gaming, or more specifically bingo, is hampered due to the restrictive definition of class II gaming limiting innovation in gameplay relative to class III gaming. For example, while class III gaming essentially covers all non-tribal and non-bingo games and allows for infinite variations in gameplay, odds, and associated gaming strategies, class II gaming is required to be based on a bingo game, such as including a bingo card and a bingo call, even if only underlying the game.

Unfortunately, despite the modernization of several aspects of class II gaming, further expansion of class II gaming is limited by regulatory constraints based on traditional aspects of bingo, such that the features of class III gameplay preferred by many players are simply not available in class II.

In view of the foregoing, there is a need for improved gaming systems and methods that improve availability and variability of class II games without losing the regulatory advantages associated with class II gaming. There is further a need for gaming systems and methods that enable the creation of new forms of gameplay for class II games, without increasing the processing requirements of a gaming terminal or gaming systems.

### SUMMARY

The embodiments disclosed herein are directed to providing improved gaming systems and methods that address the problems above and enable an advantage of separating features of a wager from a gameplay experience. The embodiments may be employed to facilitate class II gaming, including bingo games or keno games, by adapting the result of the class II games to class III style gameplay.

A gaming system for conducting a secondary game based on an underlying, bingo game based primary game is provided comprising a display device configured to display an output to a user, an input device configured to accept a wager from the user for a primary game, the primary game being based on a bingo game, and a processor coupled to a memory, the input device and the display device. The gaming system may be configured to provide a secondary game to the user, receive an input from the user for the secondary game and convert the user input to the wager for the primary game, determine a result of the wager for the primary game, and provide an output of the secondary game to the user corresponding to the result of the wager.

A method for conducting a secondary game based on an underlying, bingo game based primary game is provided comprising providing a primary game to a gaming machine, providing a secondary game to a user at the gaming machine, receiving an input from the user for the secondary game and converting the user input to a wager for the primary game, determining a result of the wager for the primary game, and providing an output of the secondary game to the user corresponding to the result of the wager.

These and other features of the disclosure will become better understood by reference to the following description, appended claims, and accompanying drawings.

### BRIEF DESCRIPTION OF THE DRAWINGS

FIG. 1 is a perspective view of a gaming machine according to the present disclosure.

FIG. 2A is a diagrammatic view of an electronic system of a gaming machine according to the present disclosure.

FIG. 2B is a diagrammatic view of a gaming system according to the present disclosure.

FIG. 3 is a diagrammatic view of a gaming system according to the present disclosure.

FIG. 4 is an illustration of a primary game according to an embodiment of the present disclosure.

FIG. 5A is an illustration of a primary game according to an embodiment of the present disclosure.

FIG. 5B is an illustration of patterns for a result index of a primary game according to an embodiment of the present disclosure.

FIG. 5C is an illustration of patterns for a result index of a primary game according to an embodiment of the present disclosure.

FIG. 6A is an illustration of a primary game and a secondary game according to an embodiment of the present disclosure.

FIG. 6B is an illustration of a secondary game according to an embodiment of the present disclosure.

FIG. 6C is an illustration of patterns for a result index of a primary game according to an embodiment of the present disclosure.

FIG. 6D is an illustration of patterns for a result index of a primary game according to an embodiment of the present disclosure.

FIG. 6E is an illustration of a final result of a result index for a primary game according to an embodiment of the present disclosure.

FIG. 7 is an illustration of a result index including a pattern and a sub-pattern for a primary game according to an embodiment of the present disclosure.

FIG. 8 is an illustration of a result index including a pattern and an anti-pattern for a primary game according to an embodiment of the present disclosure.

FIG. 9 is an illustration of a card or a final result of a result index including a hot spot for a primary game according to an embodiment of the present disclosure.

FIG. 10 is a diagram of a gaming system conducting a primary game and a secondary game according to an embodiment of the present disclosure.

FIG. 11 is an illustration of a primary game for underlying a secondary game of poker according to an embodiment of the present disclosure.

FIG. 12 is an illustration of a player pattern and a winning pattern of a result index according to the embodiment of FIG. 11.

FIG. 13 is an illustration of a primary game for underlying a secondary game of poker with multiple players according to an embodiment of the present disclosure.

FIG. 14 is an illustration of a primary game for underlying a secondary game of poker with multiple players and a common ball call according to an embodiment of the present disclosure.

FIG. 15 is an illustration of player patterns according to the embodiment of FIG. 14.

FIG. 16A is an illustration of a card or a final result of a result index including a hot spot for a primary game according to an embodiment of the present disclosure.

FIG. 16B is an illustration of a primary game for underlying a secondary game of roulette with a hot spot for the primary game according to an embodiment of the present disclosure.

FIGS. 17A-17D include illustrations of a secondary game of blackjack having an additional poker hand pay table according to the present disclosure.

FIG. 18 includes an illustration of a secondary game of blackjack having a secondary attribute of a bonus spot on a backside according to the present disclosure.

FIG. 19 includes an illustration of a secondary game of keno having a secondary attribute of a bonus pattern pay in a pay table according to the present disclosure.

FIGS. 20A-20C include illustrations of a secondary game of keno having a secondary attribute of a cumulative bonus pattern pay according to the present disclosure.

FIG. 21 includes an illustration of a secondary game of roulette having multiple bet options corresponding to multiple bingo cards in an underlying primary game of bingo.

FIG. 22 illustrates two stacked or aligned bingo cards according to the embodiment of FIG. 21.

FIG. 23 illustrates bingo card packs according to the present disclosure.

FIG. 24 illustrates a multiplayer secondary game of blackjack based on an underlying primary game of bingo using bingo card packs according to the present disclosure.

FIGS. 25A and 25B illustrate gameplay for a first player according to the embodiment of FIG. 24.

FIGS. 26A, 26B and 26C illustrate gameplay for a second player according to the embodiment of FIG. 24.

FIGS. 27A and 27B include illustrations of a secondary game of blackjack including a secondary attribute of a joker card according to the present disclosure.

FIG. 28 illustrates a secondary game of blackjack including a secondary attribute of a joker card according to the present disclosure.

FIG. 29 illustrates a secondary game having a ball draw according to the present disclosure.

FIG. 30 illustrates a secondary game having a ball draw with an underlying primary game according to the present disclosure.

FIG. 31 illustrates a secondary game having a ball draw with an underlying primary game according to the present disclosure.

FIG. 32 illustrates an example of a secondary game of blackjack with an underlying primary game according to the present disclosure.

FIG. 33 illustrates an example of a secondary game of blackjack with an underlying primary game according to the present disclosure.

FIG. 34 illustrates an example of a secondary game of blackjack with an underlying primary game according to the present disclosure.

FIG. 35 illustrates an example of a secondary game of blackjack with an underlying primary game according to the present disclosure.

FIG. 36 illustrates an example of a secondary game of blackjack with an underlying primary game according to the present disclosure.

FIG. 37 illustrates an example of a secondary game of blackjack with an underlying primary game according to the present disclosure.

FIG. 38 illustrates an example of a secondary game of roulette with an underlying primary game according to the present disclosure.

FIG. 39 illustrates an example of a secondary game of blackjack with an underlying primary game having insurance according to the present disclosure.

FIG. 40 illustrates an example of a primary game having insurance according to the present disclosure.

FIG. 41 illustrates an example of a primary game having insurance according to the present disclosure.

FIG. 42 illustrates an example of a primary game having subtractive patterns according to the present disclosure.

FIG. 43 illustrates an example of a primary game having undaubs/dedaubs according to the present disclosure.

FIG. 44 illustrates a secondary game having a wheel with an underlying primary game according to the present disclosure.

FIG. 45 illustrates a secondary game having a wheel with an underlying primary game according to the present disclosure.

FIG. 46 illustrates a primary game of bingo with a ball call having supplemental states according to the present disclosure.

FIG. 47 illustrates a primary game of bingo with a ball call having supplemental states according to the present disclosure.

FIG. 48 illustrates a secondary game of roulette with an underlying primary game according to the present disclosure.

FIGS. 49A, 49B, 49C, 49D, 49E, and 49F are illustrations of a bingo card of embodiments of bingo games according to embodiments of the present disclosure.

FIG. 50 is an illustration of a variation of a bingo game including wildcard daubs according to embodiments of the present disclosure.

FIGS. 51A and 51B illustrate further embodiments of bingo games with an additional card according to embodiments of the present disclosure.

FIG. 52 is an illustration of a bingo game and variations including daubs of differing values according to embodiments of the present disclosure.

FIG. 53 illustrates a bingo game and variations having layered cards according to embodiments of the present disclosure.

FIG. 54 is an illustration of a bingo game and variations having alternate free space patterns according to embodiments of the present disclosure.

FIG. 55 is another illustration of a bingo game including movable daubs are applied according to embodiments of the present disclosure.

FIG. 56 is another illustration of a bingo game including anticipatory markers according to embodiments of the present disclosure.

FIG. 57 is another illustration of a bingo game including variations with multiple cards that, when combined, form an image to complete a win according to embodiments of the present disclosure.

The figures are not necessarily drawn to scale, but instead are drawn to provide a better understanding of the components, and are not intended to be limiting in scope, but to provide exemplary illustrations. The figures illustrate exemplary configurations of a system and method for gaming, and in no way limit the structures, configurations, or methods of the system and method for gaming according to the present disclosure.

### DETAILED DESCRIPTION OF VARIOUS EMBODIMENTS

### I. Introduction

A better understanding of different embodiments of the disclosure may be had from the following description read with the accompanying drawings in which like reference characters refer to like elements.

While the disclosure is susceptible to various modifications and alternative constructions, certain illustrative embodiments are in the drawings and are described below. The dimensions, angles, and curvatures represented in the figures introduced above are to be understood as exemplary and are not necessarily shown in proportion. It should be understood, however, there is no intention to limit the disclosure to the specific embodiments disclosed, but on the contrary, the intention covers all modifications, alternative constructions, combinations, and equivalents falling within the spirit and scope of the disclosure.

The flowchart illustrations and block diagrams in the flow diagrams illustrate the architecture, functionality, and operation of possible implementations of systems, methods, and computer program products according to various embodiments of the present disclosure. In this regard, each block in the flowchart illustrations or block diagrams may represent a module, segment, or portion of code, which comprises one or more executable instructions for implementing the specified logical function(s).

It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable media that can direct a computer or other programmable data processing apparatus to function in a particular manner, such that the instructions stored in the computer-readable media produce an article of manufacture including instruction means which implement the function/act specified in the flowchart illustrations and/or block diagram block or blocks.

The disclosed embodiments relate to systems and methods for gaming that overcome the problems of static gameplay in existing gaming machines and provide an improved experience for players. The disclosure outlines some example improvements and practical applications provided by the disclosed embodiments. These are just examples only and the embodiments are not limited to only these improvements.

As used in the present disclosure, a “local connection” or “local communications interface” is generally used to refer to a direct connection by means of a network, whether wired or wireless, or similar means that does not require or otherwise involve the use of an internet or other third-party data connection.

Examples of the current disclosure may be provided in terms referring to a bingo game, however there is no intention to limit the disclosure thereto. Rather, the possibility of applying the same principles of embodiments of the current disclosure to alternative forms of gaming. For example, the same principles of embodiments of the current disclosure may be applied to gaming methods and systems as disclosed in U.S. patent application Ser. No. 18/638,294 titled Method And System For Conducting A Secondary Game Based On An Underlying, Historical-Event Based Primary Game, filed Apr. 17, 2024, which application is expressly incorporated herein by reference in its entirety.

As referenced in the examples of the current disclosure, a “game,” “active game,” “existing game,” and/or “new game” may be used to refer to a bingo call or another set of parameters governing results of a wager. A player or gameplay request entering or being assigned to a game generally refers to applying the call associated with the game to a wager associated with the player or gameplay request.

Embodiments of a gaming system and related methods are provided for increasing the availability and variability of games in the gaming system by employing a gaming engine and an experience engine as distinct portions of the gaming system, while reducing the processing requirements of the gaming system and delays in gameplay. The use of the gaming engine and the entertainment engine may separate the result of the wager from the gameplay, enabling the gaming system to present a user with entertaining gameplay while streamlining the underlying wager. Further, regulatory constraints for operation of the gaming system are reduced, and locations suitable for providing a gaming system are increased without the associated costs and complexity of prior art systems.

The disclosed embodiments operate to improve how a gaming machine comprising a computing device operates and/or functions. For instance, the disclosed embodiments are able to automatically increase the variety and variability of entertaining displays or secondary game types available for gaming by following the disclosed principles. Furthermore, the processing speed and operational efficiency of the gaming machine can be improved. As a consequence, the disclosed embodiments operate to improve the computing efficiency and resource utilization of a gaming machine and related computing architecture. As an additional example, by varying the entertaining display or secondary game type based on the reward values and the result of the player's wager, the disclosed embodiments will also improve the presentation of the game to a player.

The disclosed embodiments may be implemented in various configurations for gaming machines, gaming devices, or gaming systems, including but not limited to: (1) a dedicated gaming machine, gaming device, or gaming system wherein the computerized instructions for controlling any games (which are provided by the gaming machine or gaming device) are provided with the gaming machine or gaming device prior to delivery to a gaming establishment; and (2) a changeable gaming machine, gaming device, or gaming system wherein the computerized instructions for controlling any games (which are provided by the gaming machine or gaming device) are downloadable to the gaming machine or gaming device through a data network after the gaming machine or gaming device is in a gaming establishment.

In embodiments, the computerized instructions for controlling games may be executed by at least one central server, central controller, or remote host. In such a “thin client” embodiment, the central server remotely controls any games (or other suitable interfaces) and the gaming machine is utilized to display such games (or suitable interfaces) and receive one or more inputs or commands from a player. In another embodiment, the computerized instructions for controlling games may be communicated from the central server, central controller, or remote host to a gaming machine's local processor and memory devices. In such a “thick client” embodiment, the gaming machine's local processor executes the communicated computerized instructions to control any games (or other suitable interfaces) provided to a player.

### II. Gaming Machine and Gaming System

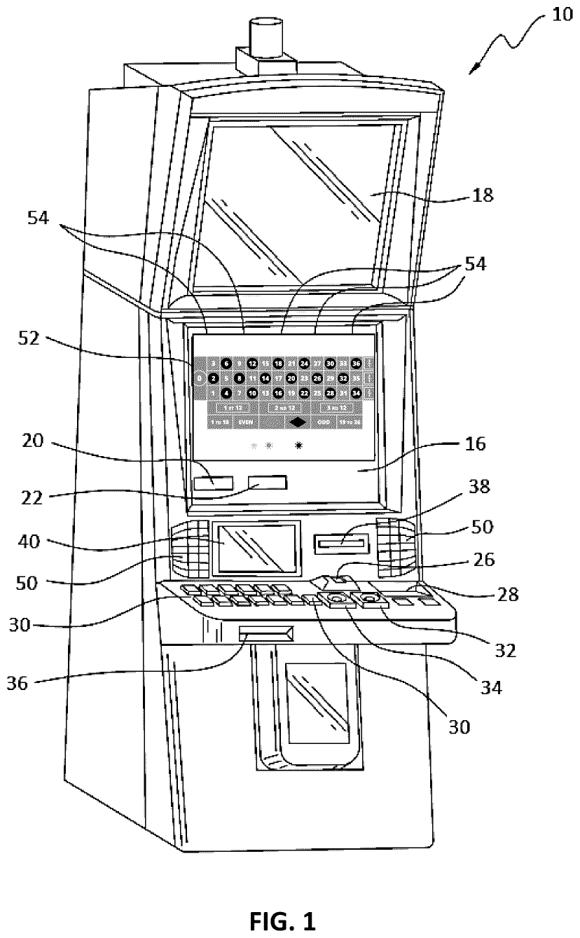

Referring to FIG. 1, one embodiment of a gaming machine 10, according to an embodiment of the present disclosure, has a support structure, housing, or cabinet which provides support for a plurality of displays, inputs, controls, and other features of a conventional gaming machine. It may be configured so that a player can operate it while standing or sitting. The gaming machine 10 can be positioned on a base or stand or can be configured as a pub-style table-top game (not shown) which a player can operate preferably while sitting. The gaming machine 10 may have varying cabinet and display configurations.

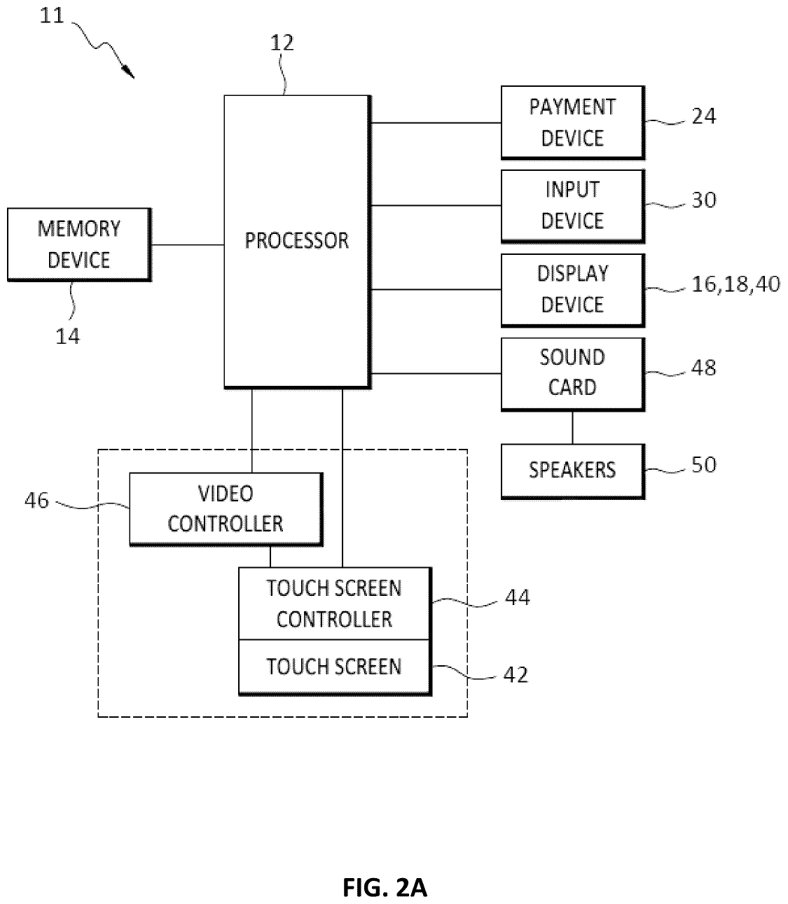

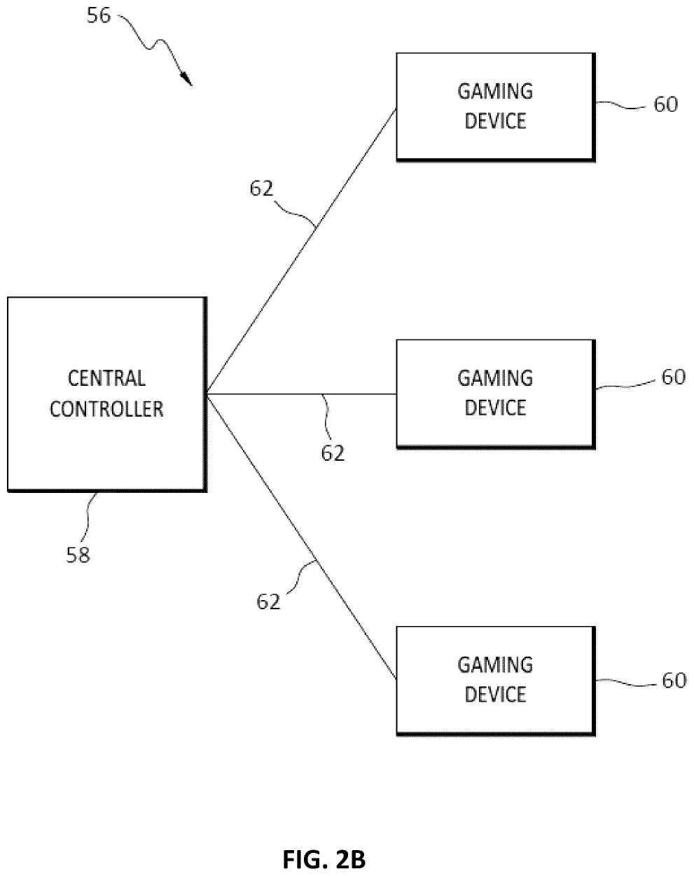

In one embodiment, as illustrated in FIG. 2A, an electronic system for facilitating gaming by a player according to the present disclosure is generally shown at 11. The electronic system 11 may be a separate gaming machine or used with the gaming machine 10 of FIG. 1. The electronic system 11 may include at least one processor 12, such as a microprocessor, a microcontroller-based platform, a suitable integrated circuit or one or more application-specific integrated circuits (ASIC's). The processor 12 may be in communication with or operable to access or to exchange signals with at least one data storage or memory device 14.

In an embodiment, the processor 12 and the memory device 14 may reside within the cabinet of the gaming machine 10. The memory device 14 may store program code and instructions, executable by the processor 12, to control the gaming machine 10. The memory device 14 may also store other data such as image data, player input data, random or pseudo-random number generators, pay-table data or information, and applicable game rules that relate to the play of the game. In an embodiment, the memory device 14 may include random access memory (RAM), which can include non-volatile RAM (NVRAM), magnetic RAM (MRAM), ferroelectric RAM (FeRAM), and other forms. In one embodiment, the memory device 14 may include read only memory (ROM). In one embodiment, the memory device 14 may include flash memory and/or EEPROM (electrically erasable programmable read only memory). Any other suitable magnetic, optical, and/or semiconductor memory may operate in conjunction with the electronic system 11.

In one embodiment, part or all of the program code and/or operating data described above may be stored in a detachable or removable memory device 14, including, but not limited to, a suitable cartridge, disk, CD ROM, DVD, or USB memory device. In other embodiments, part or all of the program code and/or operating data described above may be downloaded to the memory device 14 through a suitable network.

In one embodiment, an operator or a player can use such a removable memory device in a desktop computer, a laptop computer, a hand-held device, such as a personal digital assistant (PDA), a portable computing or mobile device, or another computerized platform to implement embodiments of the present disclosure. In one embodiment, the electronic system 11 is operable over a wireless network, for example as part of a wireless gaming machine. In one such embodiment, the electronic system 11 may be a hand-held device, a mobile device, or any other suitable wireless device that enables a player to play any suitable game at a variety of different locations.

In various embodiments in which the electronic system 11 may be a hand-held device, a mobile device, or any other suitable wireless device, at least one memory device 14 and at least one processor 12 which control the game or other operations of the hand-held device, mobile device, or other suitable wireless device may be located: (a) at the hand-held device, mobile device or other suitable wireless device; (b) at a central server or central controller; or (c) any suitable combination of the central server or central controller and the hand-held device, mobile device or other suitable wireless device. A gaming device or gaming machine as disclosed herein may be a device that has obtained approval from a regulatory gaming commission or a device that has not obtained approval from a regulatory gaming commission. The processor 12 and memory device 14 may be collectively referred to herein as a “computer,” “computing device” or “controller.”

In embodiments, as illustrated in FIG. 2A, the electronic system 11 may include one or more display devices 16, 18, 40 controlled by the processor 12. The display devices 16, 18, 40 may preferably be connected to or mounted on the cabinet of the gaming machine 10. The embodiment shown in FIG. 1 includes a central display device 16 which displays a primary or base game and an upper display device 18. The central display device 16 may also display any suitable secondary game associated with the primary or base game as well as information relating to the primary or secondary game. The upper display device 18 may display the primary game, any suitable secondary game associated or not associated with the primary game, and/or information relating to the primary or secondary game. These display devices 16, 18 may also serve as digital glass operable to advertise games or other aspects of the gaming establishment.

As seen in FIG. 1, in various embodiments, the gaming machine 10 may include a credit display 20 which displays a player's current number of credits, cash, account balance, or the equivalent. The gaming machine 10 may include a bet display 22 which displays a player's amount wagered. The gaming machine 10 may include a player tracking display 40 which displays information regarding a player's play status, such as including past wins, number of past wagers, etc. One or more of these display devices 16, 18, 20, 22, 40 may be in communication with the processor 12.

In another embodiment, at least one display device may be a mobile display device, such as a PDA or tablet PC, that enables play of at least a portion of the primary or secondary game at a location remote from the gaming machine 10 or electronic system 11.

The display devices 16, 18, 40 may include, without limitation, a monitor, a television display, a plasma display, a liquid crystal display (LCD) a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In one embodiment, as described in more detail below, the display devices 16, 18, 40 include a touch-screen with an associated touch-screen controller. The display devices 16, 18, 40 may be of any suitable size and configuration, such as a square, a rectangle or an elongated rectangle.

The display devices 16, 18, 40 of the gaming machine 10 may be configured to display at least one and preferably a plurality of games or other suitable images, symbols and indicia such as any visual representation or exhibition of the movement of objects such as mechanical and/or virtual.

In one embodiment, the symbols, images and indicia displayed on or of the display device may be in mechanical form. That is, the display devices 16, 18, 40 may include any electromechanical device, such as one or more mechanical objects. An example of an exemplary electromechanical device according to embodiments of the disclosure may include a roulette wheel, dice, cards, or the like, configured to display at least one or a plurality of games or other suitable images, symbols or indicia.

As illustrated in FIG. 2A, the electronic system 11 may include at least one payment device 24 in communication with the processor 12. The payment device 24 may be a payment acceptor including a note, ticket or bill acceptor 28 (FIG. 1) wherein the player inserts paper money, a ticket, or voucher, and/or a coin slot 26 (FIG. 1) where the player inserts money, coins, or tokens. In other embodiments, other payment devices 24 such as readers or validators for credit cards, debit cards or credit slips may accept payment. A player may insert an identification card into a card reader 24 of the gaming machine 10.

An identification card may be a smart card having a programmed microchip, a coded magnetic strip or coded rewritable magnetic strip, wherein the programmed microchip or magnetic strips are coded with a player's identification, credit totals (or related data), and/or other relevant information. In another embodiment, a player may carry a portable device, such as a cell phone, a radio frequency identification tag, or any other suitable wireless device, which communicates a player's identification, credit totals (or related data), and other relevant information to the gaming machine 10. In one embodiment, money may be transferred by a player to a gaming machine 10 through electronic funds transfer. When a player funds the gaming machine 10, the processor 12 may determine the amount of funds entered and display the corresponding amount on the credit or other suitable display as described previously.

As seen in FIGS. 1 and 2A, in an embodiment the gaming machine 10 and electronic system 11 may include at least one input device 30 in communication with the processor 12. The at least one input device 30 can include any suitable device which enables the player to produce an input signal which is received by the processor 12. In one embodiment, after appropriate funding of the gaming machine 10, the input device 30 is a game-activation device, such as a play button 32 or a pull arm (not shown) which is used by the player to start any primary or base game or sequence of events in the gaming machine 10. The play button 32 can be any suitable play activator such as a bet-one button, a max-bet button, or a repeat-the-bet button. In an embodiment, upon appropriate funding, the gaming machine 10 may begin game play automatically. In another embodiment, upon the player engaging one of the play buttons 32, the gaming machine 10 automatically activates game play.

In an embodiment, one input device may be a bet one button. The player may place a bet by pushing the bet-one button 32. The player can increase the bet by one credit each time the player pushes the bet-one button 32. When the player pushes the bet-one button 32, the number of credits shown in the credit display 20 preferably decreases by one, and the number of credits shown in the bet display preferably increases by one. In another embodiment, one input device 30 is a bet-max button (not shown) which enables the player to bet the maximum wager permitted for a game of the gaming machine 10.

In one embodiment, one input device is a cash out button 34. The player may push the cash out button 34 and cash out to receive a cash payment or other suitable form of payment corresponding to the number of remaining credits. In one embodiment, when the player cashes out, a payment device, such as a ticket, payment, or note generator 36 prints or otherwise generates a ticket or credit slip to provide to the player. The player receives the ticket or credit slip and may redeem the value associated with the ticket or credit slip via a cashier (or other suitable redemption system).

In another embodiment, when the player cashes out, the player receives the coins or tokens in a coin payout tray. In one embodiment, the gaming machine 10 includes at least one card reader 38 in communication with the processor 12. In this embodiment, a player is issued a player identification card which has an encoded player identification number that uniquely identifies the player. When the player inserts their playing tracking card into the card reader 38 to begin a gaming session, the card reader 38 reads the player identification number off the player tracking card to identify the player. Any suitable payout mechanism, such as funding to the player's electronically recordable identification card or smart card, may be implemented in accordance with the gaming machine 10.

In one embodiment, as mentioned above and as seen in FIG. 2A, one input device may be a touch-screen 42 coupled with a touch-screen controller 44 or some other touch-sensitive display overlay to allow for player interaction with the images on the touch screen 42. The touch-screen 42 and the touch-screen controller 44 may be connected to a video controller 46. A player can make decisions and input signals into the gaming machine 10 or the electronic system 11 by touching the touch-screen 42 at the appropriate locations. One such input device is a conventional touch-screen button panel.

The electronic system 11 may further include a plurality of communication ports for enabling communication of the processor with external peripherals, such as external video sources, expansion buses, game or other displays, a SCSI port, or a keypad.

In an embodiment, as seen in FIG. 2A, the electronic system 11 may include a sound generating device controlled by one or more sounds cards 48 which function in conjunction with the processor 12. In one embodiment, the sound-generating device includes at least one and preferably a plurality of speakers 50 or other sound-generating hardware and/or software for generating sounds. The sound-generating device may, for example, play music for the primary and/or secondary game or play music for other modes of the gaming machine 10, such as an attract mode.

In one embodiment, the gaming machine 10 may provide dynamic sounds coupled with attractive multimedia images displayed on one or more of the display devices 16, 18, 40 to provide an audio-visual representation or to otherwise display full-motion video with sound to attract players to the gaming machine 10. During idle periods, the gaming machine 10 may display a sequence of audio and/or visual attraction messages to attract potential players to the gaming machine 10. The videos may also be customized to provide any appropriate information.

In one embodiment, the gaming machine 10 may include a sensor, such as a camera, in communication with the processor 12 (and possibly controlled by the processor 12), that is selectively positioned to acquire an image of a player actively using the gaming machine 10 and/or the surrounding area of the gaming machine 10. In one embodiment, the camera may be configured to selectively acquire still or moving (e.g., video) images and may be configured to acquire the images in an analog, digital, or other suitable format. The display devices 16, 18, 40 may be configured to display the image acquired by the camera as well as to display the visual features of the game in split screen or picture-in-picture fashion. For example, the camera may acquire an image of the player and the processor may incorporate that image into the primary and/or secondary game as a game image, symbol or indicia.

The gaming machine 10 may incorporate a bingo based wagering game as the primary or base game, and may incorporate a table game as the secondary game or as the entertaining display game. The gaming machine 10 may include some or all of the features of conventional gaming machines or devices.

In one embodiment, as illustrated in FIG. 1, an entertaining display may be provided on the gaming machine corresponding to a secondary game 52. In various embodiments, the gaming machine 10 may include one or more secondary game elements 54, such as a roulette table, a craps table, a roulette wheel, cards, dice, or the like, in either electromechanical form with mechanical elements or video form with simulated elements and movement thereof. The secondary game elements 54 preferably correspond to a theme associated with one or more secondary game 52 of the gaming machine 10. The gaming machine 10 may control the secondary game elements 54 of the entertaining display to be displayed in an arrangement corresponding to a result of the player's wager.

In one embodiment, as illustrated in FIG. 2B, a gaming system according to the present disclosure is generally shown at 56. The gaming system 56 may include at least one central controller 58 and one or more gaming controllers or devices 60 in communication with each other and/or the at least one central controller 58 through a data network or remote communication link 62. In this embodiment, the central server, central controller, central computer, or remote host is any suitable server or computing device which includes at least one processor and at least one memory or storage device. In different such embodiments, the central server is a progressive controller or a processor of one of the gaming machines in the gaming system.

In these embodiments, the processor of each gaming machine is designed to transmit and receive events, messages, commands, or any other suitable data or signal between the individual gaming machine and the central server. The gaming machine processor is operable to execute such communicated events, messages, or commands in conjunction with the operation of the gaming machine. Moreover, the processor of the central server is designed to transmit and receive events, messages, commands, or any other suitable data or signal between the central server and each of the individual gaming machines. The central server processor is operable to execute such communicated events, messages, or commands in conjunction with the operation of the central server. One, more or each of the functions of the central controller, central server or remote host as disclosed herein may be performed by one or more gaming machine processors. One, more or each of the functions of one or more gaming machine processors as disclosed herein may be performed by the central controller, central server or remote host.

In one embodiment, a plurality of the gaming machines 60 are capable of being connected together through a data network. In one embodiment, the data network is a local area network (LAN), in which one or more of the gaming machines 60 are substantially proximate to each other and an on-site central server or controller as in, for example, a gaming establishment or a portion of a gaming establishment. In another embodiment, the data network is a wide area network (WAN) in which one or more of the gaming machines are in communication with at least one off-site central server or controller. In this embodiment, the plurality of gaming machines 60 may be located in a different part of the gaming establishment or within a different gaming establishment than the off-site central server or controller. Thus, the WAN may include an off-site central server or controller and an off-site gaming machine located within gaming establishments in the same geographic area, such as a city or state. The WAN gaming system may be substantially identical to the LAN gaming system described above, although the number of gaming machines in each system may vary relative to one another.

In another embodiment, the data network 62 may be include the internet or an intranet. In this embodiment, the operation of the gaming machine 60 may be viewed at the gaming machine 60 using at least one internet browser implemented thereon. In this embodiment, operation of the gaming machine 60 and accumulation of credits may be accomplished with only a connection to the central server or controller 58 (the internet/intranet server) through a conventional phone or other data transmission line, digital subscriber line (DSL), T-1 line, coaxial cable, fiber optic cable, or other suitable connection. In this embodiment, players may access an internet game page from any location where an internet connection and computer or other internet facilitator is available. The expansion in the number of computers and number and speed of internet connections in recent years increases opportunities for players to play from an ever-increasing number of remote sites. The enhanced bandwidth of digital wireless communications may render such technology suitable for some or all communications, particularly if such communications are encrypted. Higher data transmission speeds may be useful for enhancing the sophistication and response of the display and interaction with the player.

As mentioned above, embodiments may be employed in a server-based gaming system. In one such embodiment, as described above, one or more gaming machines 60 may be in communication with a central server or controller 58. The central server or controller 58 may be any suitable server or computing device which includes at least one processor and a memory or storage device. In alternative embodiments, the central server is a progressive controller or another gaming machine in the gaming system. In one embodiment, the memory device of the central server stores different game programs and instructions, executable by a gaming machine processor, to control the gaming machine. Each executable game program may represent a different game or type of game which may be played on one or more of the gaming machines in the gaming system. Such different games may include the same or substantially the same game play with different pay tables. In different embodiments, the executable game program is for a primary game, a secondary game or both. In another embodiment, the game program may be executable as a secondary game to be played simultaneous with the play of a primary game (which may be downloaded to or fixed on the gaming machine) or vice versa.

In this embodiment, each gaming machine 60 at least includes one or more display devices and/or one or more input devices for interaction with a player. A local processor, such as the above-described gaming machine processor or a processor of a local server, is operable with the display device(s) and/or the input device(s) of one or more of the gaming machines.

In operation, the central controller 58 may be operable to communicate one or more of the stored game programs to at least one local processor. In different embodiments, the stored game programs may be communicated or delivered by embedding the communicated game program in a device or a component (e.g., a microchip to be inserted in a gaming machine), writing the game program on a disc or other media, or downloading or streaming the game program over a dedicated data network, internet, or a telephone line. After the stored game programs are communicated from the central server, the local processor may execute the communicated program to facilitate play of the communicated program by a player through the display device(s) and/or input device(s) of the gaming machine. That is, when a game program is communicated to a local processor, the local processor changes the game or type of game played at the gaming machine.

Several (or different) elements discussed below, and/or claimed, are described as being “coupled”, “in communication with”, or “configured to be in communication with”. This terminology is intended to be non-limiting, and where appropriate, be interpreted to include without limitation, wired and wireless communication using any one or a plurality of a suitable protocols, as well as communication methods that are constantly maintained, are made on a periodic basis, and/or made or initiated on an as needed basis.

The methodologies described herein may be implemented by various means depending upon applications according to particular examples. For example, such methodologies may be implemented in hardware, firmware, software, or combinations thereof. In a hardware implementation, for example, the controller or processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units designed to perform the functions described herein, or combinations thereof.

Some portions of the description included herein are presented in terms of algorithms or symbolic representations of operations on binary digital signals stored within a memory of a specific apparatus or special purpose computing device or platform. In the context of this particular specification, a specific apparatus or the like includes a general-purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities.

Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be appreciated, however, that all of these or similar terms are to be associated with appropriate physical quantities and are merely convenient labels. Unless specifically stated otherwise, as apparent from the discussion herein, throughout this specification discussions utilizing terms such as “processing,” “computing,” “calculating,” “determining” or the like refer to actions or processes of a specific apparatus, such as a special purpose computer or a similar special purpose electronic computing device. In the context of this description, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

For clarity in discussing the various functions of the system, multiple computers and/or servers are discussed as performing different functions. These different computers (or servers) may, however, be implemented in multiple different ways such as modules within a single computer, as nodes of a computer system, etc. The functions performed by the system (or nodes or modules) may be centralized or distributed in any suitable manner across the system and its components, regardless of the location of specific hardware. Furthermore, specific components of the system may be referenced using functional terminology in their names. The function terminology is used solely for purposes of naming convention and to distinguish one element from another in the following discussion. Unless otherwise specified, the name of an element conveys no specific functionality to the element or component. In selected embodiments, the software, hardware, and associated components of the system may be programmed and configured to implement one or more embodiments described herein. The various aspects of the system may be exemplified as software, modules, nodes, etc. of a computer or server device.

### III. Primary Game

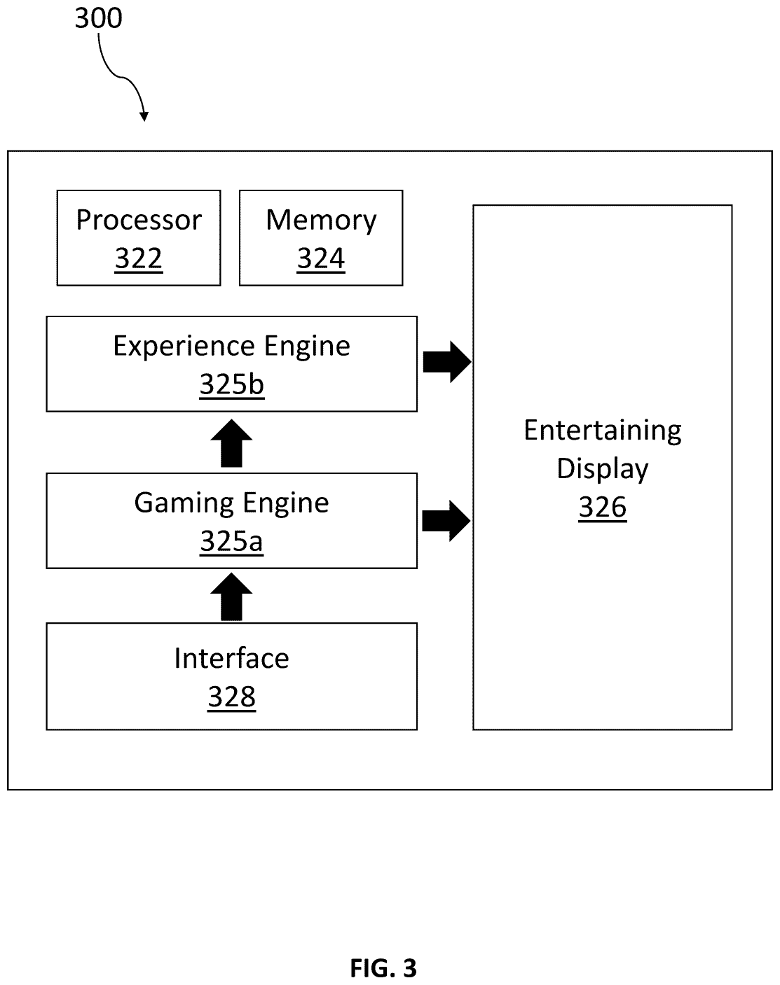

FIG. 3 illustrates an embodiment of a gaming system 300 comprising a processor 322 and a memory 324 for operating a corresponding entertaining display 326 and a corresponding user interface 328. In operation, the gaming system 300 is arranged to facilitate an input by a player, such that a corresponding gameplay request is sent to a gaming engine 325a and subsequently to an experience engine 325b.

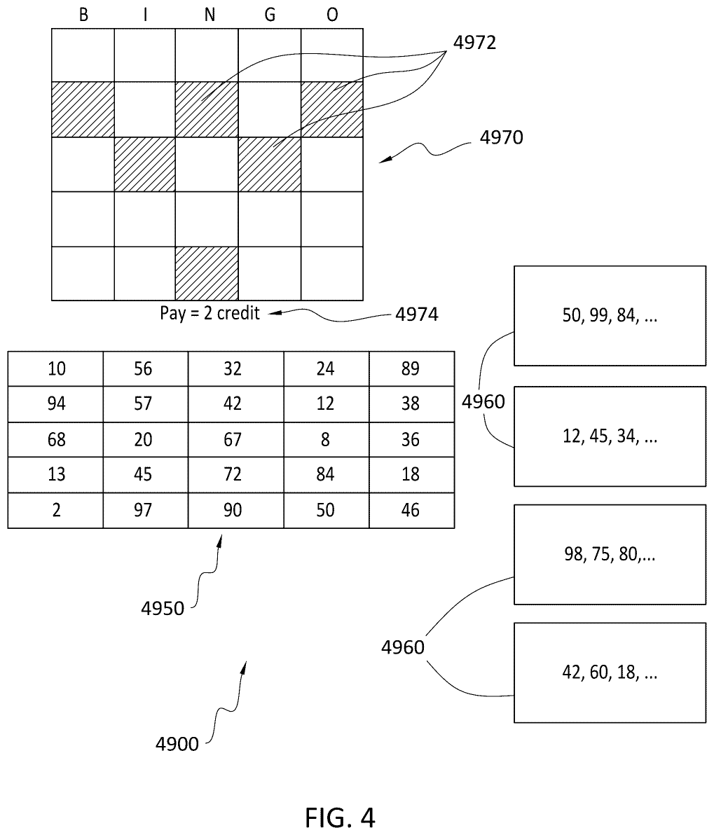

Embodiments of the disclosure may be directed to games facilitated by underlying bingo games, as illustrated in FIG. 4. Accordingly, the gaming engine 325a may comprise a bingo gaming engine, such that the gaming system 300 creates and manages a wager using a gameplay request received from the user. Each gameplay request provided may include a wager, such that the gaming engine 325a selects a card 4950 including a different arrangement of tokens, for example corresponding to a player's purchase of a card and/or a wager amount. The player may initiate a game and may place a wager by any suitable method, such as described previously by transferring money to the gaming system 300. At least one or a plurality of input devices at the interface 328 may be used to facilitate the wager and the gaming system 300 may accept the wager.

The card 4950 may include a random selection and arrangement of tokens from a token pool and may be randomly selected from a plurality of cards or randomly generated by a first random number generator. A card 4950 may be attached to the gameplay request immediately upon initiation of the wager.

The gaming engine 325a may further select a game call or ball call 4960, including randomly selected tokens from a token pool or a randomly selected grouping of tokens, such as using a second random number generator independent from the first random number generator. When the tokens on the player's card matching the call of the game 4960 form one of a plurality of certain predetermined patterns or arrangements correlating to a final result 4970 of a result index, the card of the gameplay request 4950 is identified as a winner and may be scored against the predetermined final result of the result index such that a corresponding reward or loss may be disbursed to the player at the gaming system 300. Alternatively, when the tokens on the player's card matching the call of the game 4960 do not form one of the plurality of predetermined patterns or arrangements correlating to a final result of the result index, the gameplay request 4950 may be discarded and no reward provided.

The entertainment engine 325b may receive the result of the wager from the gaming engine 325a and conduct a secondary game based thereon. According to varying embodiments, the game conducted by the entertainment engine 325b may be independent of the gaming engine 325a other than the result of the wager. Accordingly, for example, the entertainment engine 325b may invite a user to predict the result of an event, to play a class III game, to initiate a rotating reel, deal cards, roll dice, etc., and the result of the prediction is predicated on the result of the wager predetermined by the gaming engine 325a.

Various forms of card assignment or selection are contemplated. The cards may take varying forms, including a random arrangement of any number of tokens, symbols, numbers or otherwise, such as in a grid pattern, a line or other arrangement. The card may be selected from a plurality of cards for assignment to the gameplay request or randomly generated for each gameplay request. For example, a card may have the form of a standard bingo card comprising numbers arranged in a 5-by-5 grid. While the card may or may not be presented to a player in the display of the gaming system, the underlying card may be represented in a gameplay request communicated to or assigned by the gaming system in a digital, numerical, referential or other form. In like manner, a player may be provided with only one card per wager, or with a plurality of cards for one or more wagers.

To define a final result 4970 of a result index according to an embodiment of the current disclosure, the processor may consider specific patterns of matched or daubed tokens 4972 relative to a size, shape, and/or layout of the cards. A reward 4974 may be tied to matching only a specified pattern without any additional tokens being daubed (i.e., requiring that both positive daubs and non-daubs are matched) or to matching the specified pattern regardless of other tokens being daubed (i.e., requiring only that positive daubs are matched). In various embodiments, final results of a result index may be defined by a pattern and by a number of ball calls required to match the pattern. Variations in the result index 4970 with different patterns and/or a number of ball calls needed to match the pattern may be tied to different award levels 4974. While described as a result index 4970, varying embodiments may employ other approaches to evaluate a wager. As such, no specific architecture is required for evaluating a user's wager.

It will be understood that the disclosed embodiments of bingo games are merely exemplary, and that features of the present disclosure may also extend to other games and the like. In varying embodiments, any possible patterns may be provided as final results of the result index, with rewards varying according to the odds, difficulty, or based on another factor as would be understood from the current disclosure.

In certain embodiments, a player may create or select a card by selecting a desired arrangement of specific tokens or the like. In other embodiments, a card may be randomly generated for the player or a card may be assigned to the player from a predetermined set of cards for the wager.

The card may be submitted to the processor for comparison to the ball call and/or the final results of the result index. In varying embodiments, a pay table may be provided wherein the pay table may identify which final results of the result index are available for comparison to the player's card based on the wager provided by the player. If there is an available final result of the result index that is a match with the card of the player based on the corresponding ball call of the game, a final result of the corresponding wager may be used to determine the reward associated with the final result of the result index. The pay table may provide static rewards for the predetermined patterns or may be dynamically adjusted based on the circumstances of the game and/or the gaming system.

The processor may create and/or select an entertaining display 326 corresponding to the final result of the player's wager, based on whether a final result of the result index is found that is a match with the card of the player based on the corresponding ball call of the game, which final result was a match, and/or the reward value won. The entertaining display 326 may break the value won into multiple animations or bonus games. Breaking the value won into multiple animations or bonus games can increase the enjoyment and successful feeling of the player and encourage continued gaming.

In some embodiments, the entertaining display may include a separate component (not shown), such as a separate display screen or mechanical element. The separate components may include a video display, window or a mechanical element corresponding to a plurality of possible results of the player's wager. During the presentation of the entertaining display 326, a portion of the gaming device may remain dedicated to illustrating features of the bingo game 4900.

The wager may end with a payout, beginning another wager, another round, a bonus game, and/or by reverting to a menu providing additional options for the player.

### IV. Secondary Game

The entertaining display 326 may be based on a theme or a secondary game as described previously. The theme or secondary game may be selected by a player based on preference and/or may be manipulated by the processor in response to a particular final result of a wager and/or a reward value available for a wager. The theme or secondary game may include accompanying depictions and animated highlights of a winning game as the participants complete the event. The entertaining display may include matches with graphics, symbols, and other indicia particular to the theme or the secondary game. In a preferred embodiment, the secondary game is a table game. A secondary game may include a casino game, table game, class III game or the like. For example, a secondary game may include one or more of poker, baccarat, blackjack, craps, roulette, a big six wheel or wheel of fortune, pool, pachinko, chemin de fer, pai gow, a lottery, keno, or any other table game, and the like.

In a first aspect, the entertaining display 326 may provide a secondary game that is playable by the player on the gaming machine or otherwise responsive to player input, but that has an outcome that corresponds to the outcome of the wager. For example, the secondary game may be played after the wager is completed so that the outcome of the secondary game may be provided as a controlled simulation, animation or video. In one example, after initializing a wager of the primary game, a secondary game may be shown as an entertaining display. The player may be allowed to “play” the secondary game by making a selection, using the input of the gaming machine, and the result of the secondary game may be simulated with a predetermined game result that directly corresponds to the result of the primary game wager (e.g., showing a roulette loss for a bingo loss and a roulette win for a bingo win by controlling where the ball lands in view of the players predicted roulette result; allowing a player to select a “hit”, “stay”, “roll”, or a predicted winning number or entity, where the result shown for the secondary game is predetermined by the result of the primary game).

In some embodiments, the reward value of the player's wager may correspond to a simulated result of a single secondary game or to more than one secondary game and/or iterations thereof. In certain aspects, a pay table or a final result of the result index of the primary game may be associated with a display element, action or result of the secondary game. When a player makes a wager or gameplay decision in the secondary game, this action may be correlated to enabling a set of awards to build a reward table for that gameplay.

In the secondary game, a player may select a bet option corresponding to the secondary game. For example, where the secondary game is roulette, the player may select one or more bets based on predicted characteristics of a final location of a ball in a roulette wheel, such as predicting a number or color of a pocket the ball may land in, predicting the ball will land in an odd or even numbered pocket, or the like. The selected bet option may be associated with a corresponding pay table or final result of the result index for the primary game, such that the player's selection adjusts the available awards for the primary game. The amount wagered by the player may be included in the gameplay request.

The same principles can be applied to any secondary game by associating relevant betting options with pay table/final result entries of the primary game. In this way, the player's actions in the secondary game may have a direct effect on a result of the underlying primary game, while advantageously maintaining the primary game as the source of the wager and the wager result.

Some game types may have a set payout structure, such that a direct correspondence between the payout of the wager from the primary game and a simulated payout of the secondary game may not exist. By breaking the reward value of the wager from the primary game into more than one secondary game, a correspondence between the payout of the wager and the simulated payouts may be provided. For example, where a player's wager was successful based on a player's card matching a final result of a result index after the result of a ball call, a secondary game of roulette may be provided and the player may be permitted to select one or more result predictions, whether simultaneously or iteratively, so that the simulated result of the secondary game cumulatively corresponds to the wager result. The rewards of the extra game may be progressive values, static or a mix of progressive and static. In certain embodiments, the awards may all be static but the number of awards available may be varied to correlate the payouts of the secondary games and the primary game. The secondary game thereby provides advantageous variability and entertainment for the player, while maintaining a simplified and streamlined underlying gaming mechanism based on the primary game, such as bingo.

Various embodiments of the disclosure may be better understood by reference to specific examples of a method for conducting games based on bingo games according to the current disclosure, as detailed below. The examples provided are illustrative in nature of a single application of principles according to the disclosure and are not intended to be limiting. As such, while described with reference to one or more table games, the various embodiments may be adapted to employ one or more other table games, for example by switching a secondary game from roulette to baccarat or the like.

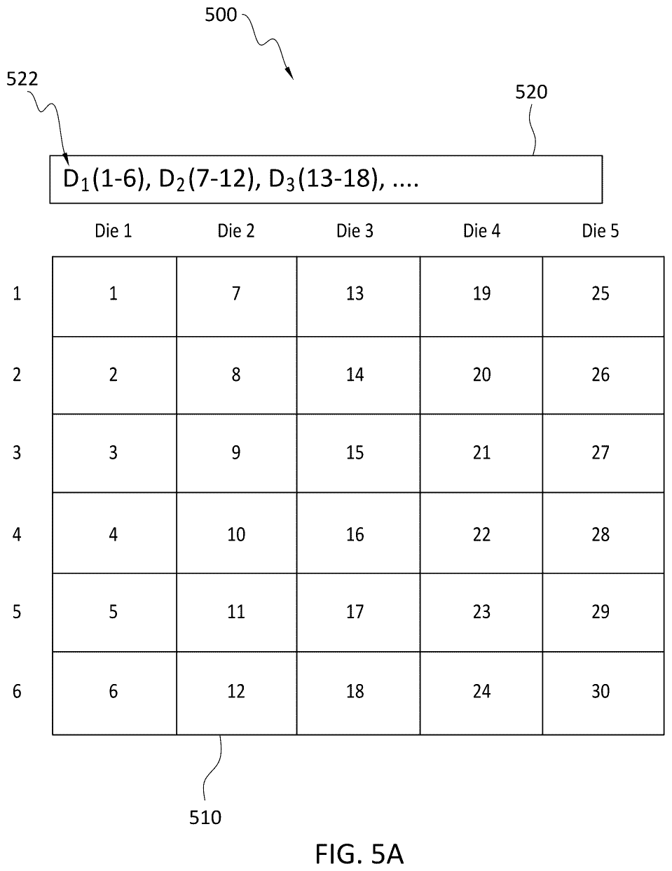

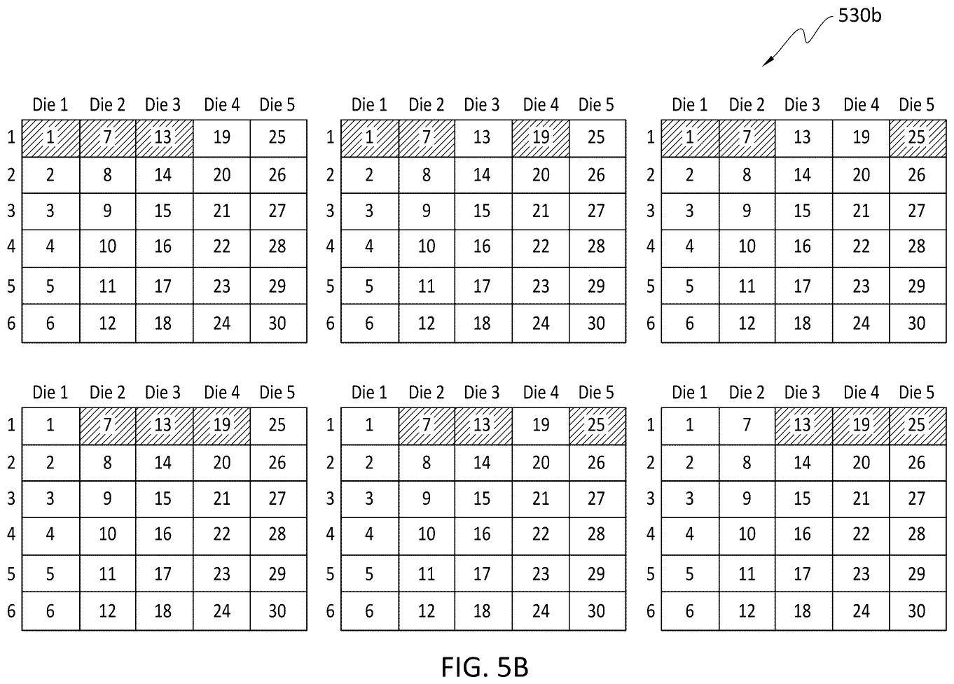

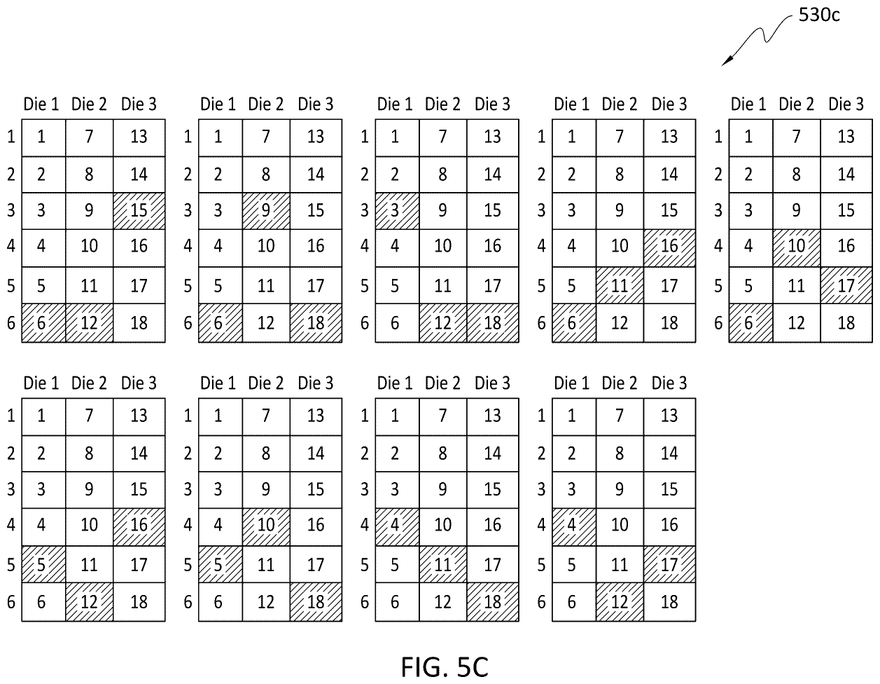

In one aspect, features of the primary game may be adapted to emulate the result of a secondary game, such as a casino table game. According to the illustrated example of FIGS. 5A-5C, cards for a primary game 500 of bingo may be configured to replicate the odds or results of rolling five dice, or rolling one die five times, etc. The card 510 is shown as a 6×5 bingo card and is used with a thirty-ball call 520, called in a “B”, “I”, “N”, “G”, “O” column-by-column fashion. In the example of FIG. 5A, the first ball 522 called in the game 500 would be from the “B” (i.e., Die 1) column, and so on. Because the ball call 520 size is thirty and the card 510 has six balls per column of equal likelihood, the probability of a given spot in each column is the same as a side of a six-sided die.

Based on the layout of the card 510 and the ball call 520, “3 of a kind”, “4 of a kind”, “5 of a kind”, “full houses”, and “straights” in a secondary game may correlate directly to final results 530 showing bingo patterns. For example, FIG. 5B illustrates final results 530b of the result index corresponding to a result of a “three of a kind” on “ones” in the secondary game.

Similarly, as illustrated in FIG. 5C, sums of die or dice rolls in a secondary game may be correlated to final results 530c of the result index showing bingo patterns. The final results 530c of the result index correspond to a result of a sum of fifteen based on a roll of three die in the secondary game.

In this manner, the primary game 500 of bingo may be configured to emulate a player's selection of wager options from a full list of available options of casino table games and the like. Advantageously, the primary game may be configured to include correlating final results from the result index and bingo patterns for all wager options in the secondary game, where specific final results and patterns are enabled in the primary game based on the player's selections made in the secondary game.

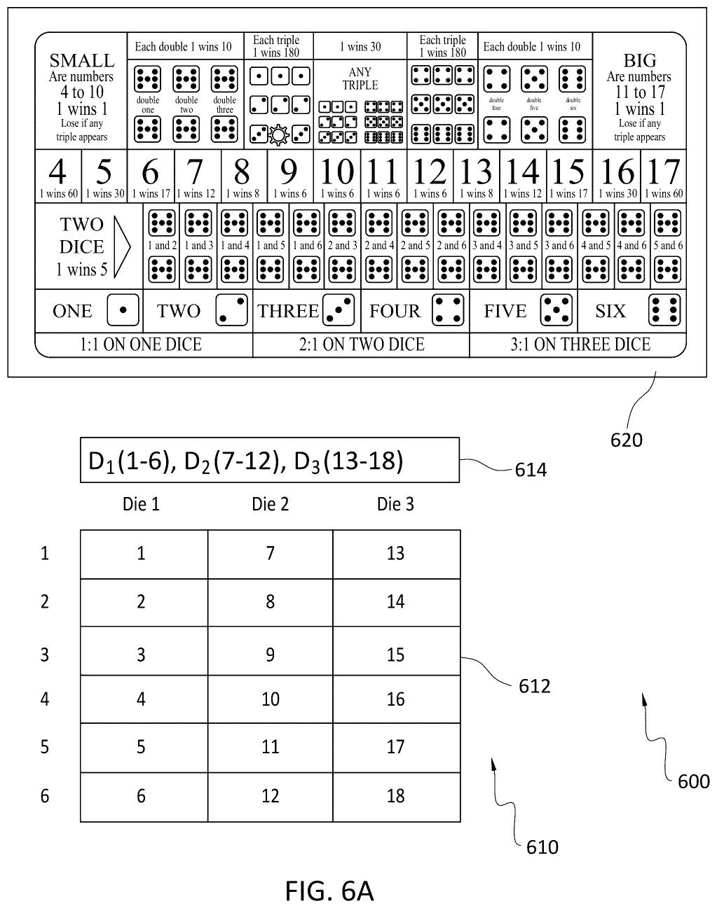

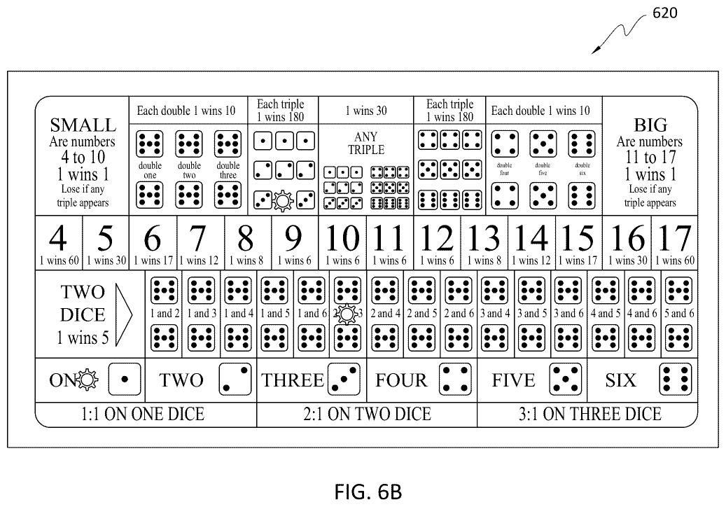

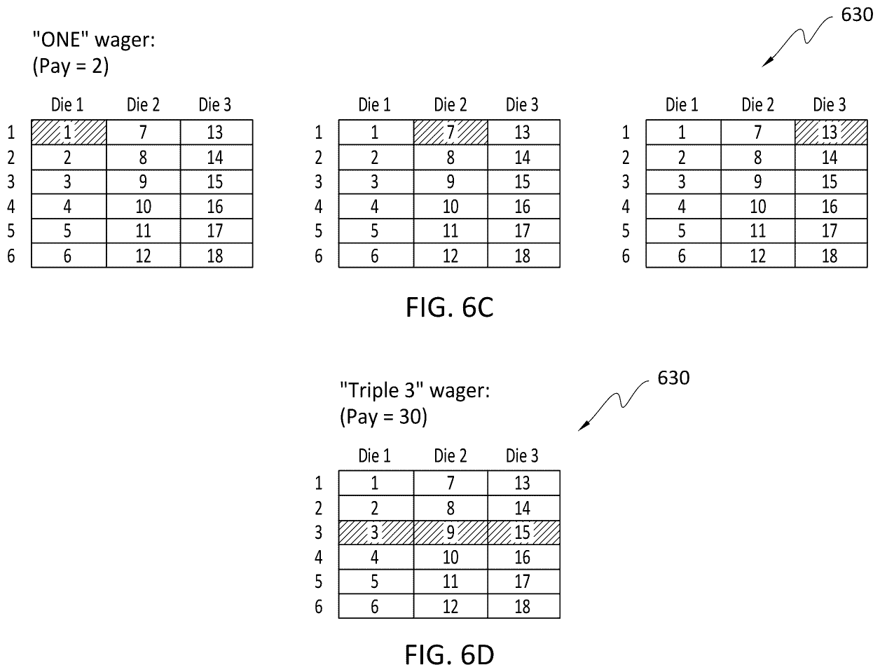

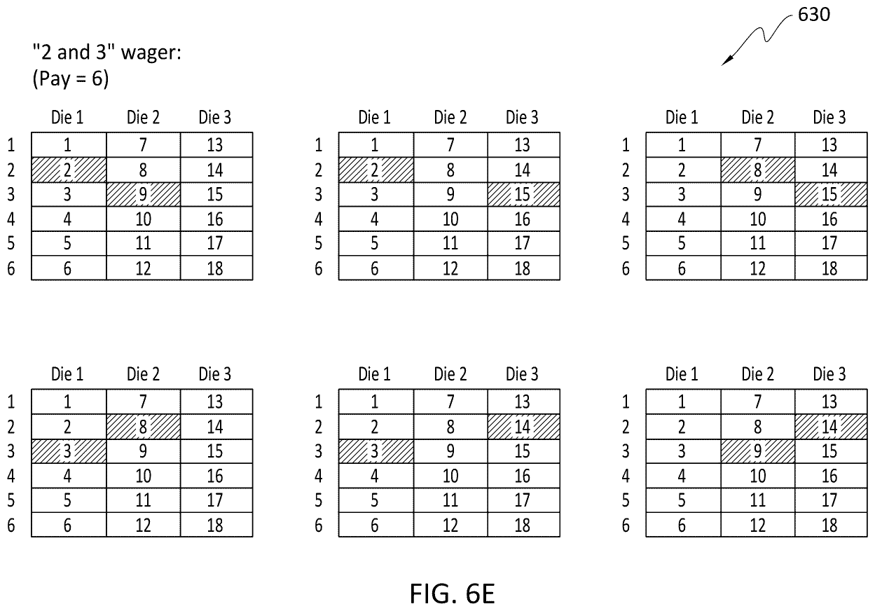

The illustrated embodiment of FIG. 6 demonstrates an example where the principles of FIGS. 5A-5C are applied to a primary game of bingo for a secondary game of sic bo. Sic bo is a game of chance where players place bets on areas of a table that has been divided into named scoring boxes representing different results of a roll of three die. The game of sic bo has some features in common with the games of craps and roulette and, while illustrated with respect to sic bo in the current example for ease of explanation, the principles of the depicted embodiment may be applied to enable a primary game of bingo with a secondary game of craps, roulette, and other table games.

FIG. 6A depicts a wager game 600 provided to a player including a primary game 610 of bingo and a secondary game 620 of sic bo. In various configurations, the secondary game 620 may be presented to the player for interactive gameplay, while the primary game 610 is used as the actual basis of a player's wager. This arrangement, while advantageous in allowing a player to experience the gameplay of sic bo without the regulatory challenges of class III gaming, presents the challenge that the many varied wagering options of sic bo do not naturally correlate to the requirements of bingo. For example, in the secondary game 620 of sic bo, a player may place a wager on dice combinations, single die results, evens, odds, total combined values, etc., each having different wager odds and corresponding rewards. For a sic bo game, a bet odds table may be provided as follows:

| | | | United Kingdom | | New Zealand | | Macau & Hong Kong | | No house |
|---|---|---|---|---|---|---|---|---|---|
| | Wager | | | House | | House | | House | edge |
| Name | event | Probability | Odds | Edge | Odds | Edge | Odds | Edge | Odds |
| Big ( [symbol] ) | The total | 48.61% | 1 to 1 | 2.78% | 1 to 1 | 2.78% | 1 to 1 | 2.78% | 37 to 35 |
| | score will | | | | | | | | |
| | be from 11 | | | | | | | | |
| | to 17 | | | | | | | | |
| | (inclusive) | | | | | | | | |
| | with the | | | | | | | | |
| | exception | | | | | | | | |
| | of a triple | | | | | | | | |
| Small ( [symbol] ) | The total | 48.61% | 1 to 1 | 2.78% | 1 to 1 | 2.78% | 1 to 1 | 2.78% | 37 to 35 |
| | score will | | | | | | | | |
| | be from 4 | | | | | | | | |
| | to 10 | | | | | | | | |
| | (inclusive) | | | | | | | | |
| | with the | | | | | | | | |
| | exception | | | | | | | | |
| | of a triple | | | | | | | | |
| Odd | The total | 48.61% | 1 to 1 | 2.78% | 1 to 1 | 2.78% | | | 37 to 35 |
| | score will | | | | | | | | |
| | be an odd | | | | | | | | |
| | number | | | | | | | | |
| | with the | | | | | | | | |
| | exception | | | | | | | | |
| | of a triple | | | | | | | | |
| Even | The total | 48.61% | 1 to 1 | 2.78% | 1 to 1 | 2.78% | | | 37 to 35 |
| | score will | | | | | | | | |
| | be an even | | | | | | | | |
| | number | | | | | | | | |
| | with the | | | | | | | | |
| | exception | | | | | | | | |
| | of a triple | | | | | | | | |
| Specific | A specific | 0.46% | 180 to 1 | 16.2% | 180 to 1 | 16.2% | 150 to 1 | 30.1% | 215 to 1 |
| ‘Triples’ or | number | | | | | | | | |
| ‘Alls’ ( [symbol] | will | | | | | | | | |
| [symbol] | appear on | | | | | | | | |
| [symbol] | all three | | | | | | | | |
| | dice | | | | | | | | |
| Specific | A specific | 7.41% | 10 to 1 | 18.5% | 11 to 1 | 11.1% | 8 to 1 | 33.3% | 25 to 2 |
| Doubles | number | | | | | | | | |
| | will | | | | | | | | |
| | appear on | | | | | | | | |
| | at least | | | | | | | | |
| | two of the | | | | | | | | |
| | three dice | | | | | | | | |
| Any Triple or | Any of the | 2.8% | 30 to 1 | 13.9% | 31 to 1 | 11.1% | 24 to 1 | 30.6% | 35 to 1 |
| All ‘Alls’ ( [symbol] | triples will | | | | | | | | |
| [symbol] ) | appear | | | | | | | | |
| Three Dice | 4 or 17 | 1.4% | 60 to 1 | 15.3% | 62 to 1 | 12.5% | 50 to 1 | 29.2% | 71 to 1 |
| Total | | | | | | | | | |
| (a specific | | | | | | | | | |
| total score in | | | | | | | | | |
| the range of 4 | | | | | | | | | |
| to 17 | | | | | | | | | |
| inclusive) | | | | | | | | | |
| Three Dice | 5 or 16 | 2.8% | 30 to 1 | 13.9% | 31 to 1 | 11.1% | 18 to 1 | 47.2% | 35 to 1 |
| Total | | | | | | | | | |
| (a specific | | | | | | | | | |
| total score in | | | | | | | | | |
| the range of 4 | | | | | | | | | |
| to 17 | | | | | | | | | |
| inclusive) | | | | | | | | | |
| Three Dice | 6 or 15 | 4.6% | 18 to 1 | 12% | 18 to 1 | 12% | 14 to 1 | 30.6% | 103 to 5 |
| Total | | | | | | | | | |
| (a specific | | | | | | | | | |
| total score in | | | | | | | | | |
| the range of 4 | | | | | | | | | |
| to 17 | | | | | | | | | |
| inclusive) | | | | | | | | | |
| Three Dice | 7 or 14 | 6.9% | 12 to 1 | 9.7% | 12 to 1 | 9.7% | 12 to 1 | 9.7% | 67 to 5 |
| Total | | | | | | | | | |
| (a specific | | | | | | | | | |
| total score in | | | | | | | | | |
| the range of 4 | | | | | | | | | |
| to 17 | | | | | | | | | |
| inclusive) | | | | | | | | | |
| Three Dice | 8 or 13 | 9.7% | 8 to 1 | 12.5% | 8 to 1 | 12.5% | 8 to 1 | 12.5% | 65 to 7 |
| Total | | | | | | | | | |
| (a specific | | | | | | | | | |
| total score in | | | | | | | | | |
| the range of 4 | | | | | | | | | |
| to 17 | | | | | | | | | |
| inclusive) | | | | | | | | | |
| Three Dice | 9 or 12 | 11.6% | 7 to 1 | 7.4% | 7 to 1 | 7.4% | 6 to 1 | 19% | 191 to 25 |
| Total | | | | | | | | | |
| (a specific | | | | | | | | | |
| total score in | | | | | | | | | |
| the range of 4 | | | | | | | | | |
| to 17 | | | | | | | | | |
| inclusive) | | | | | | | | | |
| Three Dice | 10 or 11 | 12.5% | 6 to 1 | 12.5% | 6 to 1 | 12.5% | 6 to 1 | 12.5% | 7 to 1 |
| Total | | | | | | | | | |
| (a specific | | | | | | | | | |
| total score in | | | | | | | | | |
| the range of 4 | | | | | | | | | |
| to 17 | | | | | | | | | |
| inclusive) | | | | | | | | | |
| Dice | Two of the | 13.9% | 6 to 1 | 2.8% | 6 to 1 | 2.8% | 5 to 1 | 16.7% | 31 to 5 |
| Combination | dice will | | | | | | | | |
| | show a | | | | | | | | |
| | specific | | | | | | | | |
| | combination | | | | | | | | |
| | of two | | | | | | | | |
| | different | | | | | | | | |
| | numbers | | | | | | | | |
| | (for | | | | | | | | |
| | example, a | | | | | | | | |
| | 3 and a 4) | | | | | | | | |
| Single Dice | The | 1: 34.72% | 1: 1 to 1 | 7.9% | 1: 1 to 1 | 3.7% | 1: 1 to 1 | 7.9% | 1: 1 to 1 |
| Bet | specific | 2: 6.94% | 2: 2 to 1 | | 2: 2 to 1 | | 2: 2 to 1 | | 2: 3 to 1 |
| | number 1, | 3: 0.46% | 3: 3 to 1 | | 3: 12 to 1 | | 3: 3 to 1 | | 3: 5 to 1 |
| | 2, 3, 4, 5, | | | | | | | | (simplest |
| | or 6 will | | | | | | | | version) |
| | appear on | | | | | | | | |
| | one, two, | | | | | | | | |
| | or all three | | | | | | | | |
| | dice | | | | | | | | |
| Four Number | Any three | 11.1% | 7 to 1 | 11.1% | 7 to 1 | 11.1% | 7 to 1 | 11.1% | 8 to 1 |
| Combination | of the four | | | | | | | | |
| | numbers | | | | | | | | |
| | in one of | | | | | | | | |
| | the | | | | | | | | |
| | following | | | | | | | | |
| | specific | | | | | | | | |
| | combinations | | | | | | | | |
| | will | | | | | | | | |
| | appear: 6, | | | | | | | | |
| | 5, 4, 3; 6, | | | | | | | | |
| | 5, 3, 2; 5, | | | | | | | | |
| | 4, 3, 2; or | | | | | | | | |
| | 4, 3, 2, 1 | | | | | | | | |
| Three Single | The dice | 2.8% | 30 to 1 | 13.9% | 30 to 1 | 13.9% | | | 35 to 1 |
| Number | will show | | | | | | | | |
| Combination | a specific | | | | | | | | |
| | combination | | | | | | | | |
| | of three | | | | | | | | |
| | different | | | | | | | | |
| | numbers | | | | | | | | |
| Specific | Two of the | 1.4% | 50 to 1 | 29.2% | 60 to 1 | 15.3% | | | 71 to 1 |
| Double and | dice will | | | | | | | | |
| Single | show a | | | | | | | | |
| Number | specific | | | | | | | | |
| Combination | double and | | | | | | | | |
| | the third | | | | | | | | |
| | die will | | | | | | | | |
| | show a | | | | | | | | |
| | specific, | | | | | | | | |
| | different | | | | | | | | |
| | number | | | | | | | | |

Surprisingly, embodiments of the current disclosure advantageously provide a primary game of bingo that enables direct emulation of even complicated games and wagers with multiple possible wager options, odds, results, and rewards, such as in the game of sic bo.

In the illustrated example of FIG. 6A, the primary game 610 uses a 6×3 card 612 and a call 614 of eighteen for conducting a bingo wager underlying the secondary game 620 of sic bo. The gaming system may present the secondary game 620 to a player, with or without also presenting the primary game 610, such that the player may initiate a wager based on the secondary game 620 by providing an input to the secondary game 620. For example, the player may wager on the “ONE”, “2 and 3”, and “Triple 3” in the secondary game 620 of sic bo, as seen by the placement of chips on the sic bo table in FIG. 6B.

Based on the player's input, the gaming system may enable corresponding rewards in the primary game 610 using final results 630 from the result index adapted to correlate to the respective wager options selected by the player in the secondary game 620, such as shown in FIG. 6C. The enabled final results 630 of the result index and/or rewards for the primary game 610 based on the “ONE”, “2 and 3”, and “Triple 3” wagers are shown in FIGS. 6C-6E, where the “ONE” wager pays 2 (1 to 1 odds), the “2 and 3” wager pays 6 (5 to 1 odds), and the “Triple 3” wager pays 30 (30 to 1 odds). As such, the call 614 may then be provided in the primary game and daubed or compared against the player's card 612 to determine whether the card 612 matches an enabled final result 630 of a result index. Where the card 612 matches an enabled final result 630 the corresponding wager is paid out, and where the card 612 does not match an enabled final result the wager is a loss and no reward is paid out.

As may be gleaned from the described embodiment, a player may receive more than one reward when more than one final result 630 is matched, for example for a “THREE” and “Triple 3” wager in the secondary game 620 of sic bo, although many wager options and the corresponding final results may be mutually exclusive.

As discussed previously, the described embodiments may be adapted to correspond with secondary games other than sic bo. In particular, other dice games (such as craps, etc.) may be readily employed as the secondary game, with cards, calls and final results of the primary game of bingo being adapted to emulate corresponding wager options and results of such a game in the same manner as above. Additional table games such as roulette, blackjack, poker, baccarat, a big six wheel or wheel of fortune, pool, pachinko, chemin de fer, pai gow, a lottery, keno, or any other table game, and the like may be similarly applied as a secondary game by adapting the cards, calls and final results of the primary game of bingo to emulate corresponding wager options and results of such a game.

In certain aspects, the processor may be configured to map a primary game of bingo to actions taken in a secondary game of blackjack. For example, the game of blackjack involves dealing cards to a player and a dealer with the winner having the higher hand without surpassing a combined value of twenty-one. Accordingly, a set of bingo cards may be provided in the primary game that map to a respective card in a deck or decks of playing cards for the secondary game of blackjack. Each “turn” or action in a blackjack game may correspond to a bingo card, such that a payout or loss per “turn” may be based on the bingo card, or bingo cards, or any patterns thereof.

By way of example, in a secondary game of blackjack the player receives an initial hand and may select whether to “hit” and receive an additional card or “stay” and proceed with the initial hand as dealt. In the underlying primary game of bingo, the player may be served two bingo cards corresponding to the initial hand, with the bingo cards of the initial hand being evaluated to determine a combination value. Two bingo cards may be served to a dealer's hand and evaluated in a similar manner. Should the player elect to “hit”, a further bingo card may be added to the initial hand with the bingo cards being evaluated to determine a new combination value. When the player elects to “stay”, the dealer's hand may be revealed and the dealer may “hit” or “stay” with a corresponding update to the combination value of the dealer's hand.

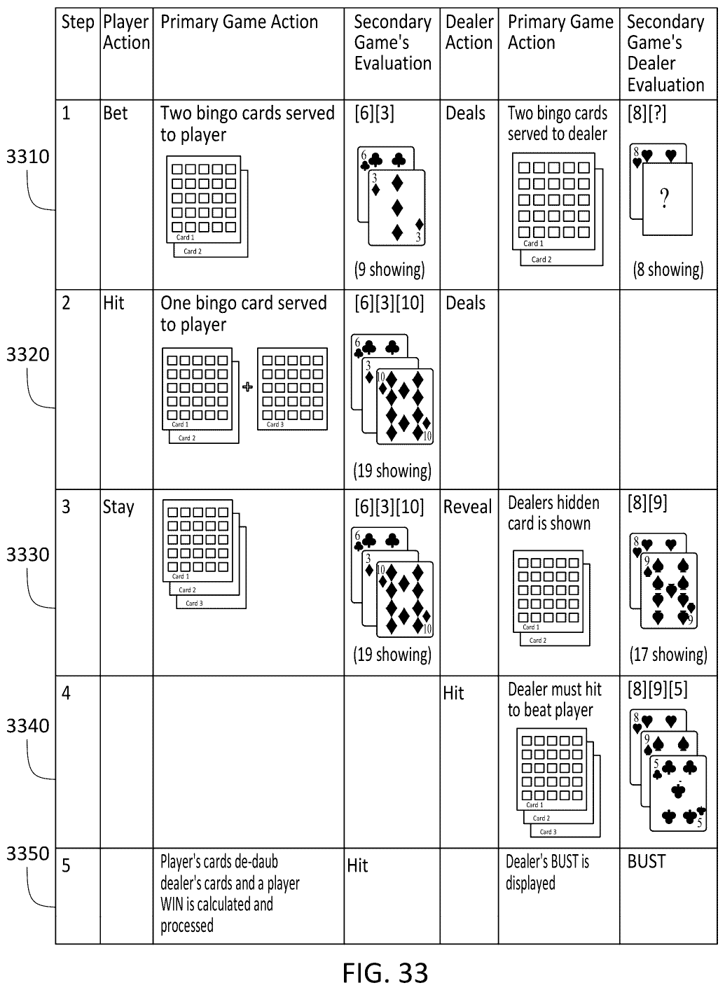

An illustrated embodiment for a single player and a simulated dealer in a secondary game of blackjack based on an underlying primary game of bingo is provided in FIG. 33. As shown in a first step 3310, a player may provide a bet or wager to the gaming machine and two bingo cards may be served to the player in the underlying primary game. The two bingo cards provided to the player are evaluated to determine a combination value and a corresponding player hand for the secondary game. In this case, the player's two bingo cards are evaluated as corresponding to an initial hand in the secondary game of blackjack showing a value of nine, illustrated as a six of clubs and a three of diamonds. Two bingo cards are served to a dealer in the primary game and evaluated in a similar manner to determine a dealer's hand in the secondary game of blackjack, but with one of the dealer's cards hidden from the player. As seen in FIG. 33, the game's dealer evaluation yields a value of eight showing, illustrated as an eight of hearts.

In a second step 3320, the player elects to hit and one additional bingo card is served to the player and the game's player evaluation is updated to reflect a change in the combination value of the bingo cards, illustrated as a six of clubs, a three of diamonds, and a ten of diamonds showing a combination value of nineteen. The player then elects to stay in a third step 3330 and the dealer's hidden card is shown, in this case yielding a value of seventeen showing, illustrated as an eight of hearts and a nine of spades. As the dealer must hit in order to beat the player, an additional bingo card is provided to the dealer in a fourth step 3340, in this case yielding a dealer “BUST” based on a value twenty-two showing, illustrated as an eight of hearts, a nine of spades, and a five of clubs.

As seen in FIG. 33, a fifth step 3350 provides an evaluation of the player's bingo cards and the dealer's bingo cards, with the player's bingo cards de-daubing the dealer's bingo cards and a player win being calculated and processed in the underlying primary game of bingo. Based on the result of the underlying primary game of bingo, the secondary game displays a dealer BUST and a corresponding player win for the secondary game of blackjack.

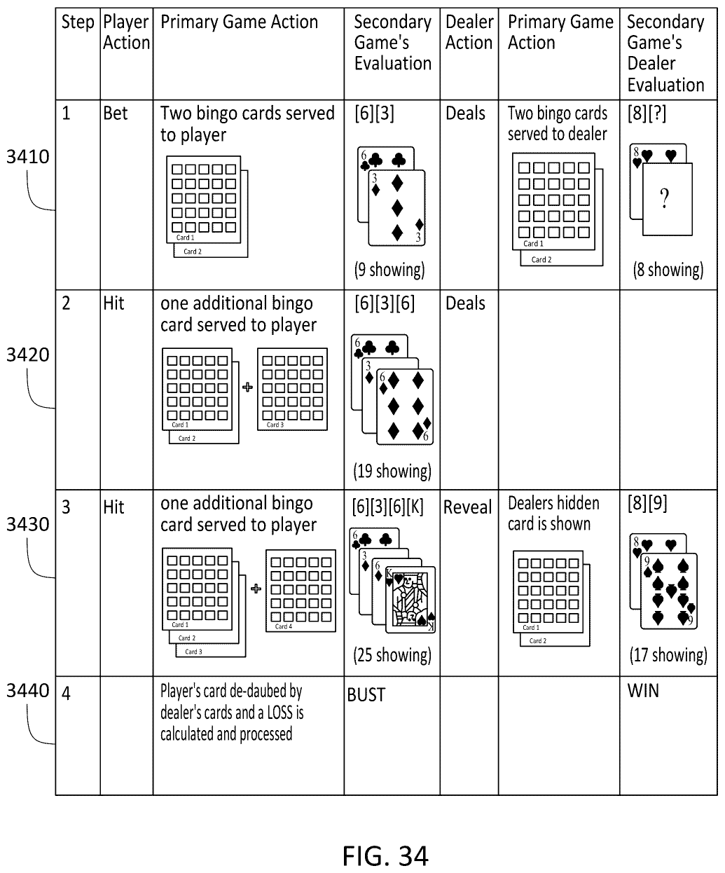

A further example of a primary game of bingo and a secondary game of blackjack is provided in FIG. 34, but where a player hits to a loss instead of a player hitting to a win as in the example of FIG. 33. As shown in a first step 3410, a player may provide a bet or wager to the gaming machine and two bingo cards may be served to the player in the underlying primary game. The two bingo cards provided to the player are evaluated to determine a combination value and a corresponding player hand for the secondary game. In this case, the player's two bingo cards are evaluated as corresponding to an initial hand in the secondary game of blackjack showing a value of nine, illustrated as a six of clubs and a three of diamonds. Two bingo cards are served to a dealer in the primary game and evaluated in a similar manner, but with one of the dealer's cards hidden from the player. As seen in FIG. 34, the game's dealer evaluation yields a value of eight showing, illustrated as an eight of hearts.

In a second step 3420, the player elects to hit and one additional bingo card is served to the player and the game's player evaluation is updated to reflect a change in the combination value of the bingo cards, illustrated as a six of clubs, a three of diamonds, and a six of diamonds showing a combination value of fifteen. The player then elects to hit again in a third step 3430 and one additional bingo card is served to the player and the game's player evaluation is updated to reflect a change in the combination value of the bingo cards, illustrated as a six of clubs, a three of diamonds, a six of diamonds, and a king of hearts, yielding a player “BUST” and showing a combination value of twenty-five. The dealer's hidden card may be shown, in this case yielding a value of seventeen showing, illustrated as an eight of hearts and a nine of spades.

As shown in a fourth step 3440 of FIG. 34, the player's bingo cards are de-daubed by the dealer's bingo cards and a loss is calculated and processed in the underlying primary game of bingo. Based on the result of the underlying primary game of bingo, the secondary game displays a player “BUST” and a dealer win with a corresponding player loss for the secondary game of blackjack.

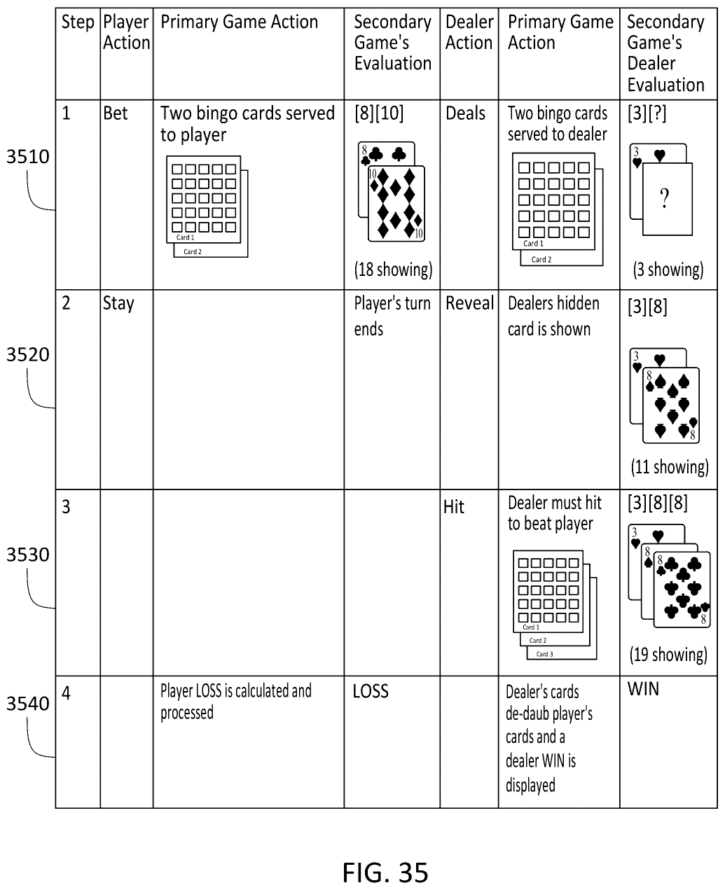

A further example of a primary game of bingo and a secondary game of blackjack is provided in FIG. 35, but where a player stays to a loss. As shown in a first step 3510, a player may provide a bet or wager to the gaming machine and two bingo cards may be served to the player in the underlying primary game. The two bingo cards provided to the player are evaluated to determine a combination value and a corresponding player hand for the secondary game. In this case, the player's two bingo cards are evaluated as corresponding to an initial hand in the secondary game of blackjack showing a value of eighteen, illustrated as an eight of clubs and a ten of diamonds. Two bingo cards are served to a dealer in the primary game and evaluated in a similar manner, but with one of the dealer's cards hidden from the player. As seen in FIG. 35, the game's dealer evaluation yields a value of three showing, illustrated as a three of hearts.

In a second step 3520, the player elects to stay and the dealer's hidden card is shown, in this case yielding a value of eleven showing, illustrated as a three of hearts and an eight of spades. As the dealer must hit in order to beat the player, an additional bingo card is provided to the dealer in a third step 3530, in this case yielding a value of nineteen showing, illustrated as a three of hearts, an eight of spades, and an eight of clubs. As shown in a fourth step 3540 of FIG. 35, the player's bingo cards are de-daubed by the dealer's bingo cards and a loss is calculated and processed in the underlying primary game of bingo. Based on the result of the underlying primary game of bingo, the secondary game displays a player loss and a dealer win with a corresponding player loss for the secondary game of blackjack.

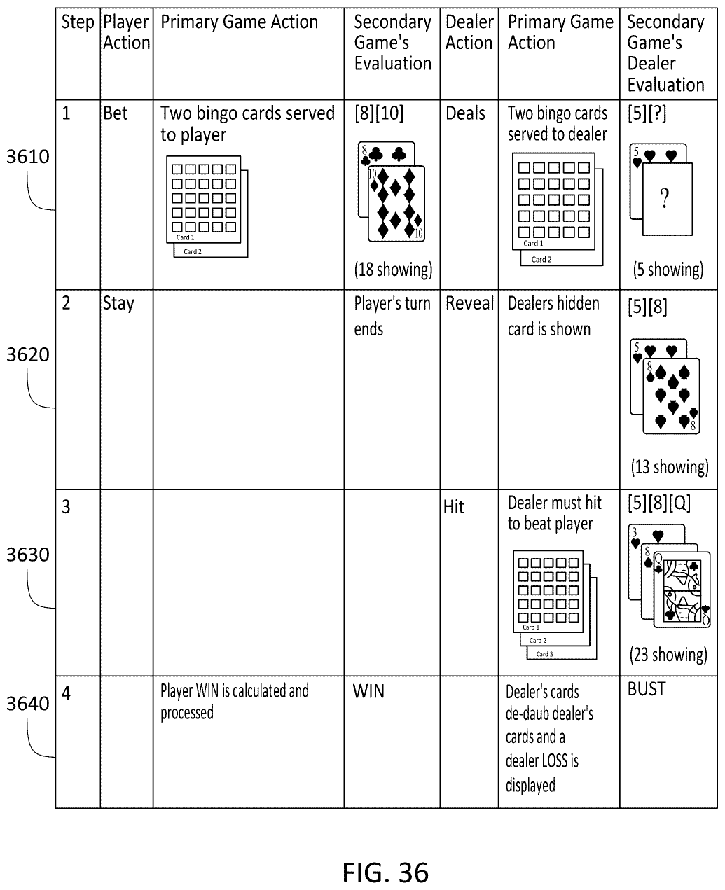

A further example of a primary game of bingo and a secondary game of blackjack is provided in FIG. 36, but where a player stays to a win. As shown in a first step 3610, a player may provide a bet or wager to the gaming machine and two bingo cards may be served to the player in the underlying primary game. The two bingo cards provided to the player are evaluated to determine a combination value and a corresponding player hand for the secondary game. In this case, the player's two bingo cards are evaluated as corresponding to an initial hand in the secondary game of blackjack showing a value of eighteen, illustrated as an eight of clubs and a ten of diamonds. Two bingo cards are served to a dealer in the primary game and evaluated in a similar manner, but with one of the dealer's cards hidden from the player. As seen in FIG. 36, the game's dealer evaluation yields a value of five showing, illustrated as a five of hearts.

In a second step 3620, the player elects to stay and the dealer's hidden card is shown, in this case yielding a value of thirteen showing, illustrated as a five of hearts and an eight of spades. As the dealer must hit in order to beat the player, an additional bingo card is provided to the dealer in a third step 3630, in this case yielding a dealer “BUST” based on a value twenty-three showing, illustrated as a five of hearts, an eight of spades, and a queen of clubs. As seen in FIG. 36, a fourth step 3640 provides an evaluation of the player's bingo cards and the dealer's bingo cards, with the player's bingo cards de-daubing the dealer's bingo cards and a player win being calculated and processed in the underlying primary game of bingo. Based on the result of the underlying primary game of bingo, the secondary game displays a dealer BUST and a corresponding player win for the secondary game of blackjack.

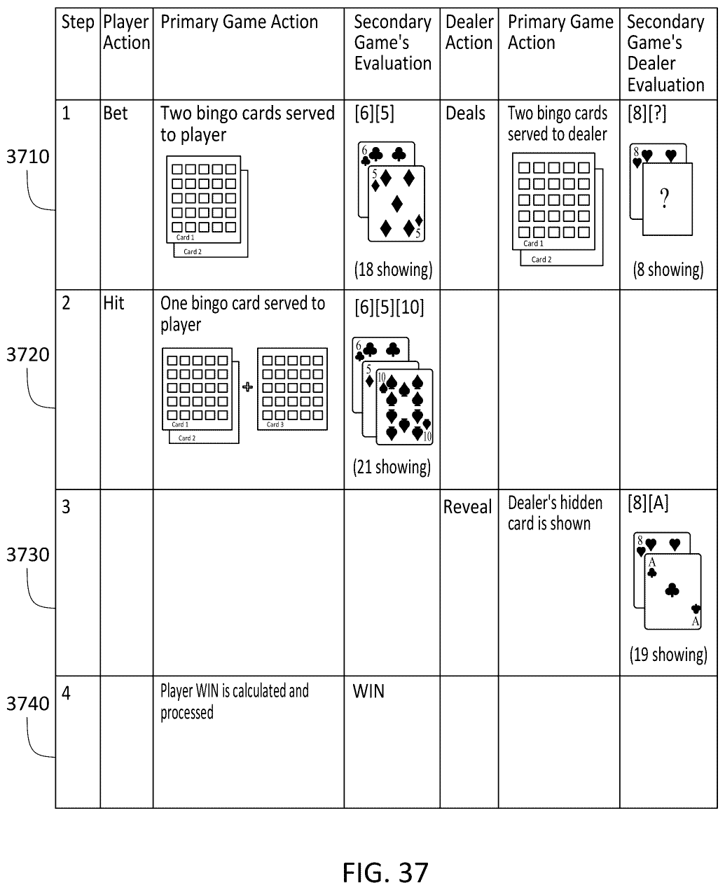

In a variation on the embodiments of FIGS. 33-36, a primary game of bingo may be provided where one or more players are able select and wager on a bingo card(s) or even on a same card. To facilitate this change in wager, the primary game may have a bingo card related on a one-to-one basis with possible outcomes or patterns, such that players are betting on a bingo card being a winner with that pattern. An example of an embodiment where players may wager on a bingo card being a winner in a primary game of bingo is illustrated in FIG. 37, with a secondary game of blackjack.

In the example of FIG. 37, a player provides a wager of 100 credits and receives two bingo cards. As described previously, the player's wager is that their two bingo cards are more valuable than a dealer's two bingo cards. The decision to “stay” or “hit” corresponds with a wager that an added bingo card will continue to yield a hand that is more valuable than the dealer's cards. As shown in a first step 3710, two bingo cards are be served to the player in the underlying primary game based on the player's wager. The two bingo cards provided to the player are evaluated to determine a combination value and a corresponding player hand for the secondary game. In this case, the player's two bingo cards are evaluated as corresponding to an initial hand in the secondary game of blackjack showing a value of 11, illustrated as a six of clubs and a five of diamonds. Two bingo cards are served to a dealer in the primary game and evaluated in a similar manner, but with one of the dealer's cards hidden from the player. As seen in FIG. 37, the game's dealer evaluation yields a value of eight showing, illustrated as an eight of hearts.

In a second step 3720, the player elects to hit and one additional bingo card is served to the player and the game's player evaluation is updated to reflect a change in the combination value of the bingo cards, illustrated as a six of clubs, a five of diamonds, and a ten of spades showing a combination value of twenty-one. In a third step 3730 the dealer's hidden card is shown, in this case yielding a value of nineteen showing, illustrated as an eight of hearts and an ace of clubs. A fourth step 3740 provides an evaluation of the player's bingo cards and the dealer's bingo cards, with the player's bingo cards being more valuable than the dealer's bingo cards and a player win being calculated and processed in the underlying primary game of bingo. Based on the result of the underlying primary game of bingo, the secondary game displays a player win for the secondary game of blackjack.

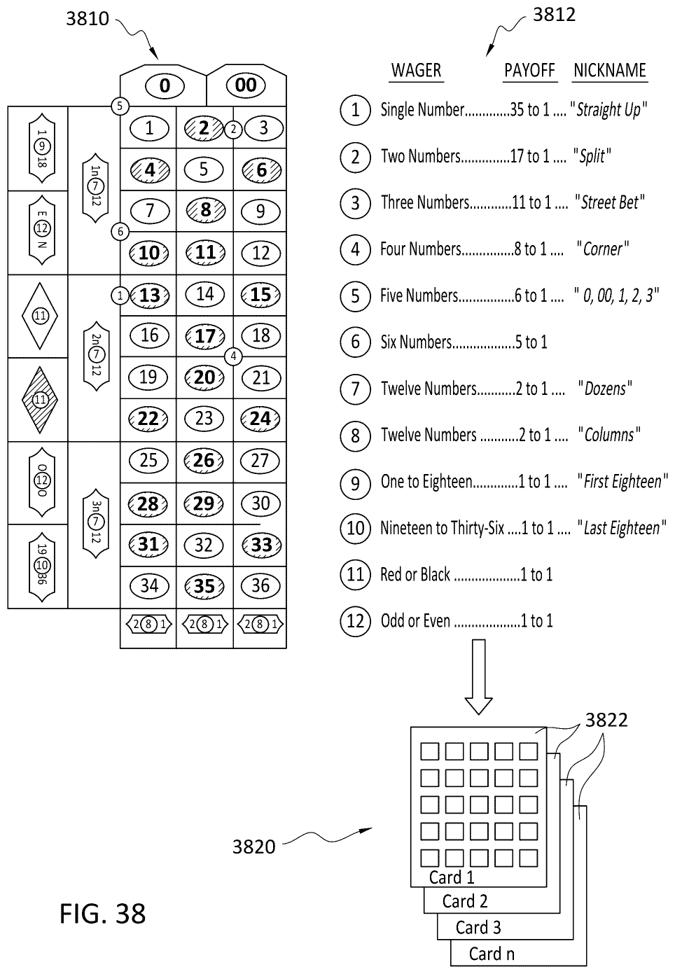

Notably, while discussed with respect to a secondary game of blackjack, the varying embodiments may be provided with a secondary game comprising another game, table game or the like. For example, FIG. 38 illustrates an embodiment similar to that of FIG. 37, but with a secondary game 3810 of roulette rather than a secondary game of blackjack. In the embodiment of FIG. 38, a secondary game of roulette 3810 is provided having a plurality of bet combinations 3812. Each of the bet combinations 3812 may be mapped to respective bingo card 3822 in an underlying primary game 3820 of bingo, where odds of the bingo card 3822 being a winner in the primary game are correlated to the odds of a respective bet combination in roulette. As such, a player may select a bet combination 3812 in the secondary game 3810 of roulette and purchase the corresponding bingo card 3822 in the primary game 3820, a result of the primary game 3820 then corresponding to a result in the secondary game 3810 of roulette. Players may wager on multiple bingo cards 3822 by selecting multiple bet combinations in the secondary game 3810 of roulette, and multiple players may wager on the same bingo card 3822.

For example, in a game having three players, a first player may bet twenty credits on “One to Eighteen”, i.e., numbers one through eighteen, in the secondary game 3810 of roulette which is configured to correlate to a bingo card 3822 in the underlying primary game 3820 of bingo having similar odds (e.g., one-to-one odds). A second player may bet ten credits on “Black”, i.e., all black numbers, in the secondary game 3810 which is configured to correlate to a bingo card 3822 in the underlying primary game 3820 of bingo having similar odds (e.g., one-to-one odds). A third player may bet fifty credits on “Columns” for column one, i.e., twelve numbers (1,4,7,10,13,16,19,22,25,28,31,34), in the secondary game 3810 which is configured to correlate to a bingo card 3822 in the underlying primary game 3820 of bingo having similar odds (e.g., two-to-one odds). As such, the result of the underlying primary game 3820 of bingo may then be evaluated and mapped directly to the result of the secondary game 3810. The embodiments of FIGS. 37-38 may be configured to facilitate additional features and/or actions, such as the result of a “BUST” and/or an action corresponding to a “double-down” bet and/or the like.

For secondary game types having a set payout structure, such that a direct correspondence between the payout of the underlying primary game wager and a simulated payout of the secondary game may not exist, an added flexible award table may be used in the secondary game, such as to handle an effect of multiple bingo pattern hits occurring in the underlying primary game. The awards of the secondary games may be progressive values, static or a mix of progressive and static. In certain embodiments, the awards may all be static but the number of awards available may be varied to correlate the payouts of the secondary games and the primary game. The secondary game thereby provides an advantageous variability and entertainment for the player, while maintaining a simplified and streamlined underlying primary gaming mechanism, e.g., based on the game of bingo.

In varying embodiments, a secondary game of blackjack or the like may be provided having a conventional static award table while the primary game includes a payout structure that varies based on a number of bingo pattern hits, etc. As the payout award of the secondary game is based on the underlying wager in the primary game, the secondary game may be modified to address any discrepancies between the value of the static award table of the secondary game and the payout of the primary game by including a bonus game having a flexible award table and/or by incorporating a flexible award table into the secondary game. A bonus game may comprise any additional game, such as a further game or a new game, configured to provide a bonus award equal to the difference between the static award of the secondary game and the award of the primary game. These additional award presentations provide players with an additional way to win a larger prize than is traditionally won during a game of blackjack.

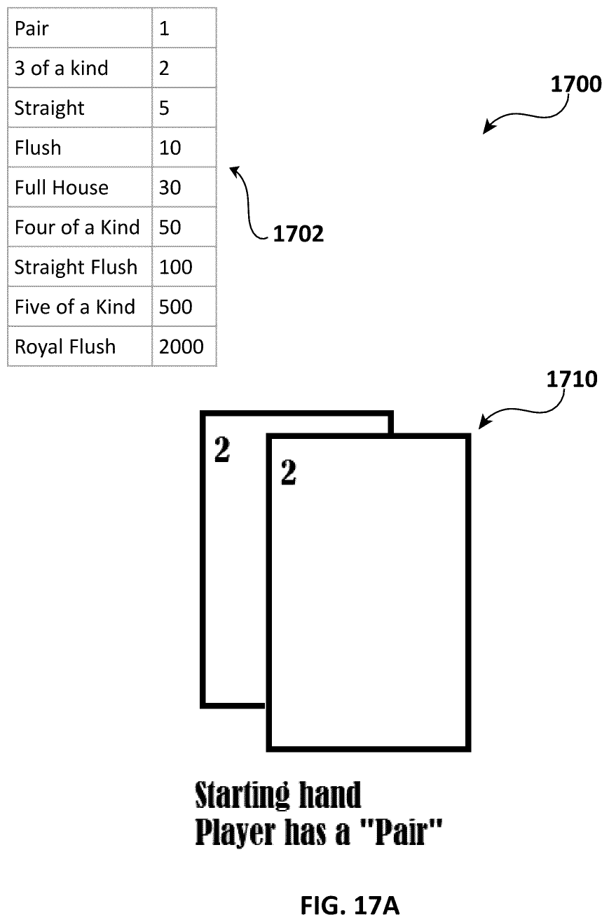

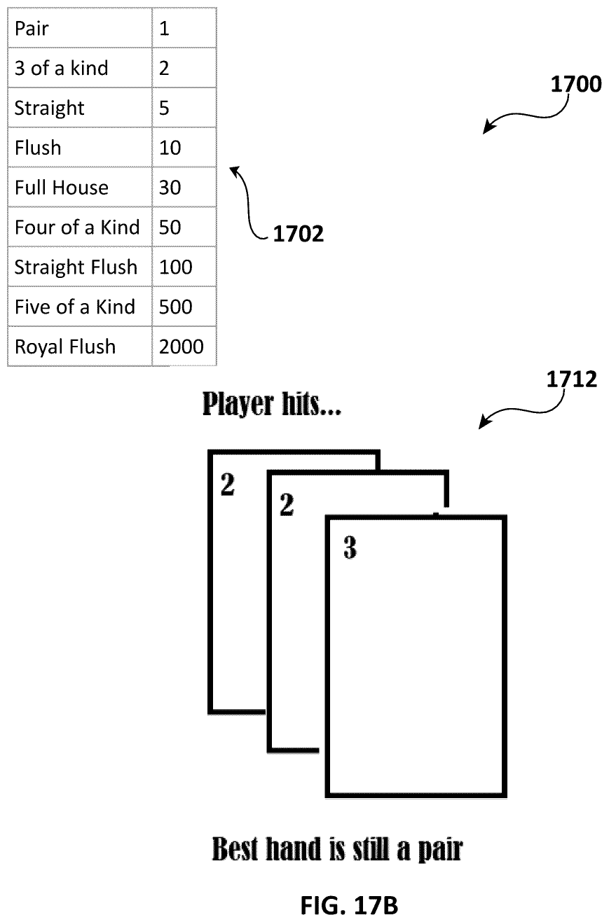

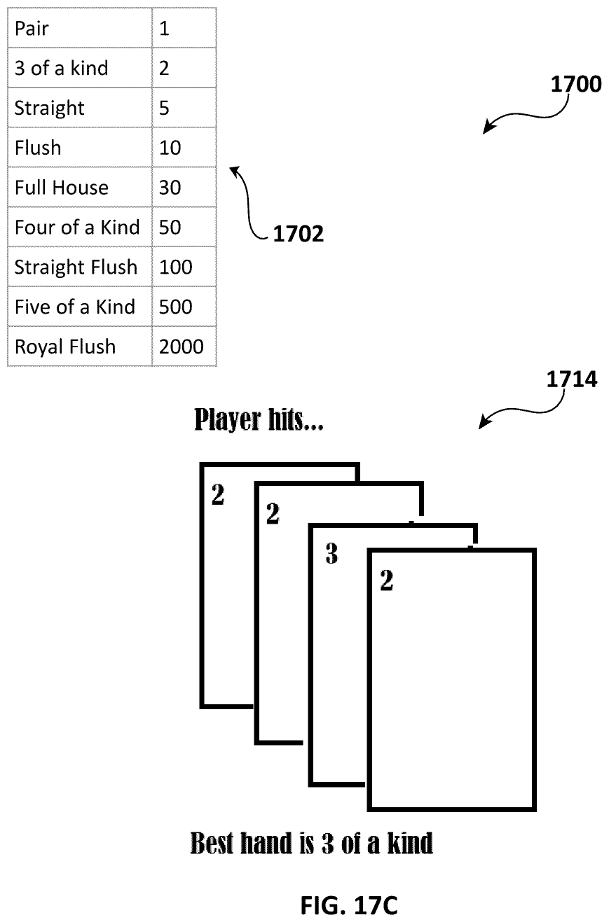

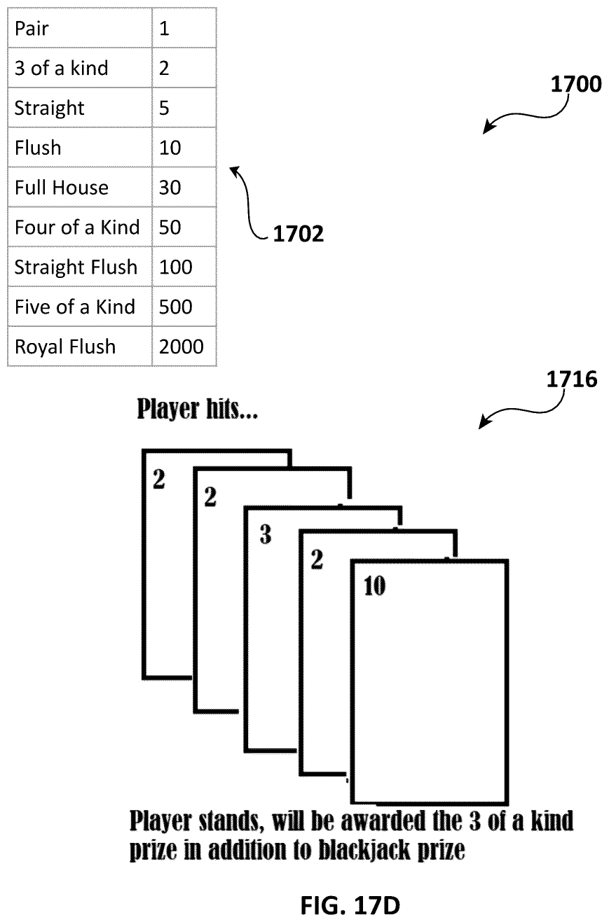

In the illustrated example of FIG. 17A, an additional poker hand award table 1702 is available to players prior to an initial deal of player cards in a secondary game of blackjack 1700 and a final presentation of a card flip is configured to allow for bonus triggers. Notably, the additional poker hand table 1702 is applicable starting with two cards in the initial deal of cards to the player's hand 1710. According to the initial hand 1710 shown in FIG. 17A, the player has a “Pair” based on the pair of twos in the initial hand 1710 and may already qualify for the corresponding award in the additional poker hand award table 1702.

As a player keeps playing and hitting during the secondary game of blackjack 1700, their cards will be constantly reevaluated with respect to the additional poker hand table 1702 to determine the best poker hand that could be formed from their cards. As such, additional hits during the secondary game of blackjack may add to the award value for the wager of the secondary game 1700. Additional expansion of the award table 1702 can be made possible by including suits and/or creating new secondary attributes for the cards.

FIG. 17B, FIG. 17C and FIG. 17D illustrate the continuation of the secondary game 1700 according to FIG. 17A. In FIG. 17B the player hits and receives an additional card to their hand 1712, the additional card being a three such that the best hand is still a pair. In FIG. 17C, the player hits again and receives an additional card to their hand 1714. In this case the additional card is another two, meaning that the best poker hand from the additional poker hand table 1702 for the player's hand 1714 is now three of a kind. According to FIG. 17D, the player again elects to hit and receives another card. Here, the player's final hand 1716 qualifies for the three of a kind prize from the additional poker hand table 1702 in addition to the blackjack prize. In this case, the player elects to stand in the secondary game 1700 of blackjack based on the player's hand 1716 totaling nineteen, and the secondary game 1700 ends with the player receiving both the three of a kind prize from the additional poker hand table 1702 in addition to the blackjack prize, the total value corresponding to a value of a wager in an underlying primary game, such as a bingo wager.

It should be noted that the use of the additional poker hand table 1702 may be adjusted to include any other card values, or even a secondary attribute according to other embodiments described herein. As such, the additional poker hand table may be replaced with another secondary award table based on another characteristic, feature, and/or result of the secondary game. The secondary game may therefore include a flexible award table that can have prize awards that may be static value awards, progressive value awards, bonus game triggering awards, and/or some combination of static value awards, progressive value awards, and bonus game triggering awards. In like manner, the number of awards available may be static or may be progressively varied based on the value of the bingo wager, e.g., with multiple pattern hits, in the underlying primary game. The awards may be provided as credits or another value, as multiplier values, bonus triggers, etc.

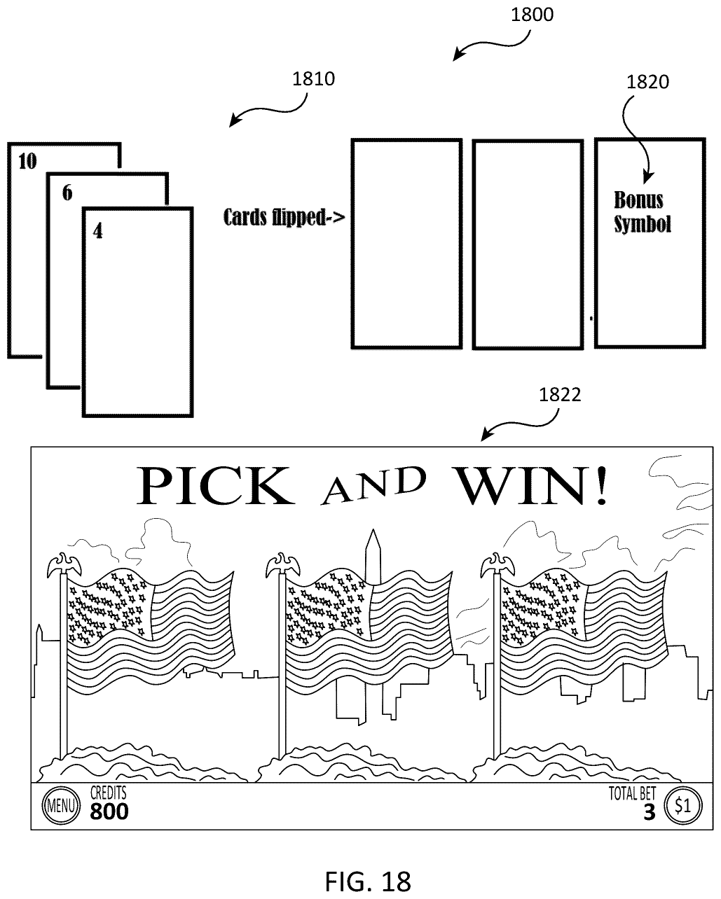

In an embodiment according to FIG. 18, in combination with or separate from the embodiment of FIG. 17A-17D, when a secondary game of blackjack 1800 ends without a win or a value of a win of the secondary game still needs to be increased to reach a value of a wager in an underlying primary game, the cards of the player's hand 1810 may be flipped over to their opposite sides to reveal the presence or absence of a secondary attribute 1820. For example, if at least one cards contains a “Bonus” symbol then a bonus game 1822 will be awarded. The bonus game may comprise any additional game, such as a further blackjack game or a new game, configured to provide a bonus award equal to the difference between the award of the secondary game and the award of the underlying primary game. In the illustrated example of FIG. 18, a picking game may be provided as a bonus game 1822, where the player picks a part of an entertaining display to reveal a bonus award value or multiplier.

As with previous embodiments, the win value of the bonus game 1822 would be configured to correspond with the final result of a result index of the underlying primary game, such that a corresponding reward or loss may be disbursed to the player at the gaming system. In this manner, the wager result of the secondary game, including the blackjack game and the additional poker hand table, may correspond to the wager result or final result of the primary game, such as a bingo game, which may be shown in another window, part of the entertaining display, or only used in a game engine. This is realized even though the secondary game of blackjack generally requires static award values and the primary game may include multiple bingo pattern hits, due to the additional award table and/or bonus game of the secondary game providing the difference between the award values.

Notably, while described in the embodiment of FIG. 18 as being on an opposite side of the playing cards in the game of blackjack, secondary attributes may be provided on any part of the playing cards, such as in the form of a “scratcher” subsection that is revealed at the end of the game or the like. According to varying embodiments, secondary attribute 810 may simply indicate whether a bonus game is won, may provide a multiplier value for the wager of the secondary game, additional credits, or otherwise communicate an adjustment that allows the awards of the secondary game to correspond to the awards of the primary game, whether or not the awards of the secondary game are static or flexible.

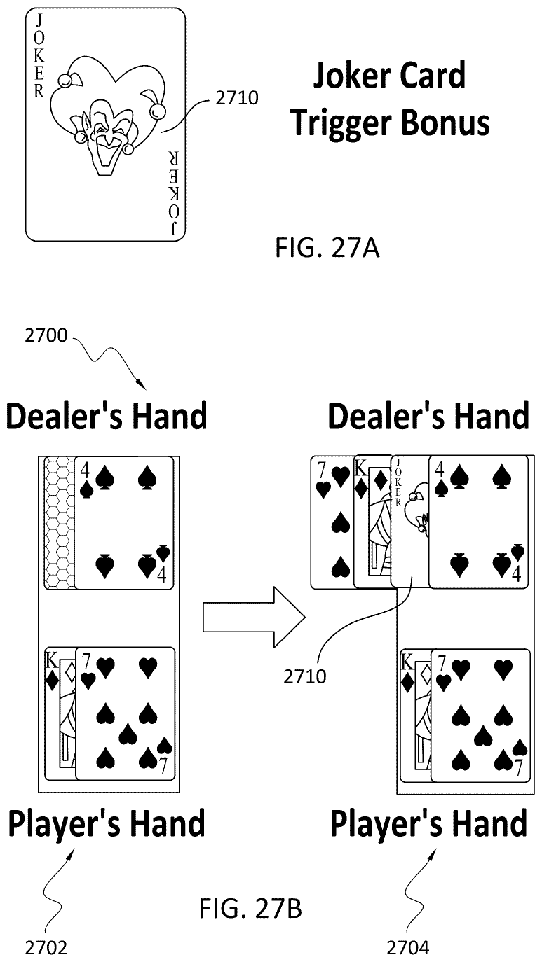

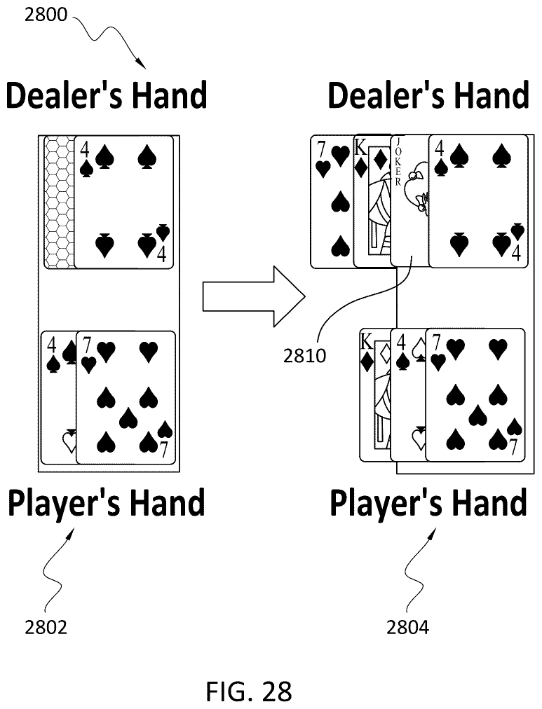

In another embodiment, the secondary game may be adjusted to include a secondary attribute in the form of an additional card in the deck. In the embodiment of FIGS. 27A-27B, the secondary attribute is a joker card 2710. FIG. 27B illustrates a secondary game 2700 of blackjack where a secondary attribute has been added to the deck in the form of a joker card 2710 that may or may not affect the value of a hand but that triggers a bonus game. According to varying embodiments, secondary attribute may simply indicate whether a bonus game is won, may provide a multiplier value for the wager of the secondary game, or otherwise communicate a wager adjustment that allows the awards of the secondary game to correspond to the awards of the primary game, whether or not the awards of the secondary game are static or flexible.

In the game of FIG. 27B, an initial hand 2702 of playing cards has provided the player with a king and a seven, for a total value of seventeen, while the dealer has a four. With a final hand 2704 of playing cards in the example of FIG. 27B, the player decides to “stay”, resulting in a value of seventeen while the dealer's hand has a value of twenty-one but also includes a joker card 2710. The player has lost the hand, however, the wager result of the underlying primary game in this case is a win. To address this difference, the joker card 2710 has been revealed to trigger a bonus game.

As the payout award of the secondary game 2700 is based on the underlying wager in the primary game, the secondary game 2700 may be modified to address any discrepancies between the value of the award table of the secondary game and the payout of the primary game by providing a bonus game, for example having a flexible award table. The bonus game may comprise any additional game, such as a further blackjack game or a new game, configured to provide a bonus award equal to the difference between the award or loss of the secondary game and the award of the primary game. In one example, a picking game may be provided as a bonus game, where the player picks a part of an entertaining display to reveal a bonus award value or multiplier.

For the secondary game of blackjack, the possible awards for a win include a push for ties, two-to-one for wins, and two and a half to one for player blackjack, which could be made to correspond with the final result of a result index of an underlying primary game based on bingo, such that a corresponding reward or loss may be disbursed to the player at the gaming system. In this manner, the wager result of the secondary game, including the blackjack game and the secondary attribute, may correspond to the wager result or final result of the primary game, such as a bingo game, which may be shown in another window, part of the entertaining display, or only used in a game engine. This is realized even though the secondary game of blackjack generally requires static award values and the primary game may include multiple bingo pattern hits, due to the additional award table and/or bonus game of the secondary game providing the difference between the award values.

In a similar way, secondary attributes may be provided to account for poor gameplay decisions made by a player in the secondary game, as depicted in FIG. 28. For the game of FIG. 28, the player has won the final result of a result index of the primary game with a value of $2 on a $0.50 wager. So, in this case, the secondary game 2800 is configured to provide the player with a winning award of $2. To do so, the secondary game 2800 provides the player an initial hand 2802 with a value of eleven, in the form of a four of spades and seven of hearts, while the dealer holds only a value of four. The best decision for a blackjack player in this circumstance is to “double-down”, meaning the player doubles their bet in the middle of the game and receives only one more card, and the secondary game 2800 is configured to provide a winning result to such a “double-down” bet in order to realize the payout award of $2.

However, the player is allowed to play the secondary game, rather than only observing, meaning that the player can make poor decisions and elect not to “double-down”. With a final hand 2804 of playing cards in the example of FIG. 28, the player decides to “hit” and receives a king, resulting in a value of twenty-one while the dealer's hand also has a value of twenty-one. The resulting tie corresponds to a “push” payout, meaning a bet of $0.50 would correspond to an award of $0.50 which is less than the $2 as in the underlying primary game win. To address this difference, a joker card 2810 was used to trigger a bonus game to award the additional $1.50 for a total win of $2 corresponding to the underlying primary game. Of course, any variation of a bonus value, a bonus game, a bonus multiplier or the like may be employed, such that the secondary attribute can be used to adjust a secondary game award to match a primary game award value.

By breaking the reward value of the wager into more than one secondary game, a correspondence between the payout of the wager and the simulated payouts may be provided. For example, where a player's wager was successful based on the underlying bingo game, a secondary game of blackjack may be provided so that the simulated result of the secondary game cumulatively corresponds to the final result of the primary game. Due to the static nature of awards in table games, such as blackjack, an added flexible award table may be used to handle an effect of variation in multiple bingo pattern hits or similarly flexible awards in an underlying bingo game. The awards of the extra game may be progressive values, static or a mix of progressive and static. In certain embodiments, the awards may all be static but the number of awards available may be varied to correlate the payouts of the secondary games and the primary game. The secondary game thereby provides an advantageous variability and entertainment for the player, while maintaining a simplified and streamlined underlying gaming mechanism based on bingo.

The additional poker hand award table, secondary attribute and/or bonus game being presented as an extension of the secondary game increases player engagement and enjoyment, by providing the player with increasingly varied and exciting gameplay based on a primary game wager, such as bingo. Advantageously, the use of the secondary game including an additional poker hand award table or bonus game as described allows the player to enjoy playing a secondary game even where the awards corresponding to the secondary game do not directly correspond with the value of the underlying primary game, such as with a table game or more specifically in the example of FIGS. 17A-17D a blackjack game, and the awards for the primary game include multiple bingo hits or are otherwise varied.

In another example, where a player's wager was successful based on a final result of a result index of an underlying primary game, a secondary game of keno may be provided and the player may be permitted to select a predetermined number of spots, whether simultaneously or iteratively, so that the simulated result of the secondary game cumulatively corresponds to the final result of the primary game. For a secondary game of keno, the gaming machine may present the player with a card including a plurality of numbered spots (commonly eighty spots) and an award table based on the predicted result of a ball call. Keno players select a predetermined number of spots and receive a payout based on how many of the selected spots match the ball call, commonly referred to as “hits”. The payout odds may be based on the probability of a certain number of hits, reflecting the number of spots, the predetermined number of selected spots, and/or the number of balls called.

Due to the static nature of awards in table games, such as keno, an added flexible award table may be used to handle an effect of variation in an award value of the primary game, such as based on multiple bingo pattern hits. The awards of the flexible award table may be progressive values, static or a mix of progressive and static. In certain embodiments, the awards may all be static but the number of awards available may be varied to correlate the payouts of the secondary games and the primary game. The secondary game thereby provides an advantageous variability and entertainment for the player, while maintaining a simplified and streamlined underlying gaming mechanism based on an underlying primary game, such as bingo.

In an embodiment, a secondary game of keno may be provided having a static award table while the primary game includes a payout structure that varies based on a number of bingo pattern hits, etc. As the payout award of the secondary game is based on the underlying wager in the primary game, the secondary game may be modified to address any discrepancies between the value of the static award table of the secondary game and the payout of the primary game by including a bonus game having a flexible award table and/or by incorporating a flexible award table into the secondary game. A bonus game may comprise any additional game, such as a further game or a new game, configured to provide a bonus award equal to the difference between the static award of the secondary game and the award of the primary game. These additional award presentations provide players with an additional way to win a larger prize than is traditionally won during a game of keno.

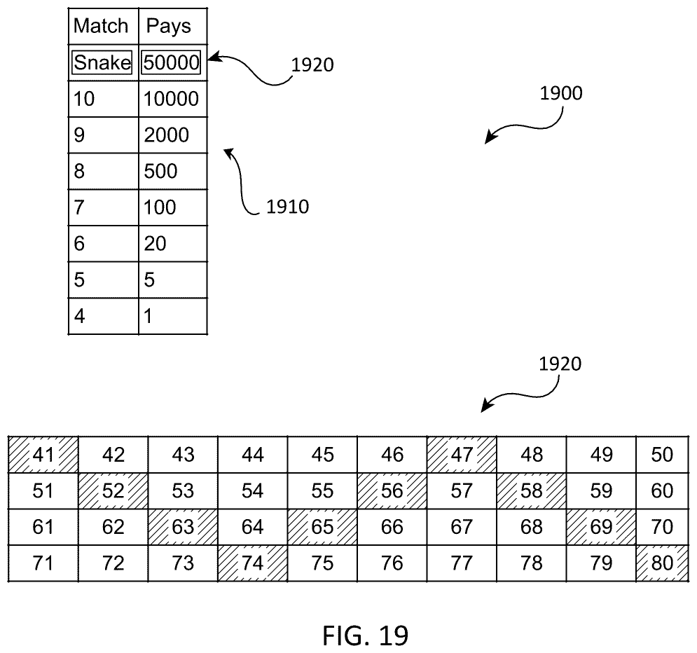

According to FIG. 19, rather than a bonus game that is separate or separate but related to or dependent on the secondary game, a bonus game or flexible award table may be directly integrated into the gameplay of the secondary game as a secondary aspect of the secondary game. In the illustrated embodiment of FIG. 19, secondary game of keno is provided having an award table that adds one or more patterns to allow for more than standard match awards. For a standard game of keno, the player may be presented with a card including a plurality of numbered spots (commonly eighty spots) and an award table based on the predicted result of a ball call. Keno players select a predetermined number of spots and receive a payout based on how many of the selected spots match the ball call, commonly referred to as “hits”. The payout odds may be based on the probability of a certain number of hits, reflecting the number of spots, the predetermined number of selected spots, and/or the number of balls called. However, traditional award values for keno may not match award values of an underlying primary game, such as based on bingo.

In the embodiment of FIG. 19, keno is provided as a secondary game where a modified award table may be directly integrated into the gameplay of the secondary game, the modified award table allowing a secondary aspect of the secondary game to modify a payout award of the secondary game. As the payout award of the secondary game is based on the underlying wager in the primary game, the secondary game may be modified to address any discrepancies between the value of the traditional or conventional award table of the secondary game and the award of the primary game, e.g., for multiple bingo pattern hits, by including a modified award table.

As shown in FIG. 19, a keno game 1900 is provided as a secondary game including a pay table 1910 with an award value for a number of matches or hits between player predictions and a ball call. However, in contrast to conventional games of keno, the secondary game 1900 of FIG. 19 includes a modified pay table 1910 that allows for more than the standard match awards by adding secondary attributes or side bets in the form of patterns on the keno card, for modifying the award value of the keno game 1900 to reflect the award value of the underlying primary game.

For the illustrated embodiment of FIG. 19, the pay table 1910 includes an award corresponding to an additional pattern 1920 in the form of a “snake” pattern. As an additional pattern 1920, the snake pattern may correspond to a ball call including numbers 41, 52, 63, 74, 65, 56, 47, 58, 69, 80, as shown in FIG. 19, but any additional pattern may be used according to the preferred parameters or presentation. In the embodiment of FIG. 19, when the player's matches include the additional pattern 1920, a player may receive an award for both a number of matches achieved and/or an award for the additional pattern 1920.

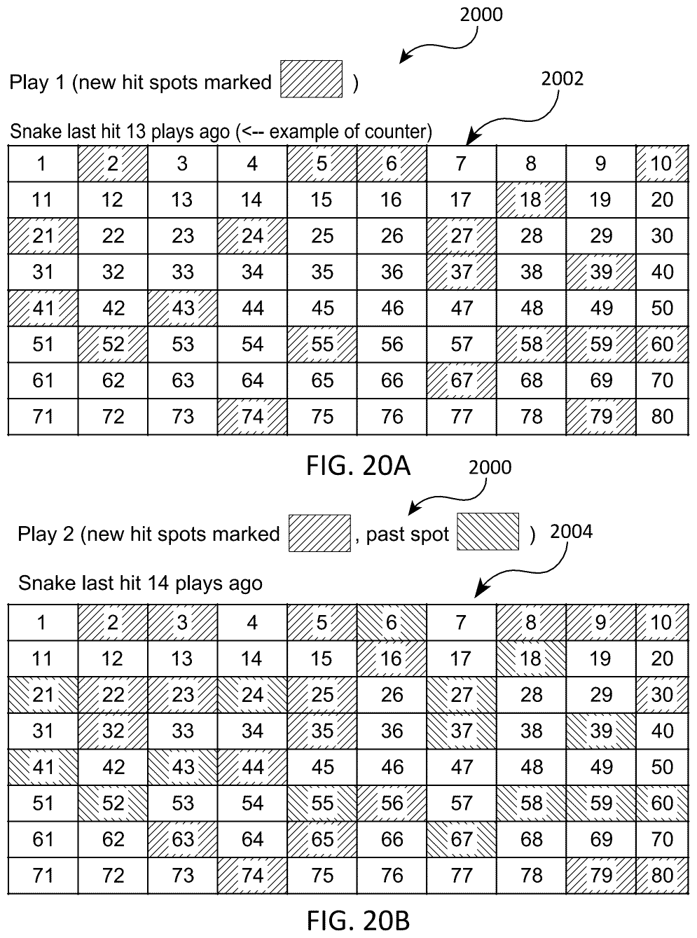

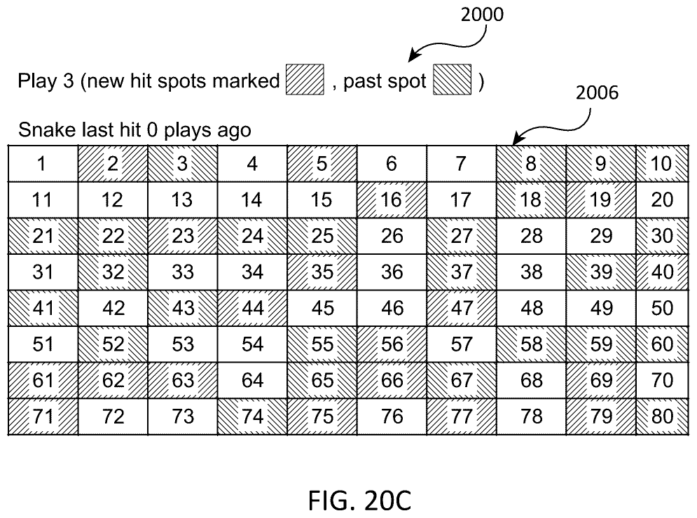

In a varying embodiment according to FIG. 20A, FIG. 20B and FIG. 20C, the additional pattern 1920 may be achieved in a cumulative manner over a plurality of plays or ball calls. This cumulative effect adds a layer of excitement and variability for players, as a pattern may appear close to hitting as a number of plays increases. For amplifying this effect, a counter may be added to the secondary game for communicating a number of plays since the pattern was last matched or hit.

Taking the additional pattern 1920 as a snake pattern according to FIG. 19, FIG. 20A shows a secondary game of keno 2000 where the snake pattern was last hit thirteen plays ago. This play or round 2002 of the secondary game 2000 proceeds according to the traditional style of keno, with the player selecting numbers for their wager and matches being marked where the selected numbers match a ball call provided for the game. However, when a subsequent play 2004 or round occurs as shown in FIG. 20B, the previous matches are tracked and added to the matches of the previous play 2002 and compared to the additional pattern 1920.

In the case of FIG. 20B, newly hit spots are marked in a lighter yellow while previously hit spots are marked in a darker orange but, cumulatively, spots forty-seven and sixty-nine are missing from the additional pattern 1920. FIG. 20C shows an example of a play 2006 where a hit for the additional pattern 1920 is achieved, with newly hit spots marked in a lighter yellow while previously hit spots are marked in a darker orange. Accordingly, the award for the snake pattern from the pay table 1910 is provided to the player together with or in place of any award achieved for a number of matches.

In this way, the embodiments of FIGS. 19-20C include a flexible award directly in the secondary game using secondary attributes in the form of additional keno patterns. Accordingly, the wager result of the secondary game can be flexibly adjusted to correspond to a primary game wager result where the final result won in the primary game corresponds to multiple bingo pattern hits, or any other value as may be required due to the variability of the prize value of the primary game and/or a mismatch between the payouts of the primary game and the secondary game.

Of course, the patterns and/or award values, etc. may be adjusted as needed to correspond to variations in the result index of the primary game, while the award system for traditional matches in the secondary game may appear to remain static. Other embodiments may be configured to include one or more of the same or different secondary attributes, such as in the form of a patterns on the card, patterns in a ball call, patterns in the numbers matched, or another pattern for triggering a bonus credit or bonus game.

Several variations are contemplated, including colors assigned to the balls in the ball call corresponding to a bonus pattern of the like. In each case, the wager result of the secondary game is controlled to correspond to the wager result of the primary game, allowing the player to enjoy playing a secondary game even where the awards corresponding to the secondary game are static or traditional values that do not directly correspond to awards of an underlying primary game, such as with a table game like a keno game and a primary game with multiple bingo pattern hits or otherwise varied awards. These variations in the secondary game further increase player engagement and enjoyment, by providing the player with increasingly varied and exciting gameplay based on a primary game wager, such as a bingo wager.

In another example, the secondary game may correspond to a game having the possibility of mid-game wager options, as in, for example, blackjack or similar table games. Such mid-game wager options present a challenge for implementation with an underlying primary game of bingo, because bingo does not commonly include similar mid-game wager options. Additionally, many mid-game wager options result in a variable pay table that does not readily correspond to the winning patterns arrangement of a primary game of bingo.

According to embodiments of the current disclosure, mid-game wager options may be converted to a choice for a player to buy one or more additional interim patterns. For example, for a secondary game of blackjack, the player receives an initial hand and may select whether to “hit” and receive an additional card or “stay” and proceed with the initial hand as dealt. For certain hands, the player may elect to “split” or “double-down”.

A “split” may be offered when a player's initial two-card hand includes two cards of the same value. It gives the player the option of splitting the cards into two separate hands, then receiving an additional card for each hand from the dealer. To split in blackjack, the player must generally place an additional bet on the newly created hand that is equal to the original bet they placed at the start of the game. To “double-down” means the player doubles their bet in the middle of the game and receives only one more card.

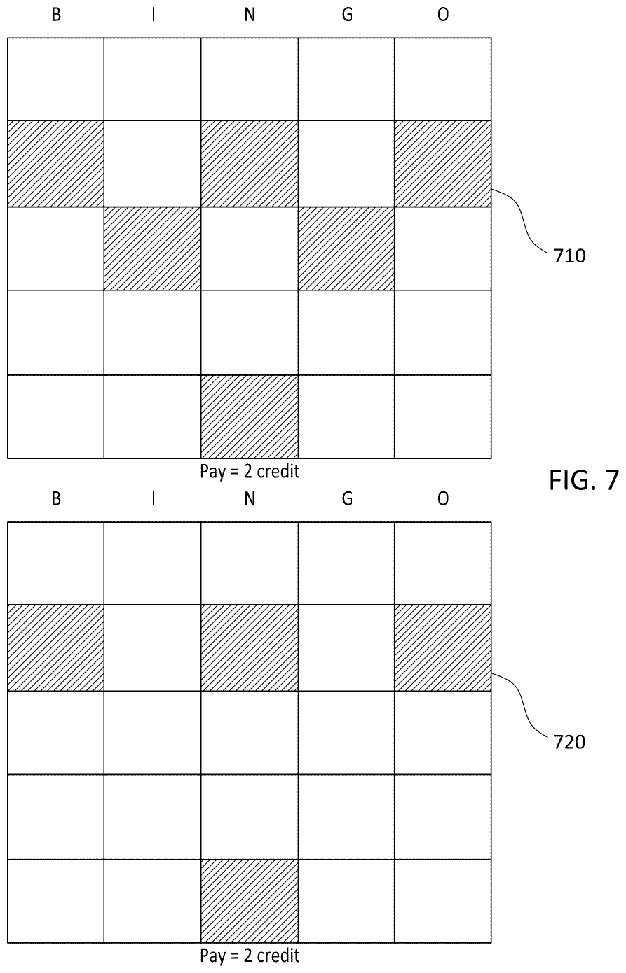

For an embodiment according to the disclosure having a primary game of bingo and a secondary game of blackjack, a final result 710 of a result index having a bingo pattern as seen in FIG. 7 may be won and the player may be provided with the opportunity to “split” in the secondary game of blackjack as described above. If the player makes the choice to split, this input to the secondary game would be provided to the primary game as a choice to purchase an additional final result 720 or pattern of the result index. The pattern of the final result 720 may be forced to be a winner with a sub-pattern of the initial final result 710, as in FIG. 7, or may be provided so as to correspond with a defined probability or likelihood of the pattern of the additional final result being won at the same time as the initial final result 710.

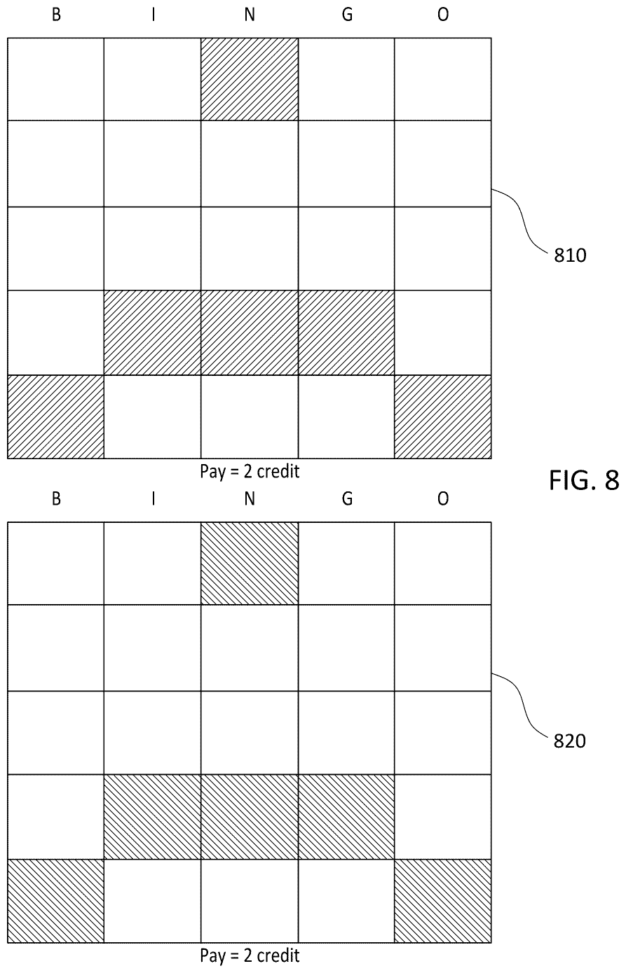

In a variation according to FIG. 8, an initial final result 810 or pattern of the result index may be provided and a player decision to “split” may be input to the secondary game. The input may be converted to an input to the primary game in the form of a decision to purchase an additional final result 820 or pattern of the result index, where the initial final result 810 and the additional final result 820 have mutually exclusive patterns. As illustrated in FIG. 8, the additional final result 820 is an “anti-pattern”, e.g. having only the spaces corresponding to the pattern of the initial final result 810 undaubed, such that the patterns of the initial final result 810 and the additional final result 820 are mutually exclusive. In this manner, the player may have the option to “split” in the secondary game but would only have the possibility of one win in the underlying primary game of bingo.

These variations in the secondary game increase player engagement and enjoyment, by providing the player with increasingly varied and exciting gameplay based on a primary game wager, such as a bingo game.

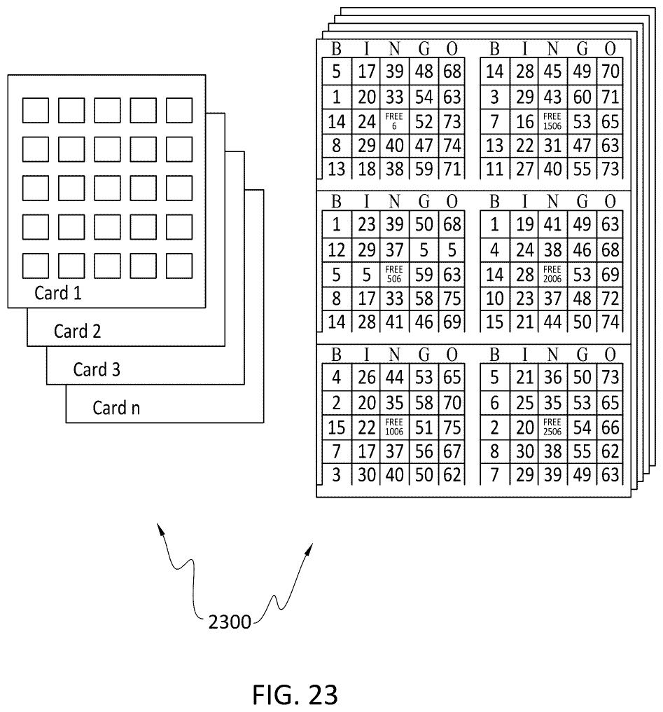

In another example, instead of offering a single bingo card for purchase in the underlying primary game, a wager made in the underlying primary game may be represented by bingo card packs containing multiple bingo cards. In this way, mid-game wager options of the secondary game may be represented by a selection of a bingo card from the respective pack. FIG. 23 illustrates an example of bingo card packs 2300, including cards one to n. The decks may be built and stored each time a game is made available. A player would play one bingo card at a time through their respective pack, not necessarily in sequential or any other specific order, as they make secondary decisions that correlate to the secondary game.

Embodiments of a primary game using card packs according to FIG. 23 may also be employed to facilitate multi-player games. To allow for multi-player games the system would prepare a group bingo card packs to be used in a session of the table game. For example, a 7-person blackjack implementation would have seven player packs and one dealer pack. Each time the game is made available the decks may be built and stored. For each game, the system may be configured to assess a number of players and select the bingo card packs to be given out based on this assessment, one to each player or a subset of the available packs if not all seats at the table are in play.

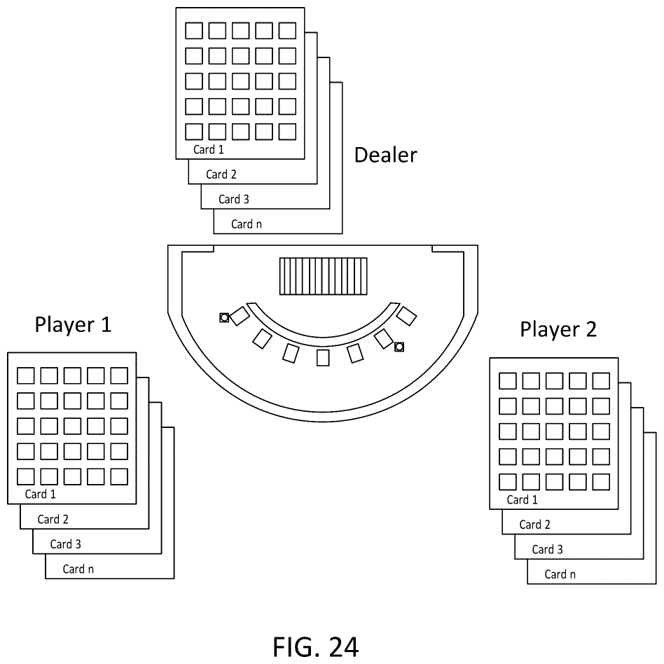

FIG. 24 illustrates an example of a primary game of bingo with card packs underlying a secondary game of blackjack, where a 7-person table is provided with only two seats in play. In the illustrated embodiment, secondary decisions in the secondary game of blackjack are represented in the primary game as decisions to forfeit a card and purchase or select a new card from within the respective card pack. Not all cards in a player's respective card pack are necessarily available for the player to purchase and a card's availability may be a function of the dealers card set or other determining factors. If the player decides to forfeit their card and purchase or select a new one they will be selecting a different bingo card within their bingo card pack, which card is used is determined by the player's secondary decision as correlates to the table game. Advantageously, this configuration allows an underlying primary game of bingo to replicate or correspond with a secondary game having mid-game decisions or other variable characteristics that are extremely difficult to replicate, such as allowing players in blackjack to surrender as well as allowing for poor choices such as doubling down on 20 in blackjack or other features/decisions in other table games.

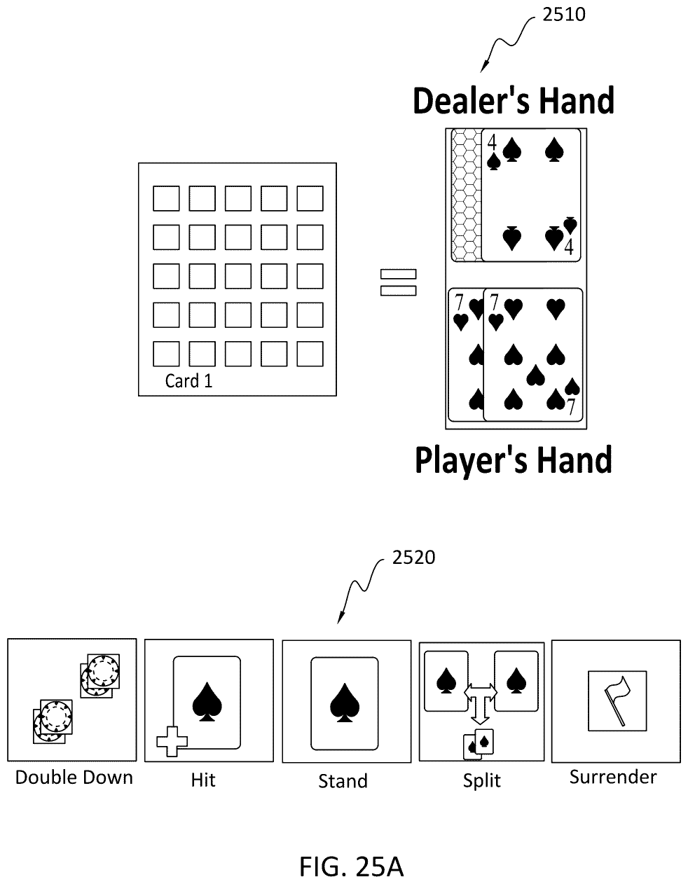

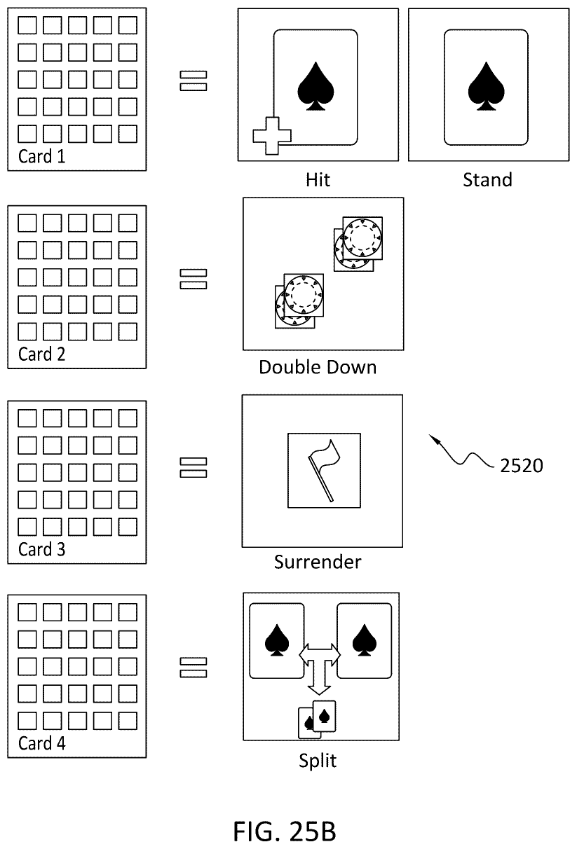

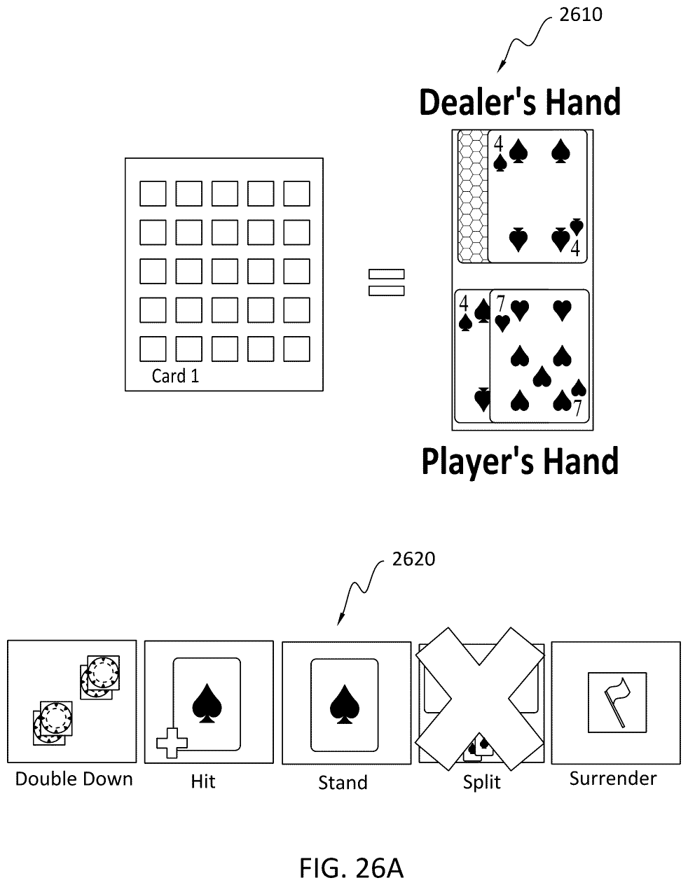

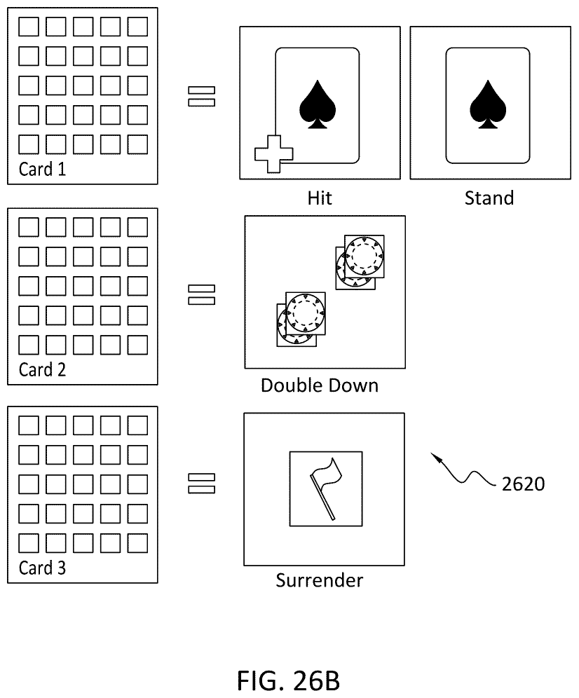

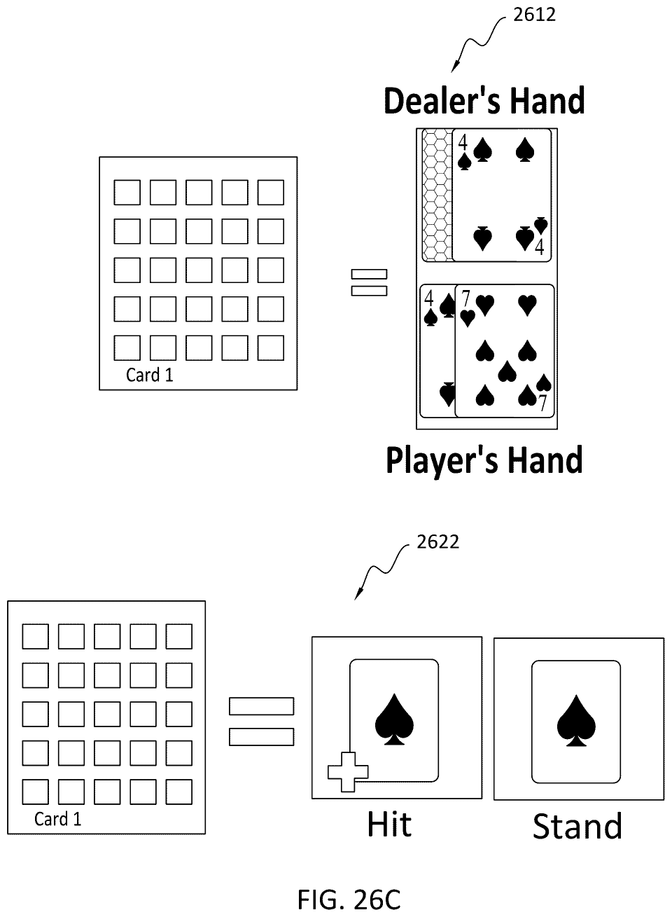

A better understanding of the embodiment of FIG. 24 may be obtained by reference to FIGS. 25A-26C, which represent the actions of the two players in play. FIGS. 25A and 25B illustrate the actions of a first player according to FIG. 24. An initial hand 2510 for a first player in the secondary game of blackjack is shown in FIG. 25A, with card 1 from the first player's bingo card pack representing the initial hand 2510 in the underlying primary game. The first player is provided with a list of available mid-game decisions 2520, shown in FIG. 25A.

For example, for a secondary game of blackjack, the first player receives an initial hand and may select whether to “hit” and receive an additional card, “stay” and proceed with the initial hand as dealt, or “surrender” and receive half of their wagered amount while the house retains the other half. For certain hands, the player may elect to “split” or “double-down”. A “split” may be offered when a player's initial two-card hand includes two cards of the same value, such as the two sevens of the initial hand of FIG. 25A. It gives the player the option of splitting the cards into two separate hands, then receiving an additional card for each hand from the dealer. To split in blackjack, the player must generally place an additional bet on the newly created hand that is equal to the original bet they placed at the start of the game. To “double-down” means the player doubles their bet in the middle of the game and receives only one more card.

According to the embodiment of FIG. 25A, each mid-game decision 2520 may correspond with a different bingo card from the first player's bingo card pack as illustrated in FIG. 25B. In the example of FIGS. 25A and 25B, the first player elects to “surrender” in the secondary game, resulting in or corresponding to a forfeit of card 1 and a purchase or selection of card 3 in the primary game. As there are no more secondary decisions available for the first player, card 3 is evaluated for bingo wins and the first player is paid the bingo win amount as the entertaining display of the blackjack secondary game concludes.

FIGS. 26A, 26B and 26C illustrate the actions of a second player according to FIG. 24. An initial hand 2610 for a second player in the secondary game of blackjack is shown in FIG. 26A, with card 1 from the second player's bingo card pack representing the initial hand 2610 in the underlying primary game. The second player is provided with a list of available mid-game decisions 2620 which, in this case, differ from those of the first player due to differences in the second player's initial hand. More specifically, the second player does not have available an option to split, as the second player's initial hand 2610 does not include two cards of the same value.

According to the embodiment of FIG. 26A, each mid-game decision 2620 may correspond with a different bingo card from the second player's bingo card pack as illustrated in FIG. 26B. In the example of FIGS. 26A and 26B, the second player elects to “hit” in the secondary game, resulting in or corresponding to retaining card 1 in the primary game. The second player's hand 2612 is updated as shown in FIG. 26C and the player's options 2622 in the secondary game are now limited to “hit” or “stand”. In this case, the second player elects to “stand” in the secondary game, corresponding to retaining card 1 in the underlying primary game. As there are no more secondary decisions available for the second player, card 1 is evaluated for bingo wins and the second player is paid the bingo win amount as the entertaining display of the blackjack secondary game concludes.

In some embodiments, to allow for dealer or table wins, bingo cards in the bingo card packs of the primary game may include “key” parts, spots or patterns to allow for all winners or all losers corresponding to a dealer bust or a dealer blackjack result in the secondary game. These “key” parts, spots or patterns may be the same across all cards, although variations are possible.

Notably, it is not necessary that the bingo cards representing secondary decisions match across different player's or bingo card packs. For example, player n's card 2 may correspond to a splitting decision in blackjack while player n+1's card 2 may correspond to a double down decision in blackjack.

The use of bingo card packs with bingo cards corresponding to secondary decisions in the secondary game advantageously allow a final result of an underlying primary game to correspond more closely with the variability of secondary games, such as table games and the like, particularly where the secondary games offer complicated secondary decisions. The configuration of the gaming system using bingo card packs to correspond with secondary decisions of secondary games allows for a simple correlation between the primary game and the secondary game, reducing processing requirements of the system while improving gameplay in a manner that increases player engagement and enjoyment.

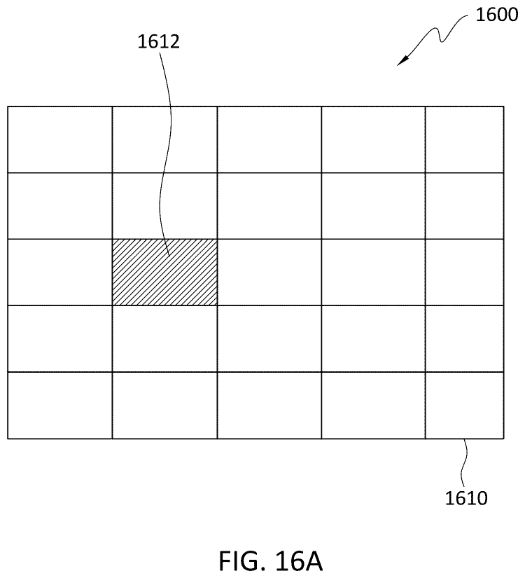

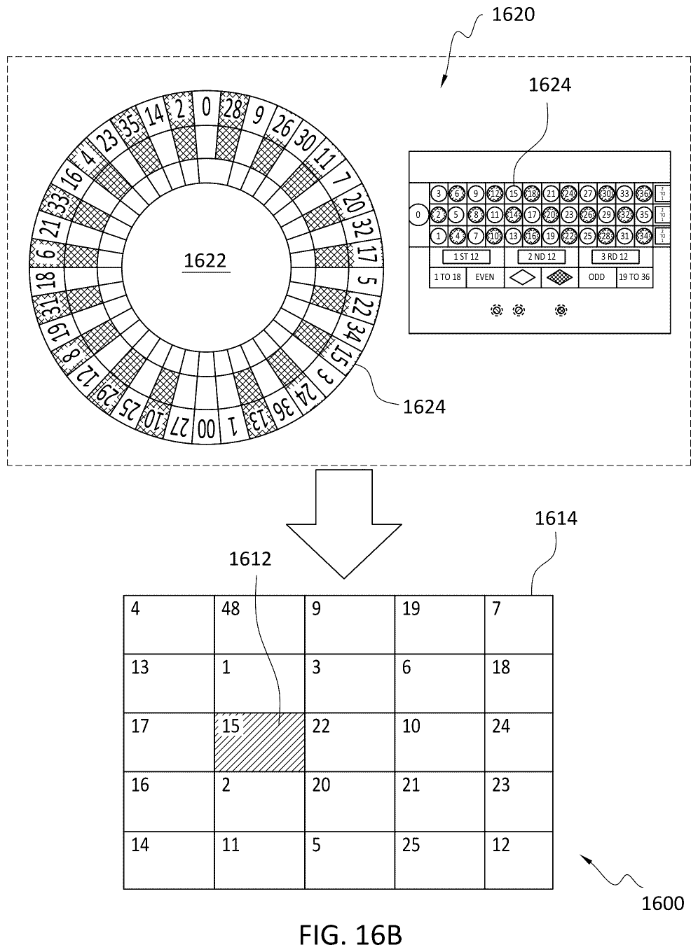

According to embodiments of the current disclosure, a secondary game may be provided as a casino game or table game with the use of an underlying primary game of bingo having cards, calls and rewards adapted to correspond with features of the secondary game. According to the embodiment of FIG. 16A, a predefined set of bingo cards may be provided in the primary game 1600 where there is a “Hot Spot in 1 Ball” pattern provided as a winning final result from a result index, such that each card 1610 of the predefined set of cards has a unique number or other identifier in the hot spot position 1612. For example, for a secondary game of roulette, the predefined set of cards may be provided corresponding to a predefined set of bet options in roulette. When a player places a bet on a number of a roulette wheel in the secondary game of roulette, the player may receive or be designated a card corresponding to that specific number or bet with the hot spot overlaying that specific location, as shown in FIG. 16B.

In the example of FIG. 16B, the player places a bet 1624 on the number 15 of the roulette wheel 1622 in a secondary game 1620 of roulette and a corresponding card 1614 is provided for the player's wager in the underlying primary game 1600. As seen in FIG. 16B, the card 1614 corresponding to the player's wager includes the number 15 located on the hot spot position 1612. A single ball is then drawn in the underlying primary game 1600. If the ball corresponds to the number 15 then the hot spot pattern is fulfilled and a payout will result, or, if the ball corresponds to any other number or bet, the pattern will not be fulfilled and no payout will result for that card/wager. In the secondary game, a result corresponding to the result of the underlying primary game may be displayed for the player, e.g., the roulette ball may land or not land in the number 15 space to show a win or a loss, respectively.

For a secondary game having more than one wager, such as placing bets in roulette on more than one number, a separate card may be provided to the player for each wager or bet with different hot spot numbers corresponding to the respective bets. In this manner, the player may be playing multiple cards in the underlying primary game corresponding to multiple bets in the secondary game. In some embodiments, the call of the underlying primary game may be adapted to match a set of predefined results of the secondary game, e.g., having a call electing from only those numbers corresponding to positions on a roulette wheel. In further embodiments, the call may be adapted to include characteristics corresponding to both numbers and colors of positions on a roulette wheel, etc. For ease of explanation, the examples are described as having a call comprising numbers corresponding to a roulette wheel, although different sets of numbers, colors, letters, symbols or tokens may be used for varying table games without departing from the scope of the described embodiments.

In some embodiments for a secondary game having more than one wager, such as placing bets in roulette on more than one number, cards of the underlying primary game may be modified to provide an award for a player winning one or more wagers in a secondary game in a simultaneous and/or mutually exclusive manner. For each bet, the player may be given a different card in an underlying primary game of bingo. For example, with a secondary game of roulette, a first card corresponding to the numbers from the secondary game and a second card corresponding to the wager options “Red” and “Black” from the secondary game may be provided.

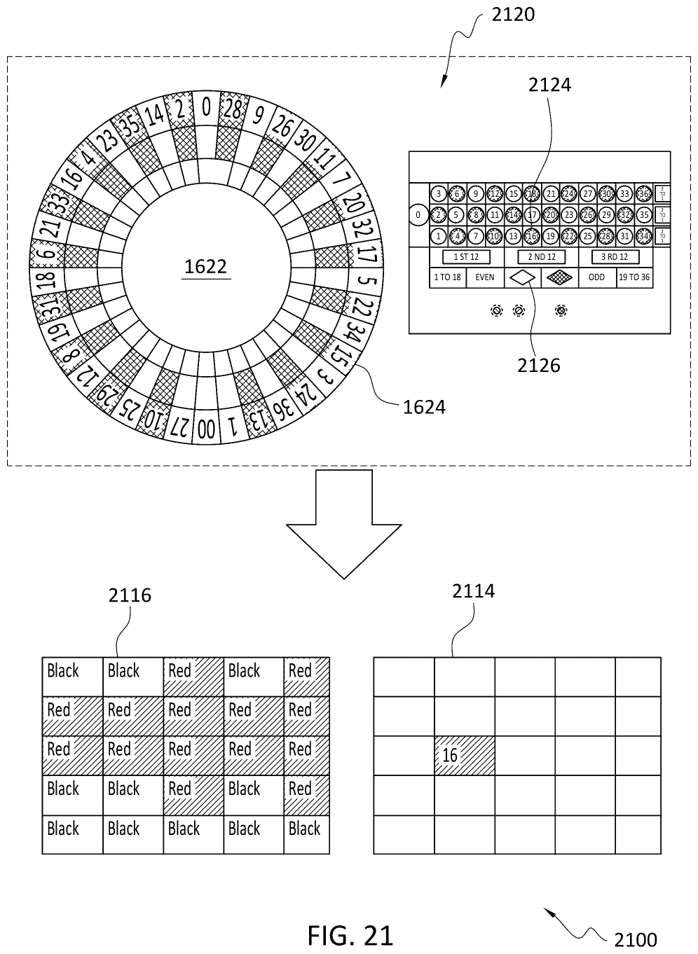

In the example of FIG. 21, the player places a bet 2124 on the number “16” of the roulette wheel 2122 in a secondary game 2120 of roulette and a corresponding first card 2114 is provided for the player's wager in the underlying primary game 2100. The player places a further bet 2126 on the color “Red” and a corresponding second card 2116 is provided for the player's wager. As seen in FIG. 21, portions of the first card 2114 and the second card 2116 corresponding to the player's wagers in the secondary game are highlighted in yellow. The cards will pay a prize if the highlighted spots are daubed during the primary game.

The first card 2114 and the second card 2116 are then arranged on top of each other, so that the specific spots corresponding to the players bets in the secondary game 2120 are arranged together, whether physically or digitally associated, such that winning spots are in the same position if the respective bets may be won simultaneously or not in the same position if the bets cannot be won simultaneously, or may be mutually exclusive. Due to the arrangement or relationship of the first card 2114 and the second card 2116, when a ball is called in the primary game, the cards may be daubed through the cards or otherwise in a 3D manner so that aligned spots are daubed together.

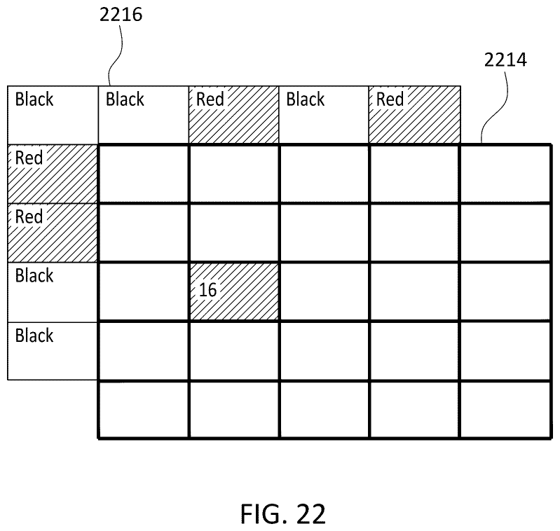

The embodiment of FIG. 21 is continued in FIG. 22, where the player's bet 2124 on the number “16” and the player's bet 2126 on the color “Red” are indicated on the first card 2214 and the second card 2216, and the first card 2214 is arranged on top of the second card 2216 in such a manner that the “16” and a “Red” spot overlap. A single ball is then drawn in the underlying primary game 2100. In a single bingo ball, if the number “16” is called, this spot will be daubed on the top card 2114 and through to the bottom card 2116. In this case the appropriate prizes on each card could be awarded for daubing an active spot. In the secondary game 2120, a result corresponding to the result of the underlying primary game 2100 may be displayed for the player, e.g., the roulette ball may land or not land in the number “16” space to show a win or a loss, respectively.

In some cases, according to the embodiment of FIGS. 21 and 22, multiple bets may be made in the secondary game in a way that they cannot be won simultaneously. With bets that cannot be won simultaneously, the highlighted spots may be arranged so that they do not overlap.

Notably, while discussed in terms of “arranging” the cards, physical cards are not required according to the disclosed embodiments. Instead, it is sufficient that a relationship between the cards according to the above-described embodiments is realized in the gaming machine or terminal, such that the described effect occurs. Likewise, variations in a number of cards, as well as the numbers, symbols or the like represented on the cards, may be configured to correspond with different wager or bet options of different secondary games, such as any other table game, or to include other elements for representing said betting options for the secondary games.

The described correspondence between multiple cards according to the embodiments of FIGS. 21 and 22 and bet options of a secondary game advantageously allow gameplay in a secondary game to be represented in an underlying primary game. Accordingly, player enjoyment and engagement may be increased by the availability of more bet options while processing requirements of the corresponding gaming system may be minimized.

While described with respect to a secondary game of roulette, variations on the embodiments of FIGS. 21 and 22 may be applied to other table games and the like. For example, embodiments may be provided for any secondary game having more than one wager, such as corresponding to side-bets in table games, e.g., an insurance bet in blackjack. In this manner, players can purchase more than one bingo card at a time, and past and future plays may be related.

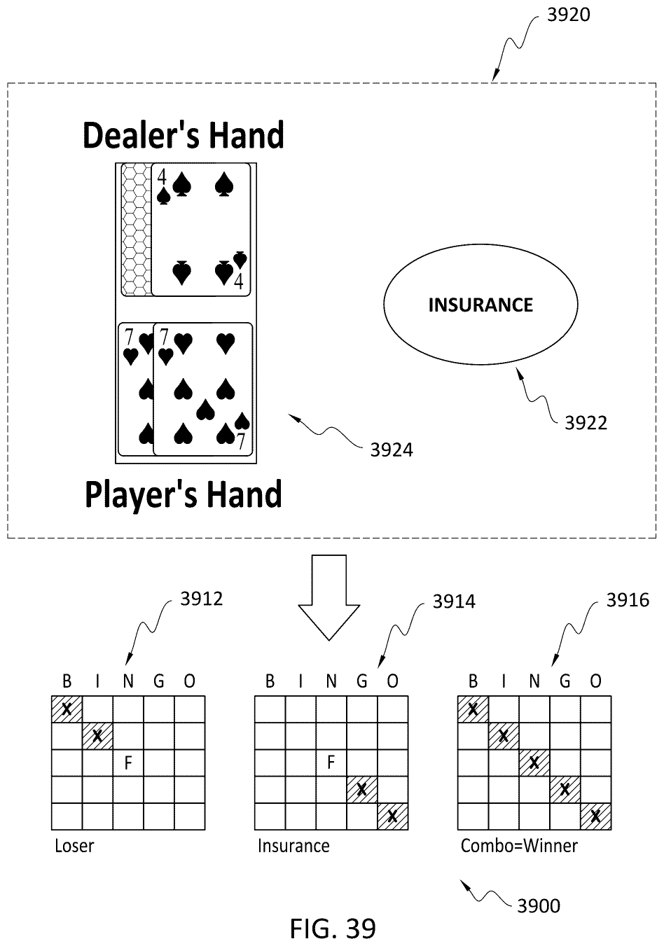

In the example of FIG. 39, players are provided with the option to play with “insurance” and purchase a second bingo card which will be combined with an initial bingo card for comparing a resulting combination pattern to a final result of a result index. In FIG. 39, a secondary game 3920 of blackjack is provided where the player places a bet 3924 on an initial hand in the secondary game 3920 of blackjack and a corresponding first bingo card 3912 is provided for the player's wager in the underlying primary game 3900. The player may purchase insurance 3922 and a corresponding second card 3914 may be provided for the player's wager. As seen in FIG. 39, daubed spaces on the first card 3912 alone results in a loss, while a combination 3916 of daubed spaces on the first card 3912 and daubed spaces on the second card 3914 result in a winning pattern 3916 or final result of a result index.

In varying embodiments, additional insurance options may include an offer to a player to pay extra to ignore a losing bingo card and/or to have the lowest of a series of plays tossed out (e.g., forfeited) and/or the like.

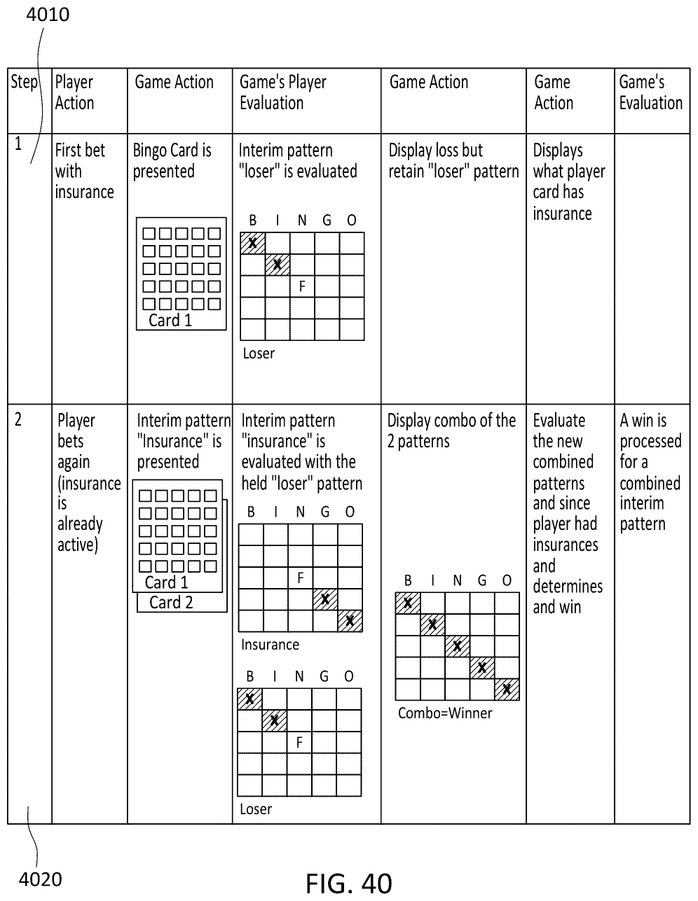

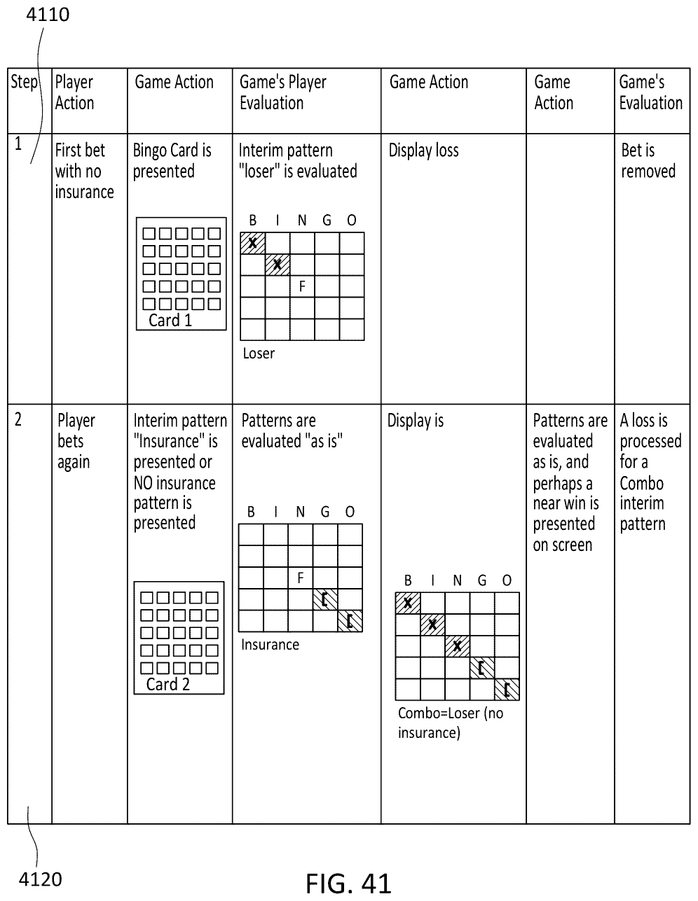

The illustrated embodiments of FIG. 40 and FIG. 41 illustrate an example of a method of providing insurance in a primary game of bingo, such as for a primary game of bingo underlying a secondary game. In a first step 4010 according to FIG. 40, a player places a bet with insurance and a bingo card is presented in the primary game. The bingo card is evaluated and an interim pattern formed by daubed spaces on the bingo card is determined to be a loser, such that a loss is displayed but the interim pattern is retained in the primary game. In a second step 4020, the player bets again and another bingo card is provided to the player, such that the patterns of the multiple bingo cards are evaluated together and, in the illustrated example, a win is processed for the combination pattern.

FIG. 41 illustrates an example where a player is not a winner, as in FIG. 40, but without insurance. In a first step 4110 according to FIG. 40, a player places a bet without insurance and a bingo card is presented in the primary game. The bingo card is evaluated and an interim pattern formed by daubed spaces on the bingo card is determined to be a loser, such that a loss is displayed and the initial bet is removed. In a second step 4120, the player bets again and another bingo card is provided to the player, such that the patterns of the multiple bingo cards are evaluated independently and, in the illustrated example, a loss is processed for each individual pattern.

While illustrated in FIGS. 21-22 and 39-41 and discussed above with reference to specific examples of a secondary game having more than one wager, the current disclosure is not limited to these examples. Instead, the use of more than one bingo card in a 3D-like arrangement, in a combined pattern, or the like may be configured to provide a player with multiple bet options in a secondary game. In a secondary game according to the current application, a player may select bet options corresponding to the secondary game that are configured to correspond with changes to the bingo cards and/or patterns and/or final results of a result index of the primary game. For example, where the secondary game is blackjack, the player may be provided an initial hand and, based on the initial hand, the player may select one or more bet options, e.g., a decision between “Stand”, “Split”, or “Hit” according to traditional blackjack.

The options “Stand”, “Split”, or “Hit” of the secondary game may be correlated to one or more options in the underlying primary game. For example, corresponding options in an underlying primary game of bingo may be configured as “Buy additional card or insurance”=“Split” and “Don't buy additional card or insurance”=“Stand” or “Hit”. Notably, more than one option in one of the primary or secondary game can be configured to correlate to the same option in the other of the primary or secondary game, or the options can be correlated in a one-to-one manner. When purchased, a wildcard spot may be marked on one or more of the player's bingo cards, an additional bingo card may be combined with an initial bingo card to determine a combination pattern, etc. For example, the player may purchase a wildcard spot corresponding to a top left corner of a bingo card, and/or the player may purchase an additional bingo card that is combined with an initial card as in FIG. 39 and FIG. 40, and/or another form of insurance may be provided as discussed above.

The description of a wildcard is only one possibility for a change or option of an underlying primary game, and various configurations are possible. For example, in addition to or in place of a wildcard spot, a player's decision in a secondary game may be configured to correspond to enabling different patterns, multiple wildcard spots, multiple patters, an increase of a wager value, or the like. In some embodiments, the decision may initiate a second primary game, such that more than one primary game wagers are conducted concurrently, for example, where a player selects to split in the secondary game of blackjack, makes an odds wager in craps, fold in three-card poker, etc.

In some embodiments, for example for a secondary game having more than one wager originating from more than one player or more than one betting option, such as one or more players placing bets in roulette on different numbers, colors, odds/evens, etc., a primary game of bingo may be configured to include a ball call with supplemental states. While known bingo ball calls have a limited set of states (e.g., uncalled, called, number, letter), various embodiments of the current disclosure may include a primary game of bingo where a value or attribute of a subset of balls called will affect or add to subsequent-pending ball's attributes. In this manner, an underlying primary game may be provided that can correspond to multiple bets and/or betting options in a secondary game.

In some embodiments, the call of the underlying primary game may be adapted to include supplemental states that match a set of features of the secondary game. For example, if the first or second ball called has or is part of a predetermined characteristic subset, pattern or sequence, for example, such as the Fibonacci sequence, the subsequent-pending balls of the ball call in the Fibonacci sequence may be augmented with supplemental states or attributes that correspond with a modification to the result of the primary game.

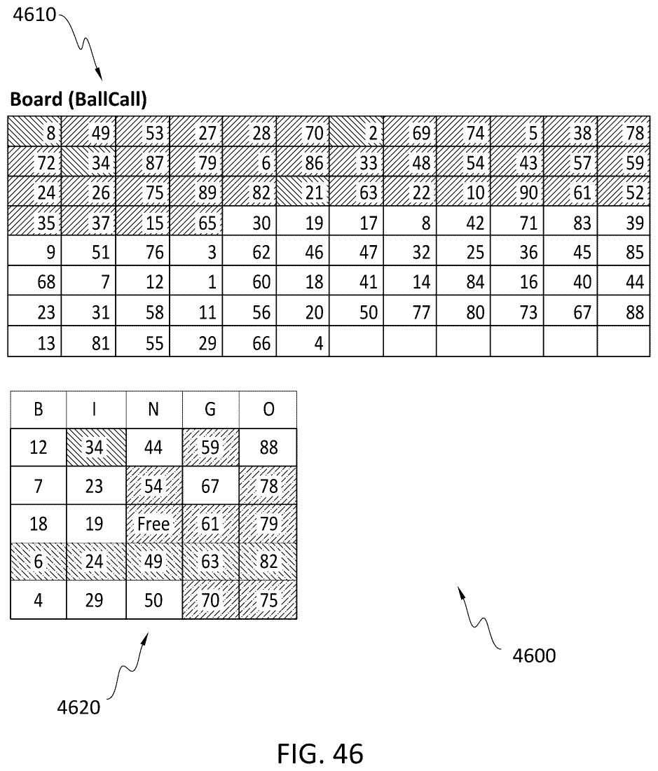

FIG. 46 illustrates an example of a ball call 4610 of a primary game 4600 where the call is adapted to include supplemental states. In the illustrated example, the primary game 4600 is configured such that if the first or second ball called is part of the Fibonacci sequence (e.g., for a ball call ranging from 1-75, the numbers 1, 2, 3, 5, 8, 13, 21, 34, 55 are part of the Fibonacci sequence), the subsequent-pending balls of the ball call in the Fibonacci sequence are augmented to provide a supplemental effect when scoring the card, such as affecting a result or wager in the primary game 4600.

In this case, the first ball of the ball call 4610 is an “8” and part of the Fibonacci sequence, such that the supplemental state is accordingly activated for numbers 8, 2, 34, and 21 of the ball call 4610. The ball call 4610 includes the additional numbers 2, 34, and 21 that are part of the Fibonacci sequence. Based on the ball call 4610, a bingo card 4620 may be daubed. In the depicted embodiment, the bingo card 4620 includes the numbers 34, 59, 54, 78, 61, 79, 6, 24, 49, 63, 82, 70, and 75 corresponding to the balls that have been called of the ball call 4610, and so the spots corresponding to these numbers, and a middle free space, are daubed on the card 4620. The bingo card 4620 is identified as a winner for including a standard horizontal line pattern formed by the numbers 6, 24, 49, 63, and 82, and in conventional bingo games a standard payout would be provided for the card. However, in the embodiment of FIG. 46, the number 34 includes a supplemental state corresponding to a multiplier effect, for example a 2× multiplier, such that a reward value of the bingo card 4620 and/or of a pattern daubed on the bingo card 4620 in the primary game 4600 is modified accordingly.

It should be noted that a supplemental state or states provided in the primary game may be based on a value of one or more balls other than, or in addition to, the Fibonacci sequence. For example, if the first ball called is odd then all subsequent odd balls called may be flagged with an attribute, such as color, multiplier, extra game, bonus, prize, etc. Further supplemental states may be triggered for even balls, two or more balls that are sequential numbers (e.g., 32, 33, 34), balls that are doubles (e.g., 14, 28, 56), etc. Further, although the Fibonacci sequence is used an example, the inventive concepts described herein are not limited to the Fibonacci sequence, but other predetermined patterns or sequences, or indeed other predetermined number sets may be used.

In some embodiments, balls from the ball call not having a specified supplemental state or attribute may be skipped or undaubed. For example, where the first ball called meets a first predetermined criteria, e.g. is odd, then a predetermined subset of the balls, e.g. odd balls, of the ball call are marked with an attribute, e.g. marked red, forming a supplemental state for the balls of the ball call such that the next daubed ball in the ball call may be the next attributed, e.g. marked red, ball in the ball call while skipping non-attributed balls in the call. This method of daubing may be provided in replacement of and/or in addition to traditional daubing of all called balls.

According to varying embodiments, in addition to or in place of adding attributes to balls of the ball call based on a characteristic of a predetermined ball in the ball call, the predetermined ball may be used to trigger a supplemental state and/or attribute for a ball corresponding to a specific location on a bingo card. For example, where the predetermined ball (e.g. first ball corresponding to Fibonacci sequence in the ball call or a subsequent ball corresponding to Fibonacci sequence in the ball call, first ball that is odd in the ball call or a subsequent ball that is odd in the ball call, etc.) is the fifth ball of the ball call, a ball corresponding to a fifth spot on a bingo card (e.g., counting left to right and top to bottom, i.e. corresponding to the spot labelled with 7 in the bingo card 4620 of FIG. 46) may be attributed, e.g. marked red.

As previously noted, the supplemental state may correspond to an additional or augmented attribute, such as a bonus game, a bonus value, extra daubs, a multiplier value or effect, or the like. In some embodiments, an effect of the augmented attribute may be triggered for a player when a corresponding space on the player's bingo card is daubed, or may be triggered for a player when a corresponding space on the player's bingo card is daubed and forms part of winning or otherwise predetermined pattern, or may be triggered for a player when a corresponding space on any player's bingo card is daubed, or may be triggered for all players when the ball with the supplemental state is called. Many variations are possible, and the current disclosure is not limited to any specific uses of the supplemental state in the primary game or to any specific augmented attributes or effects.

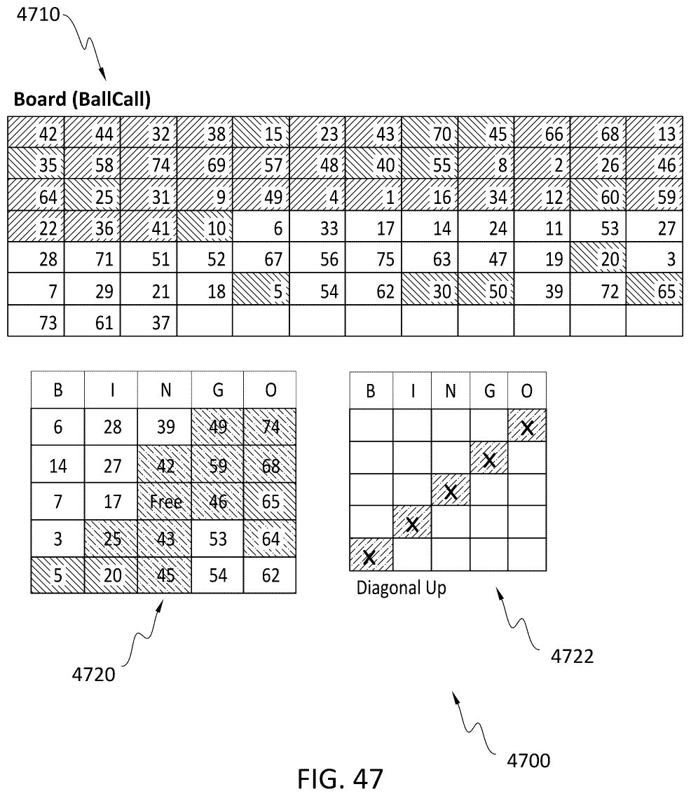

In another specific example according to FIG. 47, a primary game 4700 may be configured such that if one of the first five balls of a ball call 4710 is divisible by five, all subsequent balls of the ball call 4710 that are divisible by five will have augmented attributes corresponding to this supplemental state. In this example, the augmented attribute may include, but is not limited to, extra daubs beyond an initial set of balls called (e.g., beyond forty called balls). As shown in the depicted example, the fifth ball of the ball call 4710 is a “15” and is divisible by five, such that the supplemental state is accordingly activated for numbers 20, 5, 30, 50, and 65 of the ball call 4710. This means that the ball call 4710 includes the additional numbers 20, 5, 30, 50, and 65 that are divisible by five but are beyond the ball call size of forty balls.

Based on the ball call 4710 with the supplemental state defined above, a bingo card 4720 may be daubed. In the depicted embodiment, the bingo card 4720 includes the numbers 49, 74, 42, 59, 68, 46, 25, 43, 64, and 45 corresponding to the balls that have been called in the ball call 4710, and so the spots corresponding to these numbers, and a middle free space, are daubed on the card 4720. The bingo card 4720 does not include any winning patterns for a conventional bingo game using a forty-ball call. However, in this case, the bingo card 4720 includes the numbers 5, 20 and 65 that have the supplemental state triggered by the fifth ball of the ball call 4710 being a “15” and divisible by five, such that the numbers 5, 20 and 65 on the card are also daubed. This means that the bingo card 4720 is identified as a winner according to the embodiment of FIG. 47, for including a standard diagonal line pattern 4722 formed by the numbers 5, 25, 59, 74, and a free space.

As discussed above, the described embodiments are not limited to a supplemental state governed by one of the first five balls of a ball call being divisible by five, but may employ another supplemental state. For example, after any five balls of a ball call are divisible by five all subsequent balls of the ball call that are divisible by five will have augmented attributes corresponding to this supplemental state, or after five sequential balls of a ball call are divisible by five all subsequent balls of the ball call that are divisible by five will have augmented attributes corresponding to this supplemental state, etc. Likewise, the described embodiments are not limited to a supplemental state but may include multiple supplemental states, e.g. divisible by five and odd, from one ball call, as well as multiple added attributes. For example, a call of the five ball may provide an attribute to balls divisible by five, a call of the thirty-two ball may provide an attribute to even balls, and/or a call of the seven ball may provide an attribute to balls divisible by seven. In this example, the seventy ball would have all three attributes, e.g. color, multiplier, and extra daubs.

In some embodiments, the primary game including supplemental states for a ball call may be configured for use with a secondary game, such as a table game or the like. In an example using roulette, supplemental states for a ball call of the primary game may be configured to correspond with wager characteristics of the secondary game of roulette, such as red, black, odd, even, 1^{st} 12, 2^{nd} 12, 3^{rd} 12, 1 to 18, 19 to 36, or the like. In some examples, the first ball having a predetermined supplemental state may be used to determine a subset of balls of the ball call to be daubed, e.g. corresponding to the color of the roulette win of the secondary game, instead of the conventional practice of daubing balls in the order called, which in turn limits which numbers can be won in the secondary game of roulette. In other examples, the first ball having a predetermined supplemental state may be used to determine which patterns are available to win, red or black. Advantageously, the use of the supplemental states for the ball call may be agnostic to a pattern or anti-pattern win in the primary game of bingo.

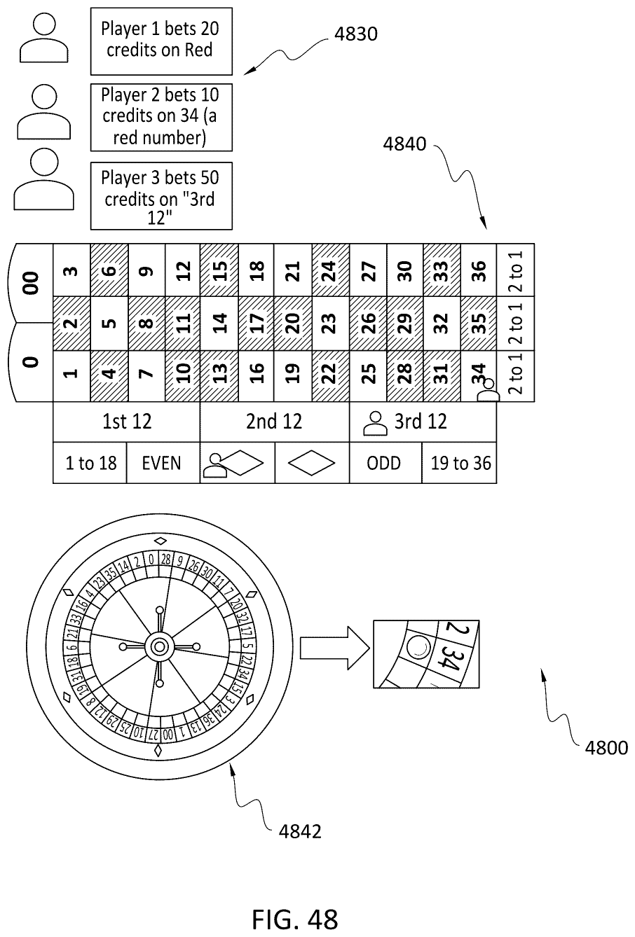

Applying a secondary game 4800 of roulette to a primary game of bingo including a ball call having supplemental states, FIG. 48 illustrates how the secondary game 4800 of roulette may be conducted based on the underlying primary game. According to varying embodiments, the players may be presented with both the primary game of bingo and the secondary game 4800 in some form, or the players may only be presented with the secondary game 4800 while the secondary game 4800 is conducted according to the underlying primary game.

As seen in FIG. 48, the secondary game 4800 may be depicted as including three players 4830 playing roulette, where the first player bets twenty credits on “Red”, the second player bets ten credits on “34” (a red number), and the third player bets fifty credits on “3^{rd} 12”. The bets may be illustrated on a roulette table 4840 while a result of the secondary game 4800 is illustrated as being determined by a roulette wheel 4842 that receives a ball therein, according to conventional roulette. In the illustrated example, the roulette wheel 4842 spins and the roulette ball lands in the Red-34 slot.

While the secondary game 4800 of roulette is presented to the players 4830 with the roulette ball in the Red-34 slot, which means all three players win (an award based on the odds of their choices), the bets of the players 4830 may be evaluated and conducted based on an underlying primary game of bingo, where a supplemental state is included in the ball call for adjusting the result of the primary game to correspond with a possible result of the secondary game, as described above. In the illustrated embodiment, the determinative information for the ball call is that the first ball called was 34, which makes the second player a winner, and:
. . . is red therefore all red numbers are active “winners” (player 1)
. . . is also part of the “3rd 12” box and a winner (player 3)
. . . is also part of the “19 to 36” box and a winner (but no one bet there)
. . . is also part of the “Even” box and a winner (but no one bet there)
. . . is also part of the “2 to 1” Column-1 box and a winner (but no one bet there)

In some embodiments, the call may be adapted to include characteristics corresponding to both numbers and colors of positions on a roulette wheel, etc. For ease of explanation, the examples are described as having a call comprising numbers corresponding to a roulette wheel, although different sets of numbers, colors, letters, symbols or tokens may be used for varying table games without departing from the scope of the described embodiments.

In some cases, multiple bets may be made in the secondary game in a way that they cannot be won simultaneously. With bets that cannot be won simultaneously, mutually exclusive supplemental states may be defined for the ball call of the underlying primary game.

Notably, the supplemental states of the ball call may be determined by the ball call itself, such that it is sufficient that a relationship between the balls of the ball call according to the above-described embodiments is realized in the gaming machine or terminal, such that the described effect occurs. Likewise, variations in a number of balls of the ball call, as well as the numbers, symbols or the like represented on the balls, may be configured to correspond with different wager or bet options of different secondary games, such as any other table game, or to include other elements for representing said betting options for the secondary games.

The described correspondence between supplemental states of a ball call according to the embodiments of FIGS. 46, 47 and 48 and bet options of a secondary game advantageously allow gameplay in a secondary game to be represented in an underlying primary game. Accordingly, player enjoyment and engagement may be increased by the availability of more bet options while processing requirements of the corresponding gaming system may be minimized.

While described with respect to a secondary game of roulette, variations on the embodiments of FIGS. 46, 47 and 48 may be applied to other table games and the like. For example, embodiments may be provided for any secondary game having more than one wager, wager options, or players, such as corresponding to side-bets in table games, e.g., an insurance bet in blackjack.

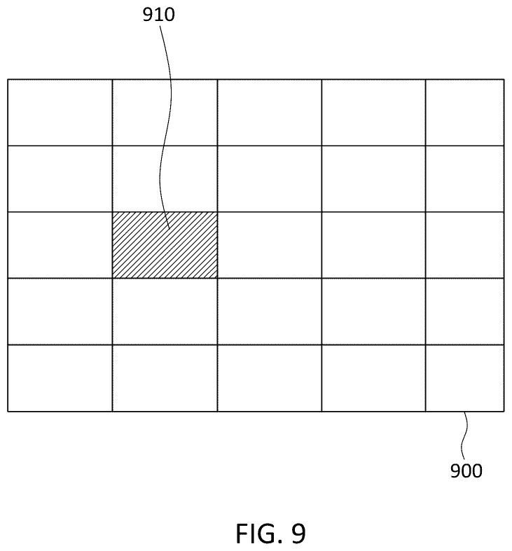

According to embodiments of the current disclosure, a secondary game may be provided as a multiplayer casino game or table game with the use of an underlying primary game of bingo having cards, calls and rewards adapted to result in one winner of a single amount. According to the embodiment of FIG. 9, a predefined set of cards may be provided in the primary game where there is a “Hot Spot in 1 Ball” pattern provided as a winning final result from a result index, such that each card 900 of the predefined set of cards has a unique number in the hot spot position 910. For ease of explanation, the below examples are described as having a call comprising numbers 1-75 and a set of 75 cards each having a unique number from 1-75 in the hot spot position, although different sets of numbers, letters, symbols or tokens may be used without departing from the scope of the described embodiments.

For a multiplayer game having two players, each player may wager one unit and the hot spot pattern or final result of the result index may pay two units. Each player may be provided with a set of cards, for example the cards with 1 through 35 in the hot spot position may be given to player one, the cards with 36 through 70 in the hot spot position may be given to player two, and the cards 71-75 may be considered the house advantage where no player wins.

In an alternative example with three players, each player may wager one unit and the hot spot pattern or final result of the result index may pay three units. The cards with 1 through 23 in the hot spot position may be given to player one, the cards with 24 through 46 in the hot spot position may be given to player two, the cards with 47 through 69 in the hot spot position may be given to player three, and the cards 70-75 may be considered the house advantage where no player wins.

In an alternative example with four players, each player may wager one unit and the hot spot pattern or final result of the result index may pay four units. The cards with 1 through 17 in the hot spot position may be given to player one, the cards with 18 through 34 in the hot spot position may be given to player two, the cards with 35 through 51 in the hot spot position may be given to player three, the cards with 52 through 68 in the hot spot position may be given to player four, and the cards 69-75 may be considered the house advantage where no player wins.

Further variations where the number of players, cards, house advantage, wagers and the like may be adjusted. In certain embodiments, a player may increase a wager to more than one unit, such that the wager increase would essentially allow the player to enter the game as another player, receiving the corresponding cards as if they were another player.

The above-described embodiments for multiplayer secondary games having an underlying primary game of bingo may be adapted to employ one or more different secondary games. For example, the multiplayer secondary game may comprise the game “War” with one or more players versus the “house”, the game “War” with ties going to the “house”, a wheel (big six wheel, wheel of fortune, etc.) with segments for each player and “house” segments, blackjack versus the “house”, etc.

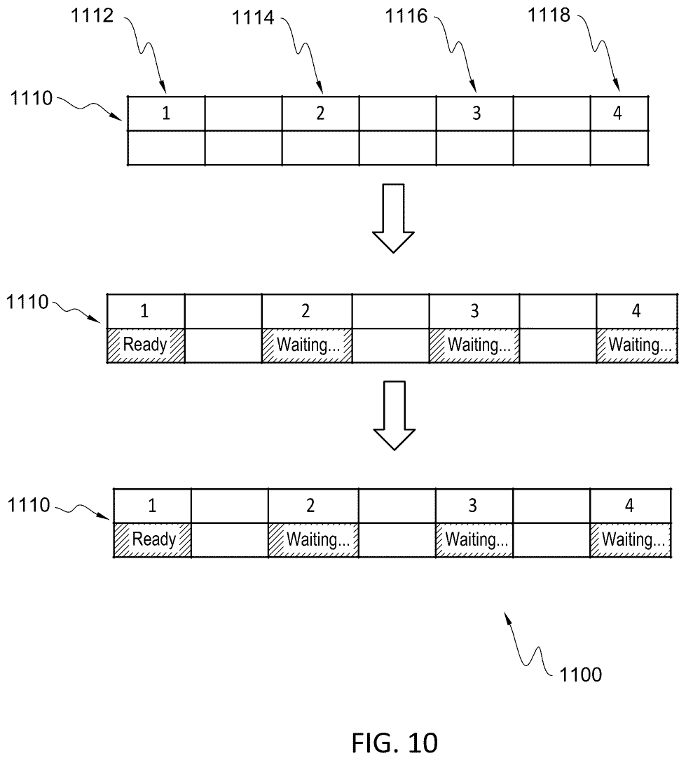

The embodiment of FIG. 10 illustrates an example of conducting a multiplayer wager game 1100 based on a secondary game comprising the game “War” and an underlying primary game in the form of a bingo game. In the depicted embodiment, a gaming system 1110 is provided with four terminals 1112, 1114, 1116, 1118 or gaming machines, such as may be set up in a gaming bank or area. A player may input a one-unit wager at terminal 1112 and initialize a request for wagers at the remaining three terminals 1114, 1116, 1118. A player may then input a two-unit wager at terminal 1116 and the game may proceed with the current players, such as after a timer or another predetermined period or event.

In the example of FIG. 10, the game 1100 is a “three player” game as three units have been wagered. Based on the wagers, terminal 1112 is assigned cards with the numbers 1-23 in the hot spot position while terminal 1116 is assigned cards with the numbers 24-69 in the hot spot position, and the underlying primary game of bingo proceeds by drawing a single ball from 1-75. In the secondary game displayed to the players, terminal 1112 displays a single playing card while terminal 1116 displays two playing cards and the “house” is dealt one playing card.

Based on the underlying primary game, if the terminal 1112 has a winning bingo card then it's playing card will be displayed having a value greater than the playing cards of terminal 1116 and greater than the house's playing card. Alternatively, if the terminal 1116 has a winning bingo card then one it's playing cards will be displayed having a value greater than the playing card of terminal 1112 and greater than the house's playing card. If neither terminal 1112, 1116 has a winning bingo card then the highest value playing card given will be given to the house.

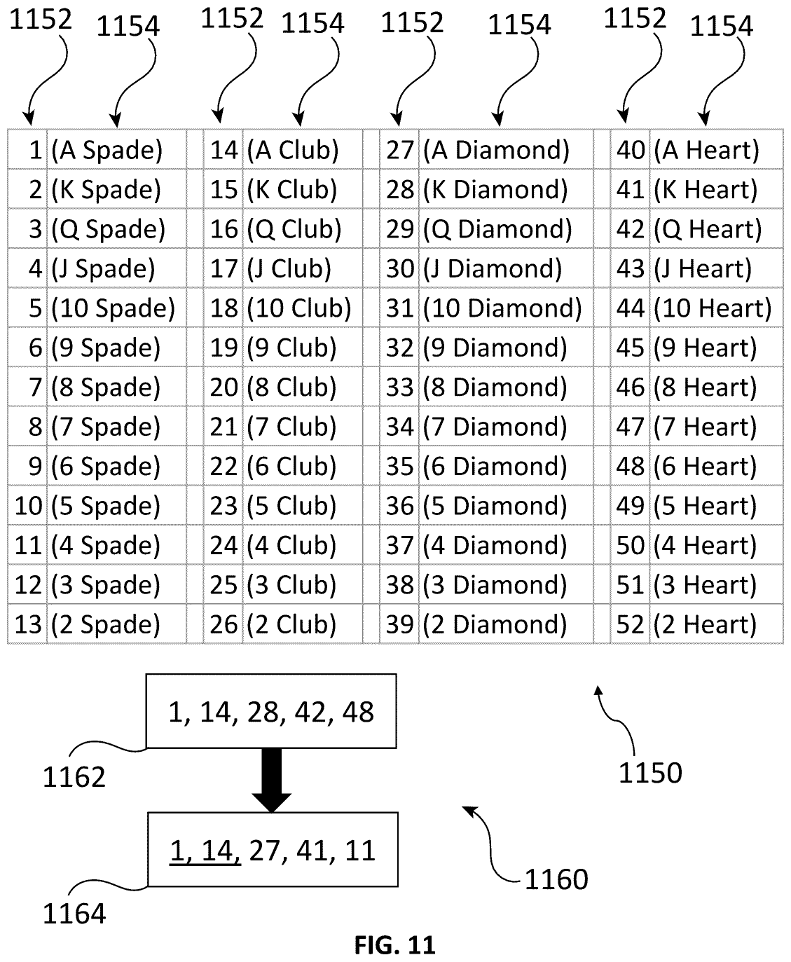

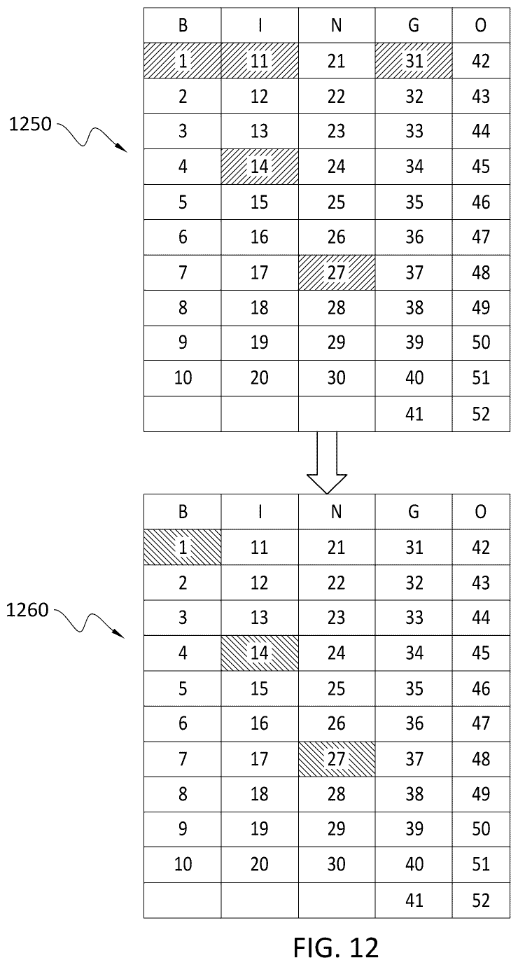

In the illustrated embodiment of FIG. 11, a primary game of bingo may be configured to emulate a deal of playing cards and/or a player selection of playing cards, as in a secondary game of poker, but in a bingo format. A card 1150 for the primary game of bingo may be configured to include fifty-two spaces 1152, shown as a 13×4 bingo card in FIG. 11 or a 5-column “B”, “I”, “N”, “G”, “O” style card as in FIG. 12, such that each space 1152 corresponds to both a ball from the primary game of bingo, for example using matching numbers, and such that each space 1152 corresponds to a poker card 1154, as demonstrated in FIG. 11. Variations on the layout of the card 1150 are of course contemplated and may be configured to take a different size or shape, based on the secondary game and the entertaining display intended to be shown to players. In some embodiments, every player and/or every play of the game may always employ the same bingo card, with a new ball call for each game played.

A five-ball call 1160 is used for daubing the card 1150, but in a multi-stage manner. In an initial ball call 1162 five balls are drawn and presented to a player. The player then is provided a choice to accept or redraw for each ball from the initial ball call 1162. In the illustrated example of FIG. 11, the initial ball call 1162 includes (1, 14, 28, 42, 48) from the card 1150 and corresponds to the poker cards 1154 (A Spade, A Club, K Diamond, Q Heart, 6 Heart). In this case, the player selects to keep two balls (1, 14), representing (A Spade, A Club), and a final ball call 1164 is provided where three new balls (27, 41, 11), representing (A Diamond, K Heart, 4 Spade), are selected for those the player elected to redraw, resulting in a final ball call 1164 of (1, 14, 27, 41, 11) representing (A Spade, A Club, A Diamond, K Heart, 4 Spade).

As shown in FIG. 12, the card 1150 is then daubed based on the final ball call 1164 and a resulting pattern 1250 is evaluated against winning patterns 1260 of a result index for the primary game. Winning patterns 1260 of the result index in the primary game may be configured to correlate directly to winning hands of the secondary game. For example, based on the layout of the card 1150 and the ball call 1160, “3 of a kind”, “4 of a kind”, “5 of a kind”, “full houses”, and “straights” in a secondary game of poker may correlate directly to bingo patterns from the result index in the underlying primary game of bingo. In the case of FIG. 12, the winning pattern 1260 for this hand would be a “3 Aces” winning pattern 1260, and the player would be provided with a payout or reward associated with the winning pattern 1260 in the result index.

In this manner, the primary game of bingo may be configured to emulate a player's selection of wager options from a full list of available options of casino table games and the like. Advantageously, the primary game may be configured to include correlating final results from the result index with bingo patterns for all wager options in the secondary game, where specific final results and winning patterns are enabled in the primary game based on the player's selections made in the secondary game.

As discussed previously, the described embodiments may be adapted to correspond with secondary games other than poker. In particular, other games using playing cards may be readily employed as the secondary game, with cards, calls and final results of the primary game of bingo being adapted to emulate corresponding wager options and results of such a game in the same manner as above. Additional table games such as roulette, blackjack, sic bo, baccarat, a big six wheel or wheel of fortune, pool, pachinko, chemin de fer, pai gow, a lottery, keno, or any other table game, and the like may be similarly applied as a secondary game by adapting the cards, calls and final results of the primary game of bingo to emulate corresponding wager options and results of such a game.

In another example, the secondary game may correspond to a game having the possibility of multiple players, as in, for example, multiplayer poker or similar multiplayer casino games. Such multiplayer casino games present a challenge for implementation with an underlying primary game of bingo.

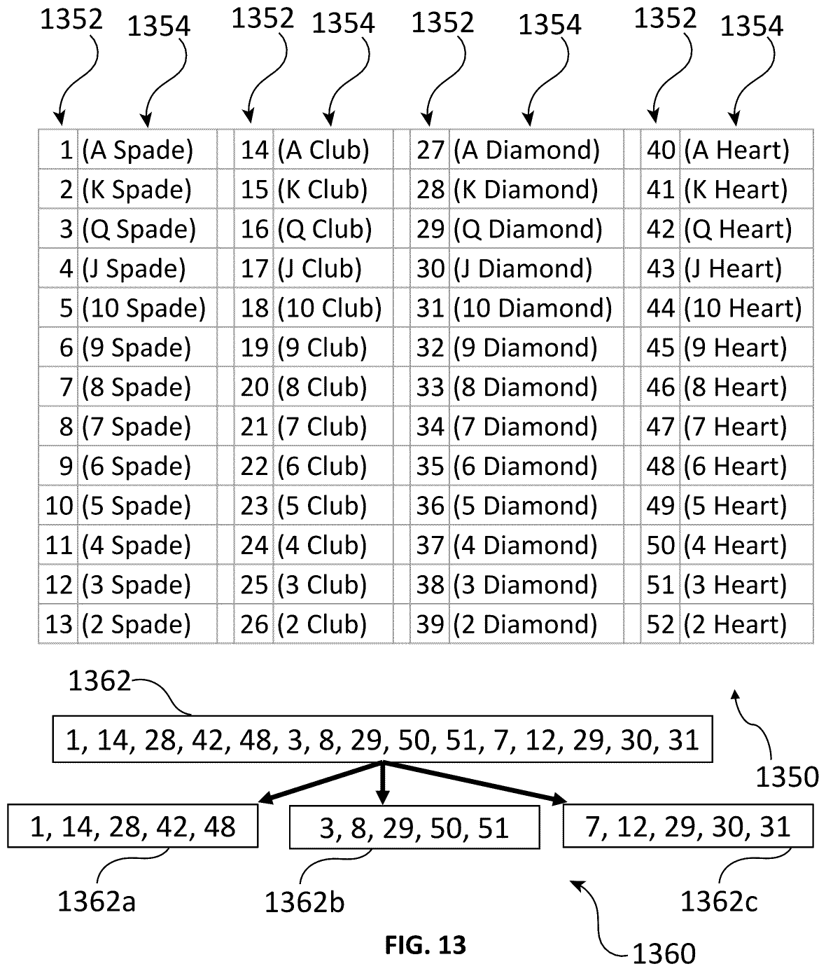

According to embodiments of the current disclosure, a secondary game may be provided as a multiplayer casino game or table game with the use of an underlying primary game of bingo having cards, calls and rewards adapted to result in one winner of a single amount. According to the embodiment of FIG. 13, a primary game of bingo may be configured to emulate a deal of playing cards and/or a player selection of playing cards for multiple players, as in a secondary game of poker with multiple players, but in a bingo format.

As with the embodiment of FIG. 11, each card 1350 for the primary game of bingo may be configured to include fifty-two spaces 1352, shown as a 13×4 bingo card in FIG. 13 or a 5-column “B”, “I”, “N”, “G”, “O” style card as in FIG. 12, such that each space 1352 corresponds to both a ball from the primary game of bingo, for example using matching numbers, and such that each space 1352 corresponds to a poker card 1354, as demonstrated in FIG. 13. Each of the multiple players may always employ identical bingo cards.

In the embodiment of FIG. 13, each player is given a unique five-ball call section of the shared game ball call 1360 for daubing their respective card 1350, in a multi-stage manner as described with respect to FIG. 11. For example, FIG. 13 shows an initial ball call 1362 for a secondary game of poker with three players playing. As such, the initial ball call 1362 includes fifteen balls drawn (1, 14, 28, 42, 48, 3, 8, 29, 50, 51, 7, 12, 29, 30, 31). Player 1 is given balls 1363a (1, 14, 28, 42, 48), Player 2 is given balls 1363b (3, 8, 29, 50, 51), and Player 3 is given balls 1363c (7, 12, 29, 30, 31). Each player is then provided an individual choice to accept or redraw for each ball from their respective balls 1363a, 1363b, 1363c from the initial ball call 1362, as explained for a single player with reference to FIG. 11 but with each player receiving a unique final ball call based on their respective choice to accept or redraw for each ball from their respective balls 1363a, 1363b, 1363c from the initial ball call 1362.

Each player's card 1350 is then daubed based only on their respective final ball call and a resulting pattern for each player is evaluated against winning patterns of a result index for the primary game. As discussed above, the winning patterns of the result index in the primary game may be configured to correlate directly to winning hands of the secondary game, such that poker hands “3 of a kind”, “4 of a kind”, “5 of a kind”, “full houses”, “straights”, etc., in a secondary game of poker may correlate directly to bingo patterns from the result index in the underlying primary game of bingo. In the case of multiple players, only the player with the highest valued winning pattern is provided a payout or reward, with the values of each winning pattern being identified in the result index, such as according to the traditional values of winning patterns of a secondary game (e.g., full house beats three of a kind, etc.).

Further variations may be provided where the number of players, cards, house advantage, wagers and the like may be adjusted. Advantageously, the primary game may be configured to include correlating final results from the result index with bingo patterns for all wager options in the secondary game, where specific final results and winning patterns are enabled in the primary game based on the players' selections made in the secondary game.

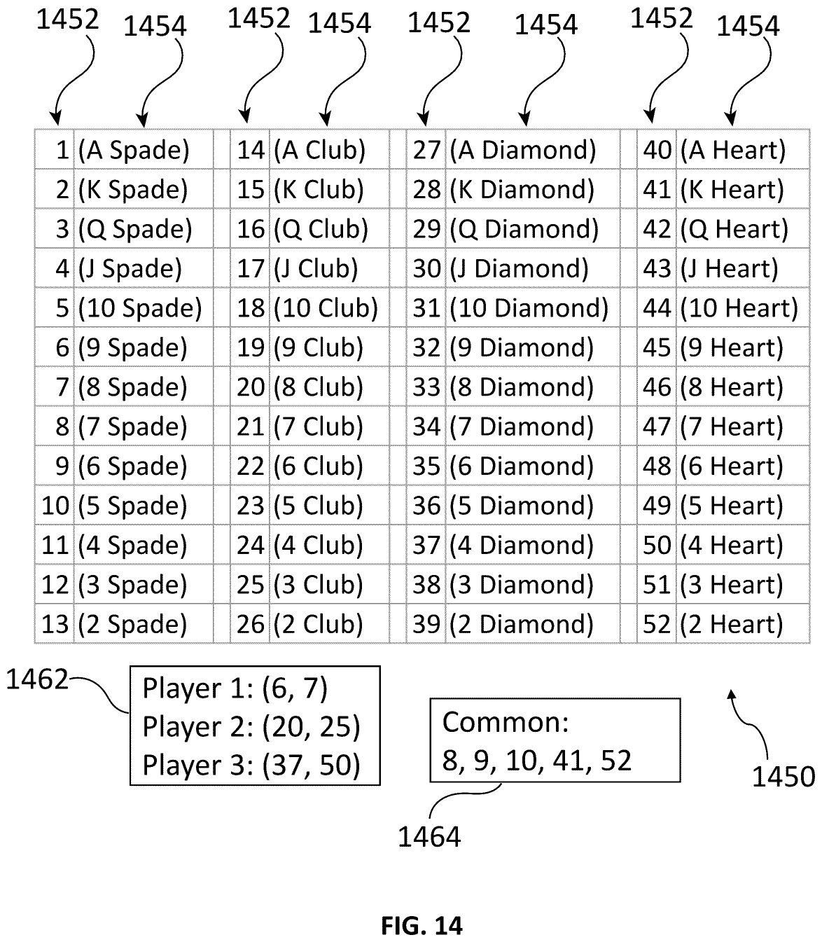

The embodiment of FIG. 14 illustrates and example of conducting a multiplayer wager game based on a secondary game comprising a multiplayer game of poker and an underlying primary game in the form of a bingo game, as in the embodiment of FIG. 13, but with a common ball call. The embodiment of FIG. 14 enables the underlying game of bingo to support a broader range of secondary games, including multiplayer games where players are all affected by a common ball call, with or without an additional unique ball call for each player.

Specifically, FIG. 14 depicts an embodiment corresponding to a secondary game of Hold'em-style poker. As with the embodiment of FIG. 11, each card 1450 for the primary game of bingo may be configured to include fifty-two spaces 1452, shown as a 13×4 bingo card in FIG. 14 or a 5-column “B”, “I”, “N”, “G”, “O” style card as in FIG. 12, such that each space 1452 corresponds to both a ball from the primary game of bingo, for example using matching numbers, and such that each space 1452 corresponds to a poker card 1454, as demonstrated in FIG. 14. Each of the multiple players may always employ identical bingo cards.

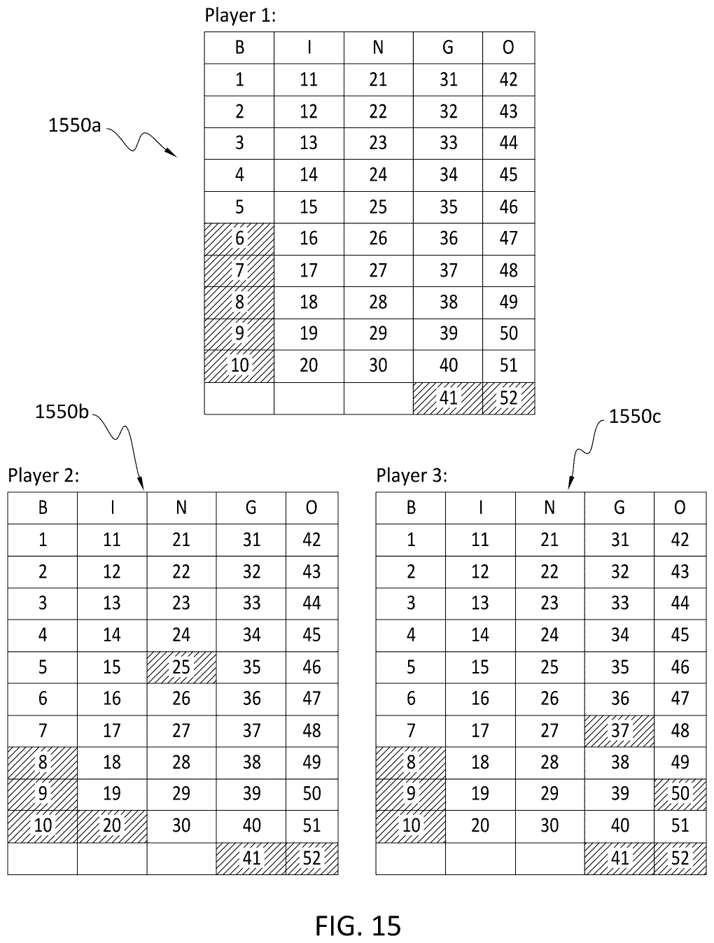

In the embodiment of FIG. 14, each player is given a unique two-ball call 1462 (e.g., hole cards) for daubing their respective card 1450, and an additional common five-ball call 1464 (e.g., community cards) for daubing on all players' cards. For example, FIG. 14 shows a ball call 1362 for a secondary game of poker with three players playing. As such, the ball call 1362 includes two balls drawn for each player, Player 1: (6, 7), Player 2: (20, 25), Player 3: (37, 50), which are daubed on the respective individual player's card. The common ball call 1464 includes shared balls (8, 9, 10, 41, 52), which are daubed on all players' cards 1550a, 1550b, 1550c, as seen in FIG. 15.

A resulting pattern for each player is then evaluated against winning patterns of a result index for the primary game. As discussed above, the winning patterns of the result index in the primary game may be configured to correlate directly to winning hands of the secondary game, such that poker hands “3 of a kind”, “4 of a kind”, “5 of a kind”, “full houses”, “straights”, etc., in a secondary game of poker may correlate directly to bingo patterns from the result index in the underlying primary game of bingo. In the case of multiple players, only the player with the highest valued winning pattern may be provided a payout or reward, with the values of each winning pattern being identified in the result index, such as according to the traditional values of winning patterns of a secondary game (e.g., full house beats three of a kind, etc.).

In this manner, the primary game of bingo may be configured to emulate multiple players' selections of wager options from a full list of available options of casino table games and the like. Advantageously, the primary game may be configured to include correlating final results from the result index with bingo patterns for all wager options in the secondary game, where specific final results and winning patterns are enabled in the primary game based on the players' selections made in the secondary game.

As discussed previously, the described embodiments may be adapted to correspond with multiplayer secondary games other than poker. In particular, other games using playing cards may be readily employed as the secondary game, with cards, calls and final results of the primary game of bingo being adapted to emulate corresponding wager options and results of such a game in the same manner as above. Additional table games such as roulette, blackjack, sic bo, baccarat, a big six wheel or wheel of fortune, pool, pachinko, chemin de fer, pai gow, a lottery, keno, or any other table game, and the like may be similarly applied as a secondary game by adapting the cards, calls and final results of the primary game of bingo to emulate corresponding wager options and results of such a game. In certain cases, a multiplayer game may be considered a game with at least a player and a dealer, or at least a player and a house player, with the dealer or house player being represented as another player according to the disclosed embodiments.

In one embodiment of a primary game having multiple players, competition between the players may be facilitated by competition between interim patterns of the players' bingo cards, such that only the player that meets the winning criteria, or pattern, first would win. Determination of which player meets the winning criteria, or pattern, first may be based on an evaluation of time and/or evaluation of a number of daubs required to meet the winning criteria. For example, a primary game of bingo may be provided having six players where a variety of interim patterns are achieved by the players. However, rather than giving every player a prize for any daubed interim patterns, only the first player to achieve the interim pattern and/or the player to achieve the interim pattern in the lowest number of daubs receives the corresponding payout. As such, in the example of six players, one player has the interim patterns completed in less balls (i.e., daubs) than the other players, so that player is awarded the win while the other players are not, even if they also have the interim patterns completed (but in more balls).

In varying examples of a primary game having multiple players, competition between the players may be facilitated by competition between interim patterns of the players' bingo cards, such that the player that meets the winning criteria, or pattern, first would receive a larger payout than other players (e.g., other players receive less). As above, determination of which player meets the winning criteria, or pattern, first may be based on an evaluation of time and/or evaluation of a number of daubs required to meet the winning criteria. In some embodiments, a payout or award corresponding with an interim pattern may diminish as time or a number of daubs required to complete the pattern increases. The payout may diminish in a static or dynamic manner, such as by predetermined values or percentages, etc.

Competition between interim patterns as described above may be used to facilitate the use of a secondary game with an underlying primary game. For example, by adapting the payouts or awards provided in the underlying primary game to correspond with competition between multiple players in the secondary game.

In a variant of a primary game using interim patterns, the primary game may be configured to award wins based on interim patterns that emerge during a predetermined range of balls called after the start of the ball call, e.g., patterns fund in range n-Start to n-End within the total ball call. In this manner, awards for a specific pattern may only be distributed if the pattern is created within a certain range of the ball call, or the awards may vary based on a range of the ball call in which the pattern is created. Evaluation of a range of the ball call may be based on the number of balls called since the beginning of the primary game of bingo, or based on the number of balls called since a predetermined point of the ball call.

For example, a primary game of bingo may be provided having 1-75 balls called in total. However, rather than awarding a prize for any diagonal line daubed during the ball call, in this example only a diagonal line pattern daubed during the final ten balls (e.g., 66-75) called would be mapped to a win. In some embodiments, a payout or award corresponding with an interim pattern may diminish or increase as a ball call progresses. The payout may diminish or increase in a predetermined manner, such as by predetermined values or percentages, etc. For example, where a pattern is daubed in balls 12-20 a payout or award may correspond to ten credits while a payout or award for the same pattern daubed in balls 23-35 may correspond to eighteen credits, with the same pattern daubed in balls 21-22 being a non-winner with no payout or award.

In varying examples of a primary game having multiple players, competition between the players may be facilitated by competition between interim patterns of the players' bingo cards, such that the player that meets the winning criteria, or pattern, in a predetermined range of the ball call would receive a larger payout than other players (e.g., other players receive less).

Ranged interim patterns as described above may be used to facilitate the use of a secondary game with an underlying primary game. For example, by adapting the payouts or awards provided in the underlying primary game to correspond with competition between multiple players in the secondary game or the like. The pay table may provide static rewards for the predetermined patterns or may be dynamically adjusted based on the circumstances of the game and/or the gaming system.

Notably, the disclosed embodiments, while being applicable for adapting a primary game underlying a secondary game wherein the secondary game comprises a traditional table game, are not restricted to application with existing traditional games. For example, additional and new variations on existing table games may be used as a secondary game.

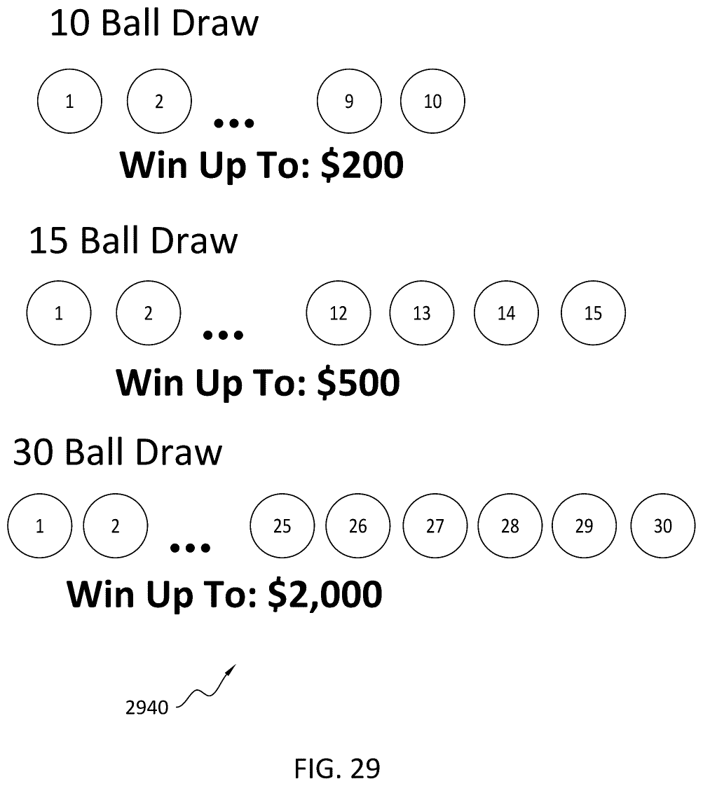

In one aspect, a secondary game may be provided as a lottery ball draw where the result of the secondary game is based on an underlying primary game, such as a primary game of bingo. As shown in FIG. 29, a lottery ball draw may be provided as a secondary game 2940 where a player may initiate a wager including a selection of a ball draw, e.g., 10 Ball Draw, 15 Ball Draw, 30 Ball Draw.

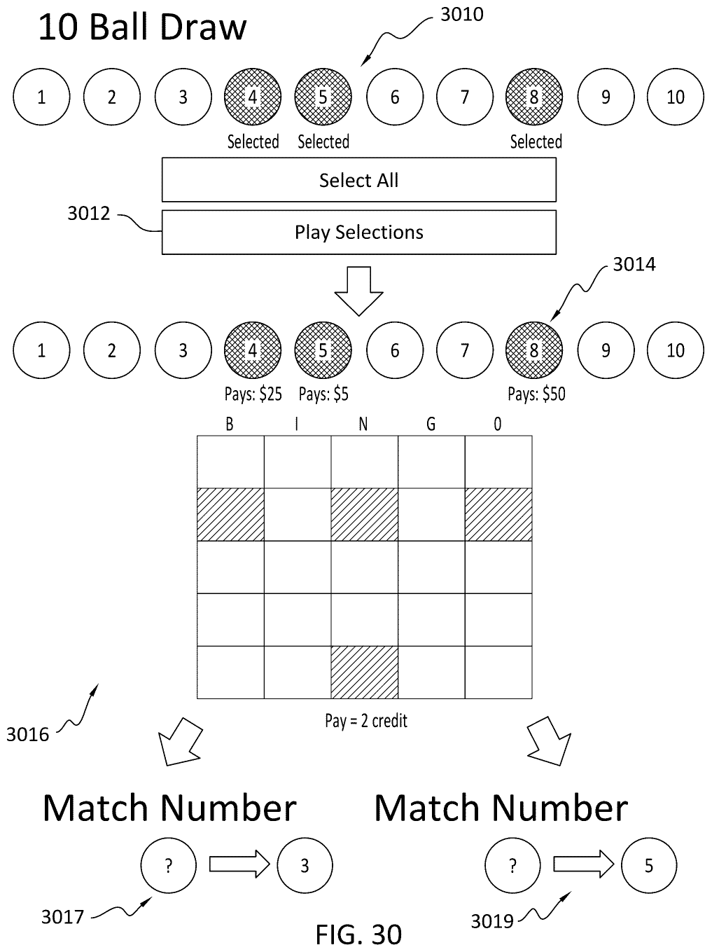

Following selection of a ball draw, for example a ten-ball draw, the player is given the opportunity to pick match balls 3010 before proceeding to play the selection 3012, as depicted in FIG. 30. In the depicted example, the player selects the match balls 4, 5 and 8, and presses the “Play Selections” button to be shown the possible awards 3014. Associated results for the underlying primary game may be based on final results of a result index for an underlying primary game comprising a bingo game, for example including bingo card patterns with corresponding award values.

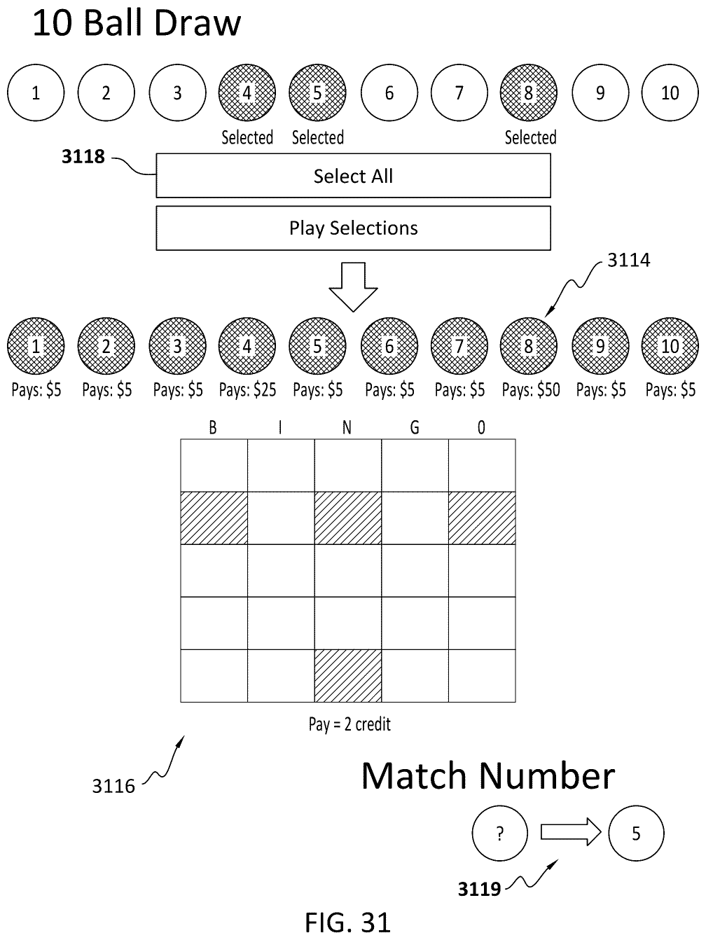

Based on the result of the primary game, a match number may be revealed showing a loss 3017 (e.g., a three where there is no match to the player's number and no award is paid) or a win 3019 (e.g., a five where the match to the selected 5 ball corresponds to a win of $5). In a further embodiment according to FIG. 31, a player may pick the “Select All” button 3118, guaranteeing a win 3114, where the associated primary game associates one or more final result 3116 for each award value in a result index. One unique feature of the embodiments is that the player is provided an option for a guaranteed win 3119, which has not been previously provided in a bingo game. These variations in the secondary game increase player engagement and enjoyment, by providing the player with increasingly varied and exciting gameplay based on a primary game wager, such as in bingo.

Although discussed as a “ball draw” it should be noted that the ball draw may be simulated by a computing device or system, may be provided as a physical ball draw, and/or may be simulated by another system or hardware component. In some examples, a random number generator may be provided for conducting the ball draw, such as comprised in software executable by a processor of a gaming machine or gaming system. In certain embodiments, a non-software random number generator may be provided, for example comprising one or more of a physical dice roll, a physical ball draw, a physical spinning wheel or reel, a physical roulette wheel, a physical card draw from a physical deck of shuffled cards, an analogue random number generator, or another similar device or system.

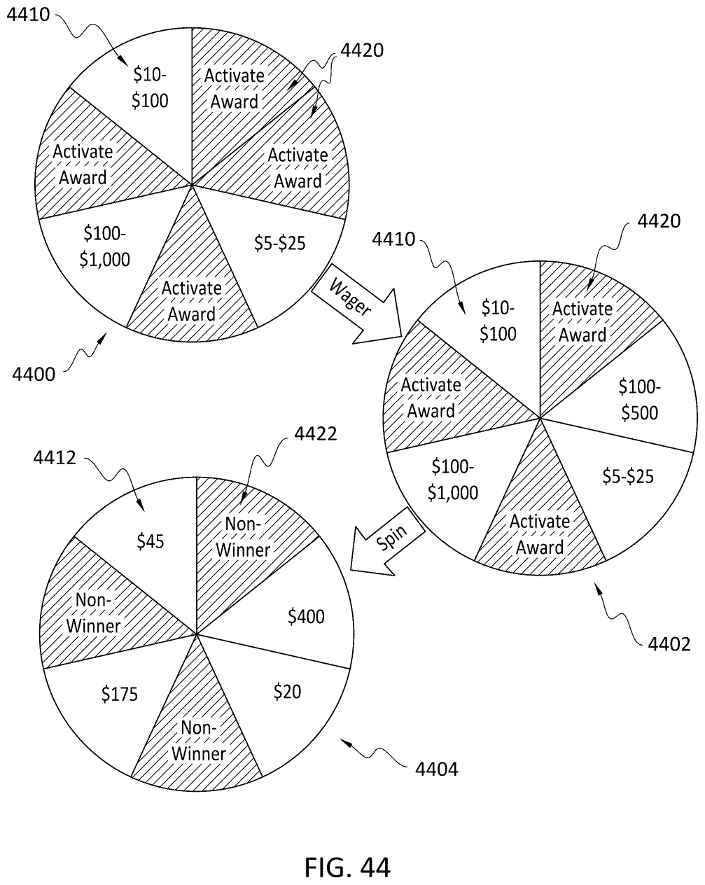

In one embodiment, a secondary game using principles of a matching game such as described with reference to FIG. 29 and FIG. 30 may be implemented as a secondary game with alternative compositions, such as by providing a wheel where a player selects a number of slices to be an active winner, the secondary game based on an underlying primary game such as a primary game of bingo. As shown in the illustrated example of FIG. 44, an entertaining display may comprise a wheel 4400 (prize wheel, spinning wheel, etc.) with active portions 4410 and inactive portions 4420. Active portions 4410 of the wheel 4400 may correlate with award ranges while inactive portions 4420 of the wheel may be activated by increasing a wager or bet value, such that the player is given the opportunity to select which areas to activate for the wheel 4402 before initiating play based on the selection, such as by initiating a spinning of the wheel.

Upon initiating play, the inactive portions 4420 of the wheel 4404 may be designated non-winners 4422, as seen in FIG. 44, while active portions 4410 of the wheel may be designated an award value 4412 within an award range. Associated results for the underlying primary game may be based on final results of a result index for an underlying primary game comprising a bingo game, for example including bingo card patterns with corresponding award values. Based on the result of the primary game, a portion of the wheel may be highlighted, selected or identified as a game result, showing a loss (e.g., non-winner) or a win (e.g., an award value).

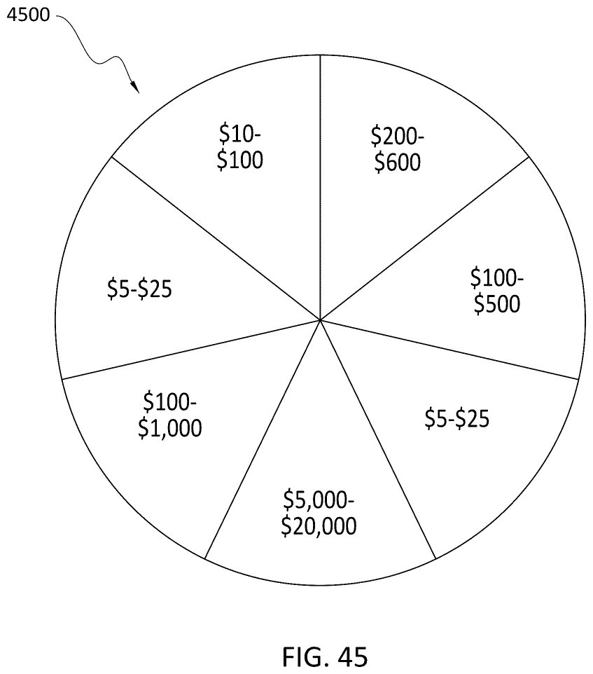

In a further embodiment according to FIG. 45, a player's wager or bet may comprise activating all of the portions of the wheel 4500, guaranteeing a win, where the associated primary game associates one or more final result for each award value in a result index. One unique feature of the embodiments is that the player is provided an option for a guaranteed win, which has not been previously provided in a bingo game. These variations in the secondary game increase player engagement and enjoyment, by providing the player with increasingly varied and exciting gameplay based on a primary game wager, such as in bingo. Further variations in the entertaining display are contemplated, such as illustrating a number of pointer elements rather than portions of a wheel, etc.

In a related manner, the disclosed embodiments, while being applicable for adapting a primary game underlying a secondary game wherein the primary game comprises a traditional bingo game, are not restricted to application with traditional or existing bingo games. For example, additional and new variations on existing bingo games may be used as a primary game.

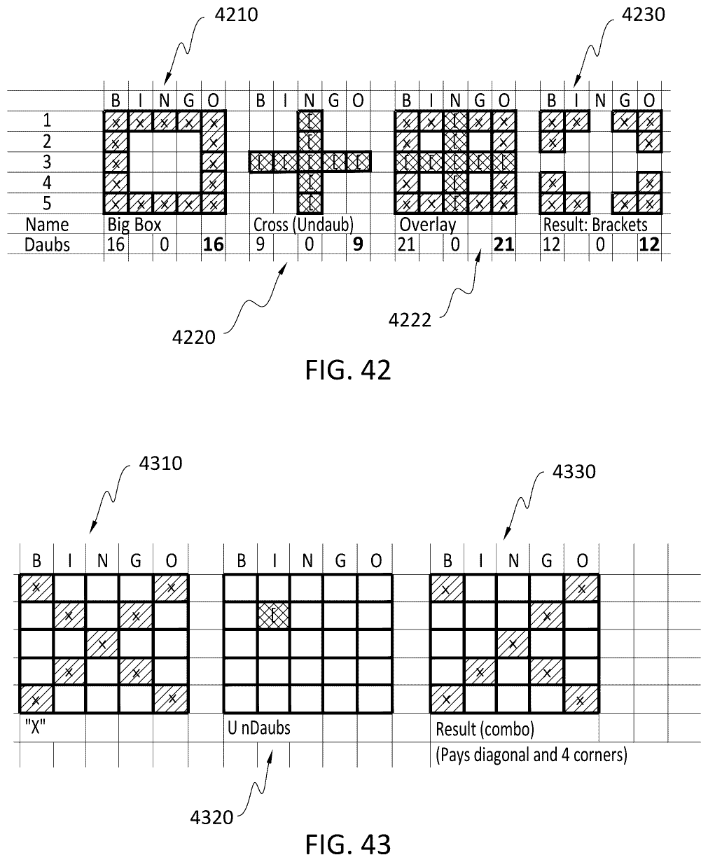

In one aspect, a primary game of bingo may be provided where subtractive patterns are provided which override or negate patterns on existing cards to create near-win experiences and/or allow for more competition. The subtractive patterns may be emergent during a ball call of the primary game or determined and/or introduced in a related manner. As shown in FIG. 42, a player's bingo card 4210 may initially be daubed according to a ball call of the primary game and matched to a final result of a result index, in this case matching a “Big Box” pattern with sixteen daubs. However, the ball call of the primary game according to FIG. 42 also included a subtractive pattern 4220, for example matching a “Cross” pattern. The subtractive pattern 4220 may then be applied to, for example overlayed 4222 on, the player's bingo card 4210 to result in undaubing any corresponding spaces. As a result of the subtractive pattern 4220 in the example of FIG. 42, a final result 4230 of the player's initial bingo card 4210 no longer matches a “Big Box” pattern with sixteen daubs, but instead matches a “Brackets” pattern with only twelve daubs, and the player is provided an award corresponding to this final result 4230.

The use of subtractive patterns in the primary game may advantageously facilitate representation of the primary game using a secondary game. For example, in a game where the player plays against a dealer, such as in a secondary game of blackjack, a dealer bust may correspond to a subtractive pattern being applied to the dealer's bingo card in the underlying primary game, or a dealer blackjack may correspond to a subtractive pattern being applied to the player's bingo card. In like manner, rather than with a dealer, competition with one or more additional players may be facilitated in the secondary game and underlying primary game using the subtractive patterns.

In a further variant according to FIG. 43, a primary game of bingo may be provided including two or more ball calls where one of the ball calls daubs the bingo cards and another of the ball calls dedaubs/undaubs the bingo cards (e.g., the dedaub ball call removes balls/daubs from the other ball call where they match). As shown in FIG. 43, evaluating the player's bingo card against a first “daubing” ball call results in a daubed card 4310, in this case matching a high value “X” pattern from a result index of the primary bingo game and/or “2-Diagonals” and “4-Corners”. However, a dedaub ball call results in a dedaub pattern 4320, which combined or evaluated with the daubed card 4310 results in a final result 4330 matching only “Diagonal” and “4-Corners” patterns and the corresponding award values, which in this case are lower than would have been won with the initial daubed card 4310.

As discussed previously, the use of a negative or dedaubing ball call in the primary game may advantageously facilitate representation of the primary game using a secondary game. For example, where the player plays against a dealer, such as in a secondary game of blackjack, a dealer bust may correspond to a dedaubing ball call negating a pattern of the dealer's bingo card in the underlying primary game, or a dealer blackjack may correspond to a dedaubing ball call negating a pattern of the player's bingo card. In like manner, rather than with a dealer, competition with one or more additional players may be facilitated in the secondary game and underlying primary game using a dedaubing ball call.

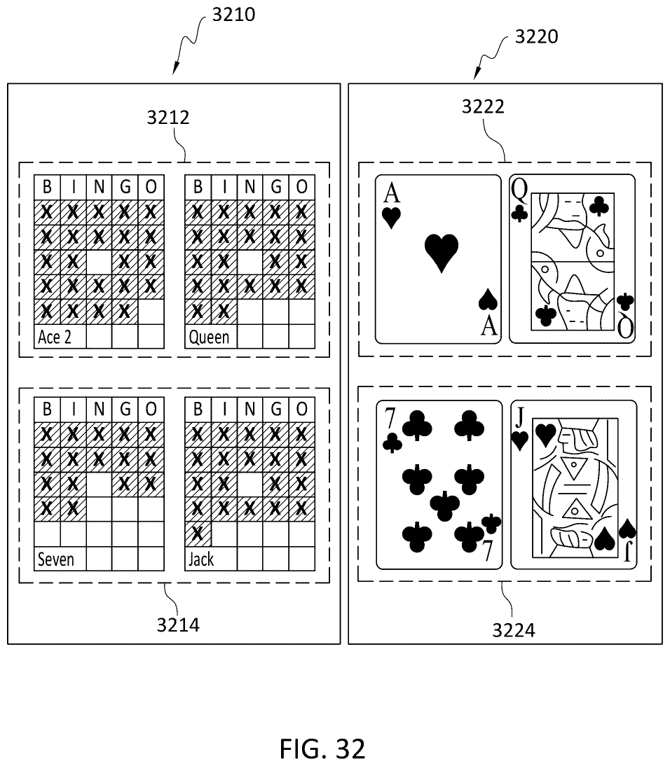

For example, as illustrated in FIG. 32, for a secondary game 3220 of blackjack and an underlying primary game 3210 of bingo, the dedaubing ball call may be represented as an evaluation of pattern combinations, or bingo card combinations, where a higher evaluation negates the lower evaluations. In the depicted embodiment, a player's bingo result 3212 is evaluated to correspond with a blackjack hand 3222 for the secondary game 3220 comprising an Ace and a Queen, which is valued at 21. The dealer's bingo result 3214 is evaluated to correspond with a blackjack hand 3224 for the secondary game 3220 comprising a Seven and a Jack, which is valued at 17, such that the player's pattern combination 3212 negates the lower evaluation.

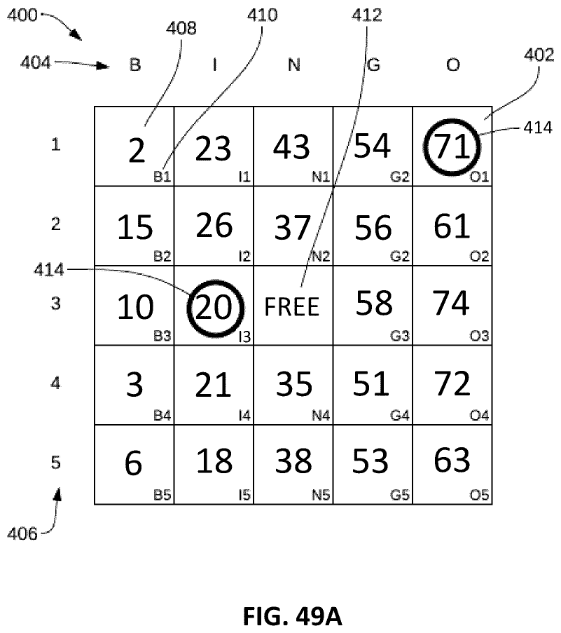

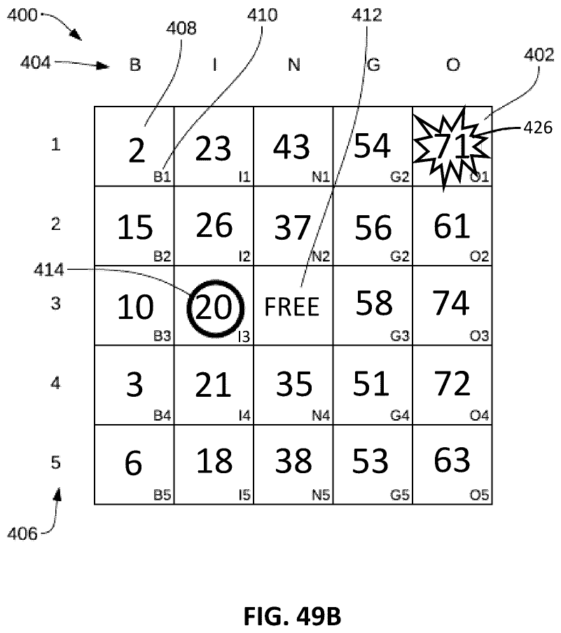

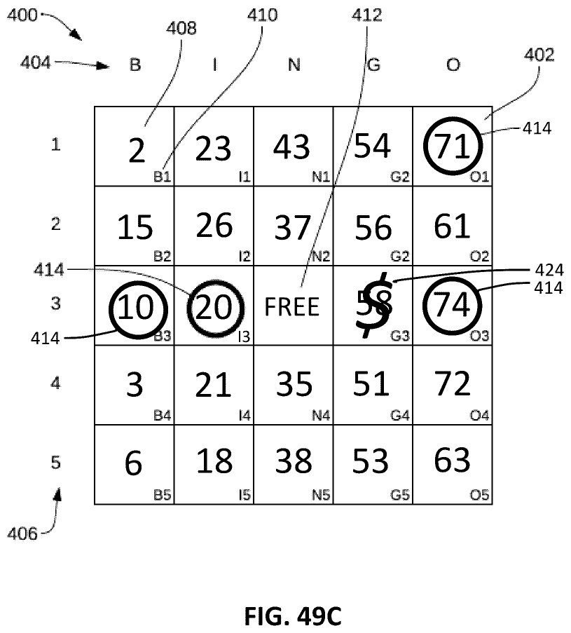

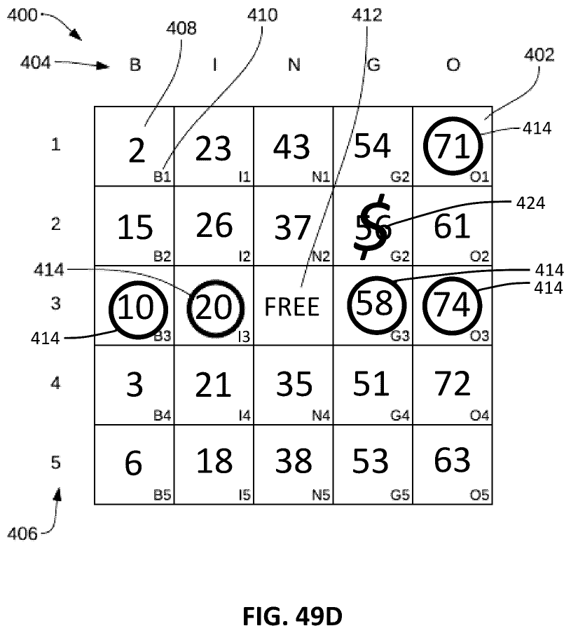

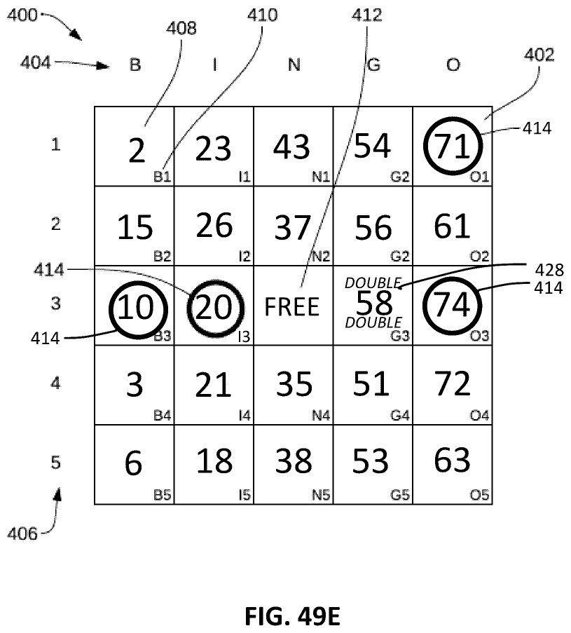

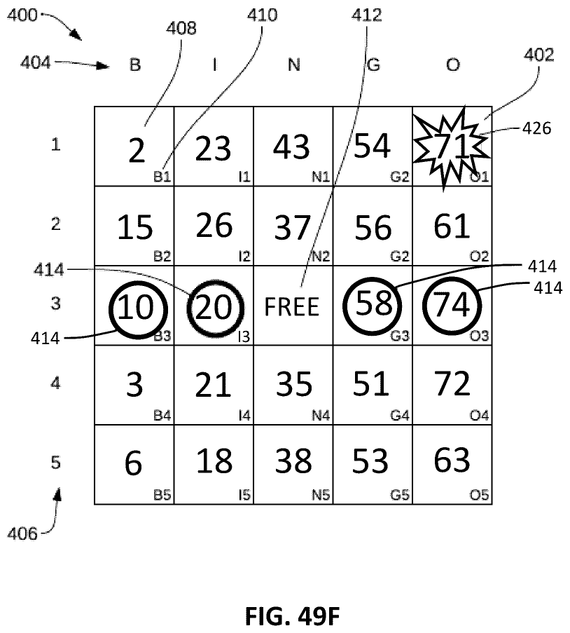

In one aspect, a primary game of bingo may be provided including dynamic daubs according to FIGS. 49-57 which may provide bonus values, bonus games, bonus patterns, or the like on existing bingo cards to modify payout values, create near-win experiences and/or allow for more competition, such that the primary game may better correspond to a secondary game, e.g. a table game. In certain aspects, a pay table or a final result of the result index of the primary game may be associated with a display element, action or result of the secondary game. When a player makes a wager or gameplay decision in the secondary game, this action may be correlated to enabling a set of dynamic daubs corresponding to varying awards to build a reward table for that gameplay.

In the secondary game, a player may select a bet option corresponding to the secondary game. For example, where the secondary game is roulette, the player may select one or more bets based on predicted characteristics of a final location of a ball in a roulette wheel, such as predicting a number or color of a pocket the ball may land in, predicting the ball will land in an odd or even numbered pocket, or the like. The selected bet option may be associated with a dynamic daub and a corresponding change in pay table or final result of the result index for the primary game, such that the player's selection adjusts the available awards for the primary game. The same principles can be applied to any secondary game by associating relevant betting options with pay table/final result entries of the primary game. In this way, the player's actions in the secondary game may have a direct effect on a result of the underlying primary game, while advantageously maintaining the primary game as the source of the wager and the wager result.

Although discussed as random in the embodiments below, in some embodiments, such dynamic daubs may correspond to or be triggered by supplemental states and/or attributes according to the embodiments of FIGS. 46-48. In varying embodiments, the dynamic daubs may correspond to or be triggered for daubs made or achieved in predefined ranges of a bingo ball call, as discussed in previous embodiments.

FIG. 49A is an illustration of a related primary game 400 in the form of bingo. Elements of the bingo game 400 include a bingo card 402 having in this example a traditional 5×5 layout consisting of columns 404 labeled with the letters “B” “I” “N” “G” and “O,” and rows 406 labeled with numbers 1-5. Although the rows are numbered 1-5 in this example for ease in describing the concepts herein, generally in a bingo game, as displayed to a user or player, the rows would not be shown as numbered. There typically is a “FREE” space 412 that is conventionally located in the center of the card 402 (at column N and row 3). Each space has an identifier 408 that can be a number, a letter, a symbol, or other indicia, and for ease of description, coordinates 410 including such as B1, are shown herein, although as noted, these would typically not be shown to the player. As used herein, the coordinates 110 for the rows ascend from 1-5 and the columns ascend from B to I to N to G to O.

As discussed previously, traditionally the game of bingo is played by distributing one or more cards 402 to the players, each card having a different arrangement of identifiers 408 on each space. Numbers indicative of the space identifiers are selected randomly and “called” as a “ball call”. It is noted that ball calls can be random, or produced by a random number generator, or pulled from numbered balls in a basket, or can be based on a very long pattern that would be unrecognizable to the players.

Players having a space identifier corresponding to an announced identifier (“ball call”) will place or have a daub 414 placed on the identifier. So, using the example in FIG. 49A, when the number “20” or “I-20” is called in a ball call, the player may place a “daub” over the space of I-3 which has the identifier 408 of “20”. The gaming system may show on the display that shows the player's bingo card 402 the space I-3 having the identifier of “20” called in a ball call by generating and showing a daub 414, which is placed on the called identifier of “20” at space I-3. Similarly, the gaming system may show on the display that shows the player's bingo card 402 the space O-1 having the identifier of “71” called in a ball call by generating and showing an identical daub 414, which is placed on the called identifier of “71” at space O-1.

The ball call may be made sequentially over a period of time, or the ball call may be called, generated, or provided as a set in a listed sequence. A win may be determined when a player meets prescribed criteria, such as a complete row, column, a diagonal, or other predetermined patterns, such as (but not limited to) an arrow, flame, numbers, checkerboard, chevron, “X”, pyramid, inverted pyramid, or a blackout (all spaces being “daubed”). In this related example, the daubs 414 placed over identifier “20” at space I-3 and identifier “71” at space O-1 are identical, that is they are shown with the same icon, which is typical in traditional bingo games. In the example of FIG. 49A, the daubs are both shown with a simple bold line circle.

In some embodiments, an award or payout associated with a winning pattern of a final result index may be based on additional factors outside of the pattern itself. In some cases a certain characteristic of the daubed spaces forming the pattern may influence the award or payout, for example where a pattern is formed by all even numbered spaces or all odd numbered spaces or alternating even/odd numbered spaces or another attribute or characteristic is present, a bonus or multiplier effect or some other benefit to the player may be provided. In another aspect, where the daubs on the bingo card only form the winning pattern with no other spaces being daubed a bonus or multiplier effect or some other benefit to the player may be provided. In another aspect, where the daubs on the bingo card daub all of the spaces except for the winning pattern a bonus or multiplier effect or some other benefit to the player may be provided. Alternatively, or in addition to such positive effects, certain characteristics of the pattern may be configured to have a negative effect.

It is noted that in embodiments described herein, the bingo cards may be shown or described as 5×5 bingo cards, having five columns and five rows of spaces with corresponding space identifiers. However, the concepts of the disclosure should not be construed or limited to such an arrangement. Indeed, the concepts of this disclosure could be implemented with varying or different arrays of spaces, including in different numbers of columns and rows (for example, but not limited to arrays of spaces such as 3×11, 3×15, 7×7, 3×3, 3×4, 3×5, 4×4, 6×6 7×7, 10×10, etc.). Further the bingo cards are not to be limited to symmetric shapes and arrays, but may be of different shapes or asymmetric. And the grid of the spaces need not be in a perpendicular grid but may be of any shape, size, geometry or orientation.

In an embodiment, as shown FIG. 49B, similar features are identified with the same reference characters. In the example of FIG. 49B, rather than having the daubs represented with the same icon or character (such as the bold lined circle of daubs 414 of FIG. 49A), in the example of FIG. 49B, the daubing icons include two or more different daubs. For example, when the ball call including “20” is made, daub 414 is generated and shown over space 13 as a bold lined circle. However, when the ball call including “71” is made, a daub 426 including an exploding icon is shown over the number 71 in space O-1.

In a further embodiment, as shown in FIG. 49C, the line or row 3 may be daubed with daubs 414 as the ball call is made including balls or elements corresponding to the identifiers “10” “20” and “74” (and the free space). But upon a ball call including the identifier “58” of space G-3, the electronic system may randomly generate and show a different type of icon, in this example, a dollar sign “$” icon which is shown to overlay the identifier “58” in the space G-3.

Accordingly, this sequence of the ball call may result in a win of a prize due to the line of row 3 having been daubed, therefore satisfying a predetermined pattern. But in the example of FIG. 49C, due to the generating and showing of a dollar sign “$” icon as a daub, some benefit may be given to the player, such as an increased prize, an additional prize, or a type of bonus, such as granting a free bingo card for additional play to the player due to the generated daub icon. With the introduction of a plurality of types of daubs, a primary game may have an expanded number of achievable final results, payouts, and player decisions that can accordingly allow more possible results and player decisions in a corresponding secondary game, such as a table game. As such, the plurality of types of daubs may be configured to correspond to betting options, results, betting options, and/or awards of a secondary game. Player interest is accordingly heightened, as different daubs can have different consequences for the outcome of the primary game and, consequently, the secondary game.

In the example of FIG. 49D, the line or row 3 may be fully daubed with daubs 414 as the ball call is made including the identifiers “10” “20” “58” and “74” being called (and the free space). But upon a ball call including the identifier “56” of space G-2, which is not in row 3 nor related to row 3, the system may randomly generate and show the dollar sign icon “$”, which may result in the player being given an additional prize or benefit, in addition to the prize based on the line of row 3 having been daubed, therefore satisfying a predetermined pattern. That is, the player having the card 402 in FIG. 49D may be allotted a prize for achieve the line of row 3 daubed, and then may be given an additional prize, benefit, or bonus due to having received an (unrelated) daubing with daub 424 that is randomly generated in for the space of G2 that is daubed over the identifier of 56. For example, the dollar sign icon “$” may correspond to a player achieving “21” in blackjack, or the like.

In a further embodiment, as shown in FIG. 49E, the line or row 3 may be daubed with daubs 414 as the ball call is made including the identifiers “10” “20” and “74” (and the free space). But upon a ball call including the identifier “58” of space G-3, the system may randomly generate and show a different type of icon, in this example, “DOUBLE DOUBLE” icon which is shown to overlay the identifier “58” in the space G-3. In this instance, due to the “DOUBLE DOUBLE” icon being generated as the daub for one of the spaces that satisfies or achieves the predetermined pattern (in this case a line), the player can be awarded double the usual prize that would be awarded to the player had the predetermined pattern been satisfied and only the bold lined circled daubs 414 been generated to show the ball call including the entire row or line. With the introduction of a plurality of types of daubs, player interest in the game is heightened, as different daubs can have different consequences of the outcome of the primary game and the corresponding secondary game.

Further, it may be the case that the daub that is generated by the system has a negative effect on the player. For example, in the embodiment of the primary game shown in FIG. 49F, the line or row 3 may be fully daubed with daubs 414 as the ball call is made including the identifiers “10” “20” “58” and “74” being called (and the free space). But upon a ball call including the identifier “71” of space O-1, which is not in row 3 nor related to row 3, the system may randomly generate and show the explosion icon 426, which may result in the player having the prize that would be awarded due to achieving the line of row 3 as a predetermined pattern lessened due to the generation of the explosion icon 426. That is, the player having the card 402 in FIG. 49F may be allotted a reduced prize for achieving the line of row 3 daubed due to the explosion icon 426 having been randomly generated in a ball call including the identifier “71”.

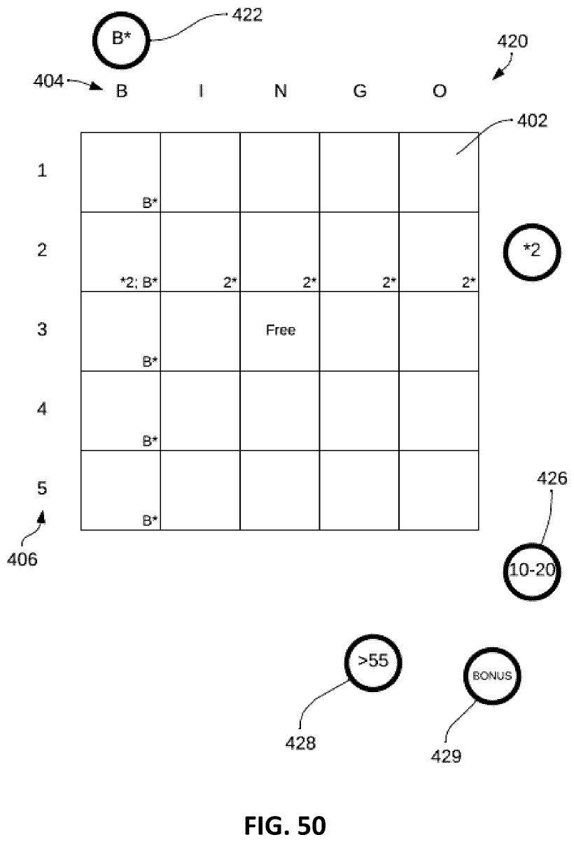

In another embodiment, FIG. 50 provides an illustration of a variation of a primary game 420 in the form of bingo including what may be termed “wildcard” daubs according to embodiments of the present disclosure. The bingo game 420 may have rules similar to traditional bingo games, including the card 402, the columns 404, and the rows 406 and the general order of play and winning conditions. The bingo game 420 also includes daubs that may be applied to more than one space. These daubs can be generated at random to increase the chance for a win and the excitement level of the bingo game 420, and may correspond to an event in a secondary game, such as a player splitting in blackjack or the like.

One such daub may be a wildcard daub 422 that includes an indication that the daub 422 may be placed on any space in the “B” column. One such indication can be an asterisk (*). If the card has an identifier corresponding to a space on the card 402, and the daub that is chosen is a wildcard daub 422, the player may place the wildcard daub 422 on any space in the column. Or, the gaming system may determine and place the wildcard daub 422 in a space that would be most advantageous to the player to achieve the greatest award or prize or bonus. A similar wildcard daub 424 may be contemplated for rows in the bingo card.

In the depicted embodiment of FIG. 50, the wildcard daub 424 is valid on any space in the row “2.” Other variations of wildcard daubs 426 may include a range of indicators upon which the wildcard daub 426 may be placed. One such range can be any indicator between 10-20. Another such wildcard daub 428 can be any indicator greater than 55. Other numbers and ranges can be used. These wildcard daubs are more valuable because of their flexibility and ability to cover more than one space if the indicator is chosen. Accordingly, these wildcard daubs can be relatively rare.

In other embodiments a bonus daub 429 can be part of the bingo game 420. In some bingo games, there are a set number of balls that will be called, after which the game ends. For discussion, in a certain bingo game there are 40 balls in a ball call. The player must achieve a win before the 40 balls are called. The bonus daub 429 may be generated but may not count toward the 40-ball total of the ball call, giving the player(s) a greater chance to win the bingo game 420. These calls may therefore be considered “free” in terms of not counting toward the total count that ends the bingo game 420.

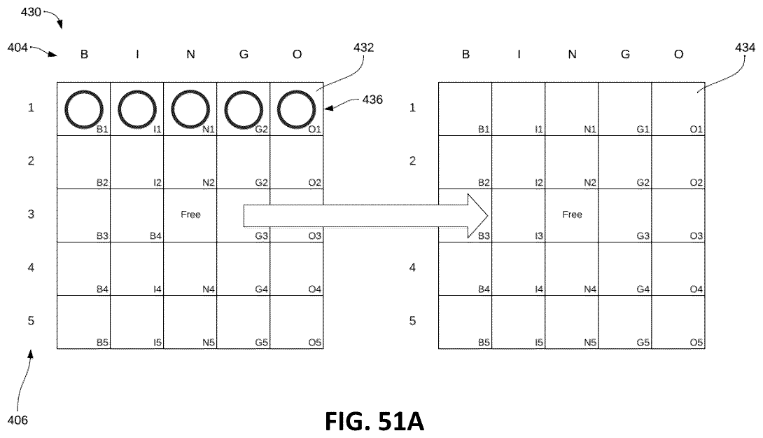

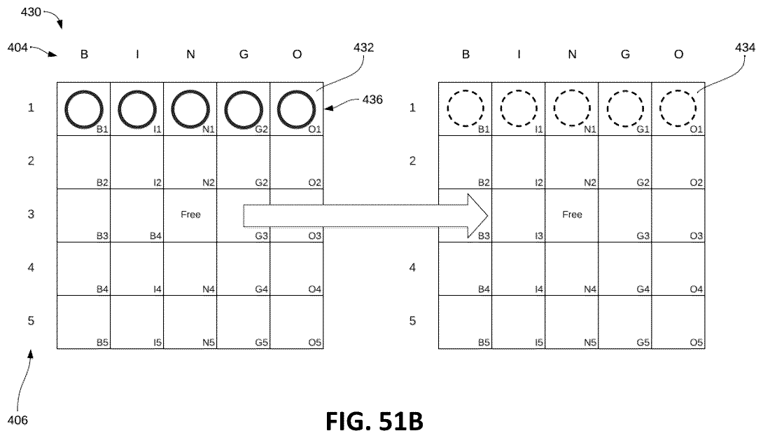

FIG. 51A illustrates another bingo game 430 with an additional card according to embodiments of the present disclosure. The bingo game 430 can include familiar elements such as a card 432 having columns 404 and rows 406, each having an indicator (not shown) that, when called, allows the player to “daub” that space. A win condition can be any predetermined pattern, such as a complete row, column, diagonal, or blackout. In the embodiment of FIG. 51A, the card 402 has reached a prize-winning condition of having five aligned daubs along the row “1.” In response to the win, a second card 434 is generated and presented to the player as a bonus, which may itself be compared to the ball call that was applied to the first card 432. The second card 434 can be a new card having all new space identifiers, or may have some similarities in space identifiers. The bingo game 430 may continue, with other players (if any) continuing their run, and the winning player alone has the second card 434.

According to embodiments of the current disclosure, mid-game wager options of a secondary game may be converted to a choice for a player related to a dynamic daub of a primary game. For example, for a secondary game of blackjack, the player receives an initial hand and may select whether to “hit” and receive an additional card or “stay” and proceed with the initial hand as dealt. For certain hands, the player may elect to “split” or “double-down”.

In some embodiments, as shown in FIG. 51B the second card 434 can include carryover daubs 438 that were placed on the first card 432. In some embodiments the carryover daubs 438 are worth less than daubs placed directly onto the second card 434. The carryover daubs 438 can be presented in phantom lines or with other indications that the carryover daubs 438 are not the same as standard daubs 436 on the first card 432 or the second card 434. The player may be presented with a choice while the second card 434 is active to activate one or more of the carryover daubs 438. The choice may correspond to mid-game wager options of a corresponding secondary game.

Suppose, for example, the player has placed one or more daubs onto the second card 434, but has not yet or will not achieve a win using purely daubs placed onto the second card 434. If one or more of the carryover daubs 438, if they became active on the second cards 434, would achieve a win, the player can choose to activate the carryover daubs 438 and achieve the win on the second card 434. One or more of the carryover daubs 438 can be selected.

In some embodiments the carryover daubs 438 can be selected directly and individually by the player. In other embodiments the player may make choice to activate one or more of the carryover daubs 438 without being able to choose which carryover daub 438 will be activated. The player may be able to spend resources (money, or another in-game resource) to activate one or more carryover daubs 438. There may be an inverse relationship between the resources spent activating carryover daubs 438 and the payout associated with a win that includes carryover daubs 438. Also, the more carryover daubs 438 used to achieve the win, the less the associated payout will be.

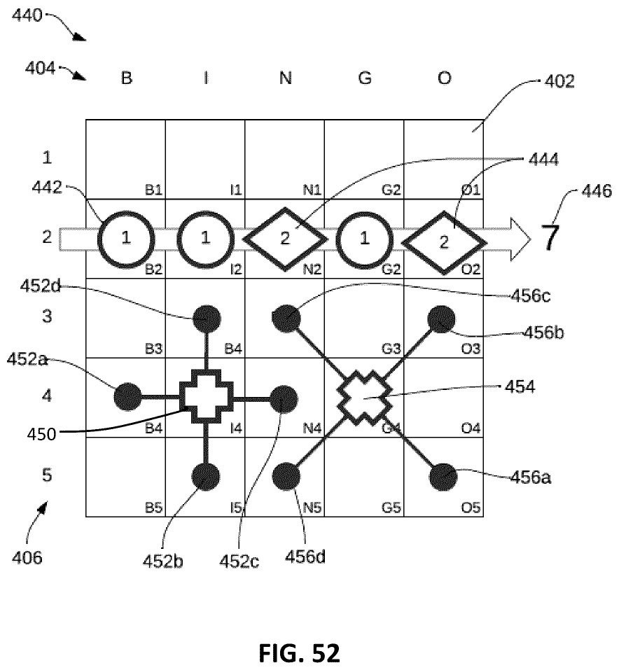

FIG. 52 is an illustration of a primary game 440 in the form of bingo and variations including daubs of differing values according to embodiments of the present disclosure. The bingo game 440 can include familiar elements including a card 402, columns 404, rows 406, and space identifiers (not shown). The order of play may also be familiar with a ball call being made at random, resulting in a daub placed in a space on the card 402. There may be first daubs 442 having a first value, and second daubs 444 having a second value. The respective values may be any arbitrary or based on a predetermined number or value, and there may be third daubs and fourth daubs, etc. For purposes of discussion, in this example, the first daubs 442 are worth 1, and the second daubs 444 are worth 2.

In the illustrated embodiment the player has achieved a complete row with first daubs 442 being placed in the B, I, and G spaces, and with second daubs 444 being placed in the N and O spaces. The row is a win, and the total value of the win is equal to the sum of the daub values, which in this case is 7, shown at 446. The bingo game 440 can display a graphical depiction of the win including the value of the payout expressed in terms of the sum of the daubs' value. In other embodiments the daubs' value is a multiplier of the values of the daubs. In yet other embodiments there may be different mathematical values associated with the different daubs, for example in order to correspond with betting options of a corresponding secondary game.

The values of the daubs can be announced before the identifier for the daub, to increase the anticipation and excitement of the bingo game 440 or the corresponding secondary game. Or, the value of the daubs can be shown on the display to increase anticipation and excitement. There may be an inverse relationship between the value of the daubs and the frequency of occurrence of the daubs.

The first daubs 442 and second daubs 444 may be represented with different symbols, such as the circles for the first daubs 442 and the diamonds for the second daubs 444. There may be additional indicia to show the value of the daubs that generally corresponds with the value of the daubs. Ordinary daubs having a low value can have a mundane presentation in terms of color, movement, and shape, while higher value daubs can have escalating appearance corresponding to their value. Different colors, sparkles, movements, and shapes can be presented to increase the interest in the bingo game 440 and to represent the value for the daubs.

The bingo game 440 can also include multispace daubs according to embodiments of the present disclosure. Multispace daubs may be randomly occurring, relatively rare events in the bingo game 440. An orthogonal multispace daub 450 can include a main body in the form of a cross that is placed upon a corresponding space if a call is announced, and the card has a corresponding space according to the indicator on the card 402. The orthogonal multispace daub 450 can also have extensions 452a, 452b, 452c, and 452d, that extend outwardly from the main body and cover spaces around the main body. These extensions can count as daubs on those spaces, resulting in a much higher chance for a win than ordinary single-space daubs. If one or more of the extensions overlap with a previously placed daub, the space remains covered. Another variation of multispace daub is the diagonal multispace daub 454 which includes a main body and extensions 456a, 456b, 456c, and 456d. Other shapes of multispace daubs are also envisioned, including multispace daubs having a different number of extensions, and multispace daubs having different distances between the extension and the main body.

In another embodiment, the daubs can be randomly selected as chess pieces: pawns, castles, bishops, knights, rooks, queens, and kings. The bingo card can be presented as a chess board, and each daub can make one move when called, and the path of the move covers the spaces in the path. For example, a knight daub can cover two spaces in a first direction, and a third space in a second direction. The player may choose the direction of the “move” or the gaming system conducting the bingo game may automatically move the daub in the direction that would be most favorable to the player or to correspond to a player decision made in the corresponding secondary game.

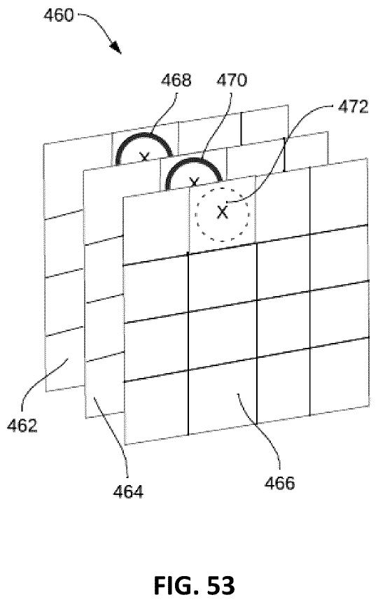

FIG. 53 illustrates a primary game 460 in the form of a bingo game having layered bingo cards according to embodiments of the present disclosure. The bingo game 460 can include two or more cards arranged in an overlapping, layered pattern. A first card 462, a second card 464, and a third card 466 are shown. There may be any desired number of cards according to this embodiment. The cards can be played consecutively, or simultaneously.

Daubs from one of the cards can apply in one or more of the other cards. For example, a daub 468 can be placed on the first card 462 and can apply to the second card 464. In the second card 464 the daub may be a carryover daub 470. In the third card 466 the daub can be displayed as a projected daub 472 that can be portrayed to the player as an option that the player can exercise to render the projected daub 472 valuable in the third card 466. The display of the cards can be in three dimensions, similar to FIG. 53. In some embodiments the cards can be rotated and translated around the display using an input device such as a mouse or a touch-sensitive input to allow the player to see the different cards and the status of each. The cards can be moved closer to one another or farther apart to allow greater visibility of the cards. The player may select a card to highlight the card, which may change the display of the other cards to a transparent or phantom status so as to not obscure the highlighted card or cards.

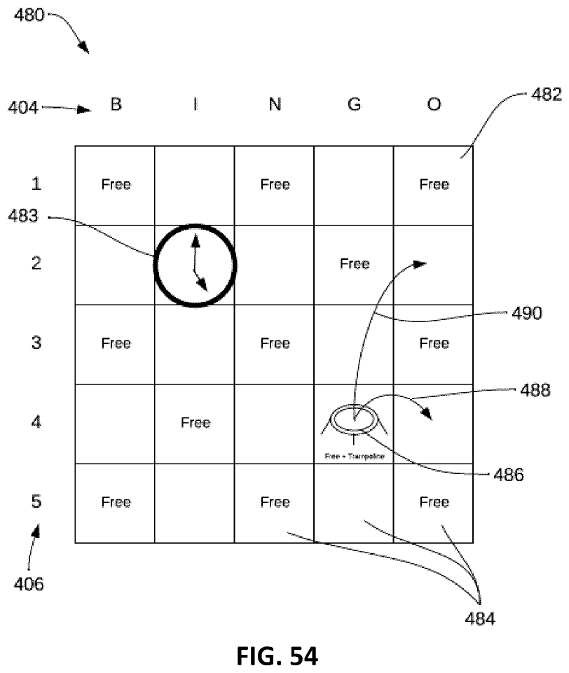

FIG. 54 is an illustration of a primary game 480 in the form of bingo including variations having alternate free space patterns according to embodiments of the present disclosure. The bingo game 480 can include familiar elements including the card 482, columns 404, rows 406, and spaces. The card 482 can include a pattern of free spaces such as the checkered layout shown here, or another suitable free space pattern. The free spaces can be achieved during play as random rewards for the player. The card 482 may initially have one or zero free spaces, and as random rewards that may be related to calls, or at least given to the player in combination with the calls, additional free spaces or patterns of free spaces can be given. In some embodiments one or more of these free spaces can be temporary free spaces 483. Some of the free spaces could be temporary in that they will last for the next few calls, and if there is no win during the next few calls, the temporary free spaces will expire.

An additional variation can be in the form of a space identifier 486 that, in addition to counting as a free space, the trampoline identifier 486 can “bounce” a daub from that space to another, randomly selected space on the card 482. The trampoline identifier 486 can be depicted as a trampoline or another attractive, humorous symbol that, in an entertaining way, distributes that daub elsewhere. A visual animation of the transfer can be made on a display, such as 488 and 490 showing an arcing trajectory for the transferred daub.

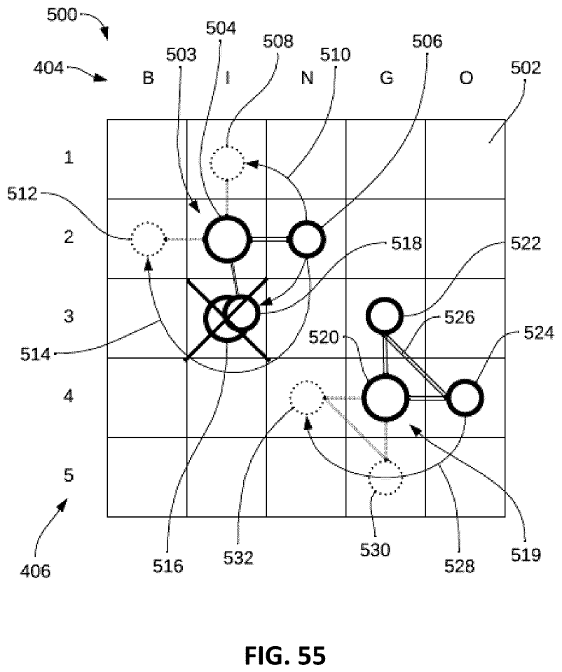

FIG. 55 is another illustration of a primary game 500 in the form of a bingo game including movable daubs are applied according to embodiments of the present disclosure. The bingo game 500 can include familiar elements such as a card 402, columns 404, and rows 406. The bingo game 500 can include standard daubs covering single spaces, and intermittent, randomly assigned movable daubs.

One example is a movable daub 503 that includes a root daub 504 that is placed at the space corresponding to the indicator for that space when that indicator is called. The movable daub 503 may also have a companion daub 506 that is attached to the root daub 504, similar to the extensions shown and described herein elsewhere. The daub can be rotated around to move the companion daub 506 to a different space on the card 402. For example, the companion daub 506 can initially be shown to the right of the root daub 504, and the player can, through an input interface such as a mouse, keyboard, or touch interface, can rotate the companion daub 506 to another position relative to the root daub 504. Or, alternatively, the gaming system can automatically rotate or move the companion daub 506 to another position relative to the root daub 504 in a way that would provide the player the maximum possible benefit or prize. For example, rotating the companion daub 506 to the space above the root daub 504 moves the companion daub 506 along a path 510 to the space “I1” at 508. Alternatively, the companion daub 506 can be rotated in the other direction along a path 514 to the “B2” space 512 to the left of the root daub 504.

In the case of overlap between a companion daub 506 and another existing daub 516, the event can have a variety of consequences. In some embodiments the overlap can cause both daubs to be removed from the board. In other embodiments the overlap can cause the daubs to combine to increase their value, and the value can be calculated in the event of a win including that combined daub.

Another feature of the bingo game 500 that involves movable daubs is a multicompanion daub 519 that includes a root daub 520, a first companion daub 522 and a second companion daub 524 that are connected with an arm 524. The root daub 520 can be placed and remains stationary and the companion daubs 522 and 524 can be rotated together or independently. For example, the companion daubs can be moved along a path 528 from the spaces above and to the right of the root daub 520, to the spaces to the left of and below the root daub 520, shown in phantom at 530 and 532. The companion daubs may be movable in rotation or in translation. In some embodiments the companion daubs are movable for a short time, requiring the player to respond quickly to place the daubs in an advantageous position. This adds an element of excitement, especially when considering the possibility of an overlap having negative consequences such as knocking out an existing daub, or in the case of a positive consequence such as a multiplication or addition with an overlapping daub, there is little time to capture this value.

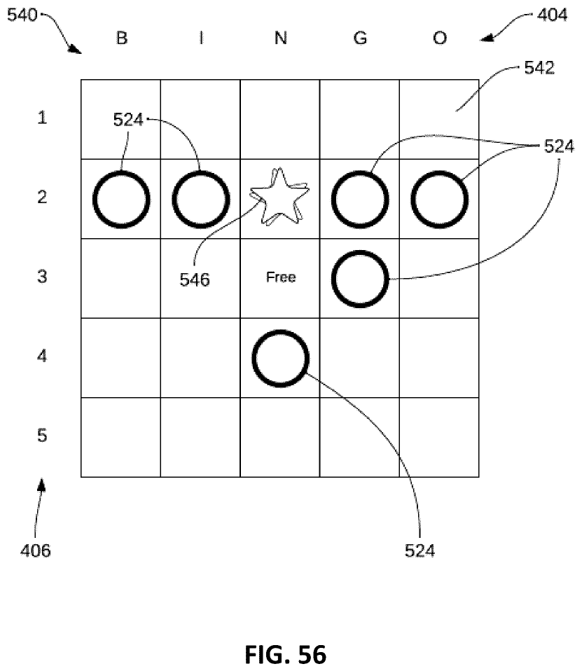

FIG. 56 is another illustration of a primary game 540 in the form of bingo including anticipatory markers according to embodiments of the present disclosure. The bingo game 540 includes familiar elements such as a card 542, columns 404, rows 406, etc. In the depicted embodiment there are daubs 524 on the “2” row that nearly complete a win. If a daub is placed on the N2 space the card is a winner and a prize is awarded. To emphasize this and to increase excitement and anticipation, a marker 546 can illuminate in anticipation of a possible call that would result in a win. The marker 546 can be a star, or another exciting symbol that can include flashy animations, a pulsation, a color, or another highlight of the N2 space. In the case of a win, the marker 546 can increase in intensity and combine with an exciting display to emphasize the win. In the case of a near win, such as a call resulting in a daub near a winning space, such as in this example in the N1 space, an indication of disappointment such as an audible groan from a crowd, or a tantalizing display can be shown.

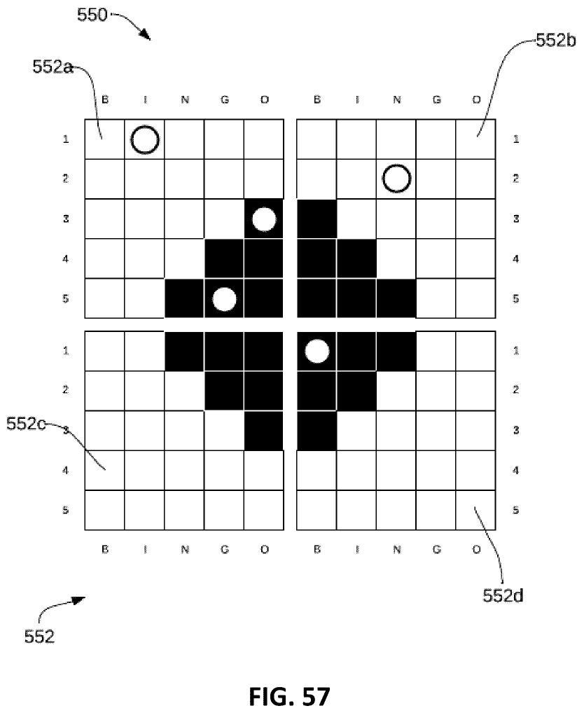

FIG. 57 is another illustration of a primary game 550 in the form of bingo including variations with multiple cards 552 that, when combined together, form an image to complete a win according to embodiments of the present disclosure. The bingo game 550 can include multiple cards arranged side-by-side, cards 552a, 552b, 552c, and 552d (collectively cards 552) are each cards in the bingo game 550. Each card has certain special spaces 554 that are visually distinct from other spaces. When these cards 552 are arranged in this order, the special spaces 554 form an image of a diamond. Completion of the diamond using the different cards 552 can result in a different win condition for the bingo game 550.

In some embodiments the multiple cards 522 can be combined in a different orientation relative to one another that can achieve a different win condition. The player may make a decision based on where the cards are relative to one another and factoring in the placement of daubs on the cards 522. For example, the win condition could be to achieve a large number of contiguous daubs, and arranging the cards 522 relative to one another to connect groups of daubs to achieve a higher number of contiguous daubs can result in a win or an increased payout in the event of a win.

Embodiments of the gaming system and the related methods according to the present disclosure may advantageously maximize gameplay at a gaming server by conducting gameplay in a secondary game of an entertaining display with input from the user and an underlying primary game in the form of a bingo game. The use of the bingo game may separate the result of the wager from an active presentation of the gameplay, enabling the gaming system to present a user with entertaining gameplay while streamlining the underlying wager. Further, regulatory constraints for operation of the gaming system are reduced, and locations suitable for providing a gaming system are increased without the associated costs and complexity of prior art systems.

As referenced in the examples of the current disclosure, a “game,” “active game,” “existing game,” and/or “new game” may be used to refer to a set of parameters governing results of a wager. A player or gameplay request entering or being assigned to a game generally refers to applying the wagering parameters associated with the game to a wager associated with the player or gameplay request.

By providing a gaming system and method for using the same according to the disclosed embodiments, the requirements of existing gaming systems including complex variations across varying regulatory regions are addressed. The gaming system embodiments provided herein advantageously allow a prospective player to play essentially any game based on a bingo game result, thereby increasing a player's enjoyment of the gaming system generally, while meeting the regulatory requirements and retaining the advantages of bingo or class III gaming.

While the invention has been illustrated and described in detail in the drawings and foregoing description, the same is to be considered as illustrative and not restrictive in character, it being understood that only the preferred embodiments have been shown and described and that all changes, equivalents, and modifications that come within the spirit of the inventions defined by following claims are desired to be protected.

It is to be understood that not necessarily all objects or advantages may be achieved under any embodiment of the disclosure. Those skilled in the art will recognize that the disclosed gaming system and related methods may be embodied or carried out in a manner that achieves or optimizes one advantage or group of advantages as taught without achieving other objects or advantages as taught or suggested.

The skilled artisan will recognize the interchangeability of various disclosed features. Besides the variations described, other known equivalents for various features can be mixed and matched by one of ordinary skill in this art to make or use a gaming system and related methods under principles of the present disclosure. The features described may be adapted to other types of systems, games and regulatory requirements.

Although this disclosure describes certain exemplary embodiments and examples of a gaming system and related methods, the present disclosure extends beyond the specifically disclosed embodiments to other alternative embodiments and/or uses of the disclosure and obvious modifications and equivalents thereof. It is intended that the present disclosure should not be limited by the particular disclosed embodiments described above.

The disclosure further relates to several embodiments as identified by the below numbered embodiments. The present invention is in no way limited to the embodiments described by way of example and represented in the embodiments, and the embodiments are provided only to demonstrate non-limiting examples of possible embodiments of the disclosure.

1-1. A gaming system comprising:
a display device configured to display an output to a user;
an input device configured to accept a wager from the user for a primary game, the primary game being based on a bingo game;
a processor coupled to a memory, the input device and the display device;
the gaming system configured to:
provide a secondary game to the user;
receive an input from the user for the secondary game and convert the user input to the wager for the primary game;
determine a result of the wager for the primary game; and
provide an output of the secondary game to the user corresponding to the result of the wager.

1-2. The gaming system of any one or a combination of two or more of embodiments 1-1 above and 1-3 to 1-10 below,
wherein the bingo game comprises at least a card and a call adapted to emulate the secondary game.

1-3. The gaming system of any one or a combination of two or more of embodiments 1-1 to 1-2 above and 1-4 to 1-10 below, wherein the card of the bingo game includes one or more columns or rows corresponding to a die,
wherein the call of the bingo game is provided column-by-column or row-by-row, and
wherein the secondary game comprises a dice game.

1-4. The gaming system of any one or a combination of two or more of embodiments 1-1 to 1-3 above and 1-5 to 1-10 below, wherein the dice game comprises sic bo or craps.

1-5. The gaming system of any one or a combination of two or more of embodiments 1-1 to 1-4 above and 1-6 to 1-10 below, wherein the input from the user for the secondary game corresponds to selecting betting options from the secondary game,
wherein the bingo game includes final results in a result index corresponding to each of the betting options of the secondary game, and
wherein converting the user input to the wager for the primary game comprises enabling the final results in the result index corresponding to the selected betting options of the secondary game.

1-6. The gaming system of any one or a combination of two or more of embodiments 1-1 to 1-5 above and 1-7 to 1-10 below, wherein the user input comprises an initial input and a mid-game input.

1-7. The gaming system of any one or a combination of two or more of embodiments 1-1 to 1-6 above and 1-8 to 1-10 below, wherein converting the user input to the wager for the primary game comprises enabling an additional final result of the result index in the primary game.

1-8. The gaming system of any one or a combination of two or more of embodiments 1-1 to 1-7 above and 1-9 to 1-10 below, wherein the additional final result of the result index is a sub-pattern of a winning final result of the result index or an anti-pattern that is mutually exclusive with the winning final result of the result index.

1-9. The gaming system of any one or a combination of two or more of embodiments 1-1 to 1-8 above and 1-10 below, wherein the bingo game includes a predetermined number of cards each having a unique number in a hot spot and a call corresponding to the predetermined number of cards.

1-10. The gaming system of any one or a combination of two or more of embodiments 1-1 to 1-9 above, wherein converting the user input to the wager for the primary game comprises dividing the predetermined number of cards between multiple users and identifying one winner based on comparing the call to the cards of each of the multiple users.

1-11. A method for conducting games, comprising:
providing a primary game to a gaming system, the primary game being based on a bingo game; providing a secondary game to a user at the gaming system;
receiving an input from the user for the secondary game and converting the user input to a wager for the primary game;
determining a result of the wager for the primary game; and providing an output of the secondary game to the user corresponding to the result of the wager.

1-12. The method of any one or a combination of two or more of embodiments 1-11 above and 1-13 to 1-20 below, wherein the bingo game comprises at least a card and a call adapted to emulate the secondary game.

1-13. The method of any one or a combination of two or more of embodiments 1-11 to 1-12 above and 1-14 to 1-20 below, wherein the card of the bingo game includes one or more columns or rows corresponding to a die, wherein the call of the bingo game is provided column-by-column or row-by-row, and wherein the secondary game comprises a dice game.

1-14. The method of any one or a combination of two or more of embodiments 1-11 to 1-13 above and 1-15 to 1-20 below, wherein the dice game comprises sic bo or craps.

1-15. The method of any one or a combination of two or more of 1-11 to 1-14 above and 1-16 to 1-20 below, wherein the input from the user for the secondary game corresponds to selecting betting options from the secondary game,
wherein the bingo game includes final results in a result index corresponding to each of the betting options of the secondary game, and
wherein converting the user input to the wager for the primary game comprises enabling the final results in the result index corresponding to the selected betting options of the secondary game.

1-16. The method of any one or a combination of two or more of embodiments 1-11 to 1-15 above and 1-17 to 1-20 below, wherein the user input comprises an initial input and a mid-game input.

1-17. The method of any one or a combination of two or more of embodiments 1-11 to 1-16 above and 1-18 to 1-20 below, wherein converting the user input to the wager for the primary game comprises enabling an additional final result of the result index in the primary game.

1-18. The method of any one or a combination of two or more of embodiments 1-11 to 1-17 above and 1-19 to 1-20 below, wherein the additional final result of the result index is a sub-pattern of a winning final result of the result index or an anti-pattern that is mutually exclusive with the winning final result of the result index.

1-19. The method of any one or a combination of two or more of embodiments 1-11 to 1-18 above and 1-20 below, wherein the bingo game includes a predetermined number of cards each having a unique number in a hot spot and a call corresponding to the predetermined number of cards.

1-20. The method of any one or a combination of two or more of embodiments 1-11 to 1-19 above, wherein converting the user input to the wager for the primary game comprises dividing the predetermined number of cards between multiple users and identifying one winner based on comparing the call to the cards of each of the multiple users.

1-21. A hardware storage device having instructions stored therein, which, when executed by one or more processors of a computer device, cause the one or more processors to performing the method according to any one or a combination of two or more embodiments 1-11 to 1-20 above.

2-1. A gaming system comprising:
a display device configured to display an output to a user;
an input device configured to accept a wager from the user for a primary game, the primary game being based on a bingo game;
a processor coupled to a memory, the input device, and the display device;
the gaming system configured to:
provide a secondary game to the user;
provide an initial output from the primary game and convert the initial output to correspond with the secondary game;
receive an input from the user for the secondary game and convert the input to correspond to the primary game;
determine a result of the wager for the primary game; and provide an output of the secondary game to the user corresponding to the result of the wager.

2-2. The gaming system of any one or a combination of two or more of embodiments 2-1 above and 2-3 to 2-10 below,
wherein the initial output from the primary game comprises at least a bingo card and a ball call, the bingo card and the ball call corresponding to elements of the secondary game.

2-3. The gaming system of any one or a combination of two or more of embodiments 2-1 to 2-2 above and 2-4 to 2-10 below, wherein the elements of the secondary game comprise playing cards and converting the initial output to correspond to the secondary game comprises converting the ball call to a hand of playing cards.

2-4. The gaming system of any one or a combination of two or more of embodiments 2-1 to 2-3 above and 2-5 to 2-10 below, wherein the secondary game comprises poker.

2-5. The gaming system of any one or a combination of two or more of embodiments 2-1 to 2-4 above and 2-6 to 2-10 below, wherein the input from the user for the secondary game corresponds to selecting betting options from the secondary game.

2-6. The gaming system of any one or a combination of two or more of embodiments 2-1 to 2-5 above and 2-7 to 2-10 below, wherein the betting options include a choice of keeping or replacing each card of the hand of playing cards and converting the input from the user to correspond to the primary game comprises keeping or redrawing each ball of the ball call for determining a final ball call.

2-7. The gaming system of any one or a combination of two or more of embodiments 2-1 to 2-6 above and 2-8 to 2-10 below, wherein determining a result of the wager for the primary game comprises comparing the bingo card and the final ball call to winning patterns of a result index, each winning pattern corresponding to a reward value.

2-8. The gaming system of any one or a combination of two or more of embodiments 2-1 to 2-7 above and 2-9 to 2-10 below, wherein a plurality of ball calls are provided for each of a plurality of users, each of the plurality of users having identical bingo cards.

2-9. The gaming system of any one or a combination of two or more of embodiments 2-1 to 2-8 above and 2-10 below, wherein determining a result of the wager for the primary game comprises comparing the bingo card and the ball call of each of the plurality of users to winning patterns of a result index, each winning pattern corresponding to a reward value, wherein only a user of the plurality of users having the ball call corresponding to a winning pattern of the result index having a highest value is provided a corresponding reward.

2-10. The gaming system of any one or a combination of two or more of embodiments 2-1 to 2-9 above, wherein the ball call comprises a unique ball call for each of the plurality of players and a common ball call for the plurality of players,
wherein determining a result of the wager for the primary game comprises comparing the bingo card, the unique ball call of each of the plurality of users, and the common ball call to winning patterns of a result index, each winning pattern corresponding to a reward value,
wherein only a user of the plurality of users having the unique ball call corresponding to a winning pattern of the result index having a highest value is provided a corresponding reward.

2-11. A method for conducting games, comprising:
providing a primary game to a gaming system, the primary game being based on a bingo game;
providing a secondary game to a user at the gaming system;
providing an initial output from the primary game and converting the initial output to correspond with the secondary game;
receiving an input from the user for the secondary game and converting the input to correspond to the primary game;
determining a result of the wager for the primary game; and
providing an output of the secondary game to the user corresponding to the result of the wager.

2-12. The method of any one or a combination of two or more of embodiments 2-11 above and 2-13 to 2-20 below, wherein the initial output from the primary game comprises at least a bingo card and a ball call, the bingo card and the ball call corresponding to elements of the secondary game.

2-13. The method of any one or a combination of two or more of embodiments 2-11 to 2-12 above and 2-14 to 2-20 below, wherein the elements of the secondary game comprise playing cards and converting the initial output to correspond to the secondary game comprises converting the ball call to a hand of playing cards.

2-14. The method of any one or a combination of two or more of embodiments 2-11 to 2-13 above and 2-15 to 2-20 below, wherein the secondary game comprises poker.

2-15. The method of any one or a combination of two or more of embodiments 2-11 to 2-14 above and 2-16 to 2-20 below, wherein the input from the user for the secondary game corresponds to selecting betting options from the secondary game.

2-16. The method of any one or a combination of two or more of embodiments 2-11 to 2-15 above and 2-17 to 2-20 below, wherein the betting options include a choice of keeping or replacing each card of the hand of playing cards and converting the input from the user to correspond to the primary game comprises keeping or redrawing each ball of the ball call for determining a final ball call.

2-17. The method of any one or a combination of two or more of embodiments 2-11 to 2-16 above and 2-18 to 2-20 below, wherein determining a result of the wager for the primary game comprises comparing the bingo card and the final ball call to winning patterns of a result index, each winning pattern corresponding to a reward value.

2-18. The method of any one or a combination of two or more of embodiments 2-11 to 2-17 above and 2-19 to 2-20 below, wherein a plurality of ball calls are provided for each of a plurality of users, each of the plurality of users having identical bingo cards.

2-19. The method of any one or a combination of two or more of embodiments 2-11 to 2-18 above and 2-20 below, wherein determining a result of the wager for the primary game comprises comparing the bingo card and the ball call of each of the plurality of users to winning patterns of a result index, each winning pattern corresponding to a reward value,
wherein only a user of the plurality of users having the ball call corresponding to a winning pattern of the result index having a highest value is provided a corresponding reward.

2-20. The method of any one or a combination of two or more of embodiments 2-11 to 2-19 above, wherein the ball call comprises a unique ball call for each of the plurality of players and a common ball call for the plurality of players,
wherein determining a result of the wager for the primary game comprises comparing the bingo card, the unique ball call of each of the plurality of users, and the common ball call to winning patterns of a result index, each winning pattern corresponding to a reward value,
wherein only a user of the plurality of users having the unique ball call corresponding to a winning pattern of the result index having a highest value is provided a corresponding reward.

2-21. A hardware storage device having instructions stored therein, which, when executed by one or more processors of a computer device, cause the one or more processors to performing the method according to any one or a combination of two or more of embodiments 2-11 to 2-20 above.

3-1. A gaming system comprising:
a display device configured to display an output to a user;
an input device configured to accept a wager from the user for a primary game, the primary game being based on a bingo game;
a processor coupled to a memory, the input device, and the display device;
the gaming system configured to:
provide a secondary game to the user;
provide an initial output from the primary game and convert the initial output to correspond with the secondary game;
receive an input from the user for the secondary game and convert the input to correspond to the primary game;
determine a result of the wager for the primary game; and
provide an output of the secondary game to the user corresponding to the result of the wager.

3-2. The gaming system of any one or a combination of two or more of embodiments 3-1 above and 3-3 to 3-10 below, wherein the initial output from the primary game comprises at least two bingo cards, the at least two bingo cards corresponding to betting options of the secondary game.

3-3. The gaming system of any one or a combination of two or more of embodiments 3-1 to 3-2 above and 3-3 to 3-10 below, wherein converting the input to correspond to the primary game comprises selecting and/or forfeiting one or more of the at least two bingo cards.

3-4. The gaming system of any one or a combination of two or more of embodiments 3-1 to 3-3 above and 3-5 to 3-10 below, wherein the secondary game comprises blackjack.

3-5. The gaming system of any one or a combination of two or more of embodiments 3-1 to 3-4 above and 3-6 to 3-10 below, wherein providing an output of the secondary game comprises automatically providing a bonus game to the player concurrent with the secondary game.

3-6. The gaming system of any one or a combination of two or more of embodiments 3-1 to 3-5 above and 3-7 to 3-10 below, wherein the betting options in the secondary game each correspond to one of the at least two bingo cards.

3-7. The gaming system of any one or a combination of two or more of embodiments 3-1 to 3-6 above and 3-8 to 3-10 below, wherein determining a result of the wager for the primary game comprises comparing the bingo card corresponding to the selected betting options with a ball call and identifying winning patterns of a result index, each of the winning patterns corresponding to a reward value.

3-8. The gaming system of any one or a combination of two or more of embodiments 3-1 to 3-7 above and 3-9 to 3-10 below, wherein a plurality bingo cards are provided for each of a plurality of users, each of the plurality of users having bingo cards corresponding to betting options of the secondary game.

3-9. The gaming system of any one or a combination of two or more of embodiments 3-1 to 3-8 above and 3-10 below, wherein the at least two bingo cards are configured to be daubed in a stacked manner, such that spots on the at least two bingo cards are simultaneously daubed or are mutually exclusive.

3-10. The gaming system of any one or a combination of two or more of embodiments 3-1 to 3-9 above, wherein an output of the secondary game includes an initial award of the secondary game and an additional award cumulatively corresponding to the result of the wager in the primary game.

3-11. A method for conducting games, comprising:
providing a primary game to a gaming system, the primary game being based on a bingo game;
providing a secondary game to a user at the gaming system;
providing an initial output from the primary game and converting the initial output to correspond with the secondary game;
receiving an input from the user for the secondary game and converting the input to correspond to the primary game;
determining a result of the wager for the primary game; and
providing an output of the secondary game to the user corresponding to the result of the wager.

3-12. The method of any one or a combination of two or more of embodiments 3-11 above and 3-13 to 3-20 below, wherein the initial output from the primary game comprises at least two bingo cards, the at least two bingo cards corresponding to betting options of the secondary game.

3-13. The method of any one or a combination of two or more of embodiments 3-11 to 3-12 above and 3-14 to 3-20 below, wherein converting the input to correspond to the primary game comprises selecting and/or forfeiting one or more of the at least two bingo cards.

3-14. The method of any one or a combination of two or more of embodiments 3-11 to 3-13 above and 3-15 to 3-20 below, wherein the secondary game comprises blackjack.

3-15. The method of any one or a combination of two or more of embodiments 3-11 to 3-14 above and 3-16 to 3-20 below, wherein providing an output of the secondary game comprises automatically providing a bonus game to the player concurrent with the secondary game.

3-16. The method of any one or a combination of two or more of embodiments 3-11 to 3-15 above and 3-17 to 3-20 below, wherein the betting options in the secondary game each correspond to one of the at least two bingo cards.

3-17. The method of any one or a combination of two or more of embodiments 3-11 to 3-16 above and 3-18 to 3-20 below, wherein determining a result of the wager for the primary game comprises comparing the bingo card corresponding to the selected betting options with a ball call and identifying winning patterns of a result index, each winning pattern corresponding to a reward value.

3-18. The method of any one or a combination of two or more of embodiments 3-11 to 3-17 above and 3-19 to 3-20 below, wherein a plurality bingo cards are provided for each of a plurality of users, each of the plurality of users having bingo cards corresponding to betting options of the secondary game.

3-19. The method of any one or a combination of two or more of embodiments 3-11 to 3-18 above and 3-20 below, wherein the at least two bingo cards are configured to be daubed in a stacked manner, such that spots on the at least two bingo cards are simultaneously daubed or are mutually exclusive.

3-20. The method of any one or a combination of two or more of embodiments 3-11 to 3-19 above, wherein an output of the secondary game includes an initial award of the secondary game and an additional award cumulatively corresponding to the result of the wager in the primary game.

3-21. A hardware storage device having instructions stored therein, which, when executed by one or more processors of a computer device, cause the one or more processors to performing the method according to any one or a combination of two or more of embodiments 3-11 to 3-20 above.

4-1. A gaming system comprising:
a display device configured to display an output to a user;
an input device configured to accept a wager from the user for a primary game, the primary game being based on a bingo game;
a processor coupled to a memory, the input device, and the display device;
the gaming system configured to:
provide a secondary game to the user;
provide an initial output from the primary game and convert the initial output to correspond with the secondary game;
receive an input from the user for the secondary game and convert the input to correspond to the primary game;
determine a result of the wager for the primary game; and
provide an output of the secondary game to the user corresponding to the result of the wager.

4-2. The gaming system of any one or a combination of two or more of embodiments 4-1 above and 4-3 to 4-10 below, wherein the initial output from the primary game comprises at least two bingo cards, the at least two bingo cards corresponding to betting options of the secondary game and the gaming system configured to select the at least two bingo cards based on odds of available wagers in the secondary game.

4-3. The gaming system of any one or a combination of two or more of embodiments 4-1 to 4-2 above and 4-3 to 4-10 below, wherein the result of the wager for the primary game is based on subtractive patterns and/or dedaubed spaces of the at least two bingo cards.

4-4. The gaming system of any one or a combination of two or more of embodiments 4-1 to 4-3 above and 4-5 to 4-10 below, wherein the gaming system is configured to provide secondary attributes in the secondary game based on the input from the user for the secondary game, the secondary attributes corresponding to a bonus award wherein the output of the secondary game includes a static award and a bonus award cumulatively corresponding to the result of the wager in the primary game.

4-5. The gaming system of any one or a combination of two or more of embodiments 4-1 to 4-4 above and 4-6 to 4-10 below, wherein the input from the user for the secondary game includes a modified wager; and
wherein said converting the input to correspond to the primary game comprises modifying the result of the primary game according to the modified wager and converting an output of the secondary game to correspond with the modified wager for the primary game.

4-6. The gaming system of any one or a combination of two or more of embodiments 4-1 to 4-5 above and 4-7 to 4-10 below, wherein the modified wager includes a payment beyond an initial payment made in the initial wager.

4-7. The gaming system of any one or a combination of two or more of embodiments 4-1 to 4-6 above and 4-8 to 4-10 below, wherein the modified wager comprises a secondary, tertiary or more wagers.

4-8. The gaming system of any one or a combination of two or more of embodiments 4-1 to 4-7 above and 4-9 to 4-10 below, wherein the modified wager corresponds to different bingo cards of the primary game than the initial wager.

4-9. The gaming system of any one or a combination of two or more of embodiments 4-1 to 4-8 above and 4-10 below, wherein the modified wager comprises a combination of two or more bingo cards or two or more interim patterns.

4-10. The gaming system of any one or a combination of two or more of embodiments 4-1 to 4-9 above, wherein the result of the primary game is based on a time or number of daubs required to complete an interim pattern.

4-11. A method for conducting games, comprising:
providing a primary game to a gaming system, the primary game being based on a bingo game;
providing a secondary game to a user at the gaming system;
providing an initial output from the primary game and converting the initial output to correspond with the secondary game;
receiving an input from the user for the secondary game and converting the input to correspond to the primary game;
determining a result of the wager for the primary game; and
providing an output of the secondary game to the user corresponding to the result of the wager.

4-12. The method of any one or a combination of two or more of embodiments 4-11 above and 4-13 to 4-20 below, wherein the initial output from the primary game comprises at least two bingo cards, the at least two bingo cards corresponding to betting options of the secondary game and the gaming system configured to select the at least two bingo cards based on odds of available wagers in the secondary game.

4-13. The method of any one or a combination of two or more of embodiments 4-11 to 4-12 above and 4-14 to 4-20 below, wherein the result of the wager for the primary game is based on subtractive patterns and/or dedaubed spaces of the at least two bingo cards.

4-14. The method of any one or a combination of two or more of embodiments 4-11 to 4-12 above and 4-14 to 4-20 below, wherein the gaming system is configured to provide secondary attributes in the secondary game based on the input from the user for the secondary game, the secondary attributes corresponding to a bonus award wherein the output of the secondary game includes a static award and a bonus award cumulatively corresponding to the result of the wager in the primary game.

4-15. The method of any one or a combination of two or more of embodiments 4-11 to 4-14 above and 4-16 to 4-20 below, wherein the input from the user for the secondary game includes a modified wager; and
wherein said converting the input to correspond to the primary game comprises modifying the result of the primary game according to the modified wager and converting an output of the secondary game to correspond with the modified wager for the primary game.

4-16. The method of any one or a combination of two or more of embodiments 4-11 to 4-15 above and 4-17 to 4-20 below, wherein the modified wager includes a payment beyond an initial payment made in the initial wager.

4-17. The method of any one or a combination of two or more of embodiments 4-11 to 4-16 above and 4-18 to 4-20 below, wherein the modified wager comprises a secondary, tertiary or more wagers.

4-18. The method of any one or a combination of two or more of embodiments 4-11 to 4-17 above and 4-19 to 4-20 below, wherein the modified wager corresponds to different bingo cards of the primary game than the initial wager.

4-19. The method of any one or a combination of two or more of embodiments 4-11 to 4-18 above and 4-20 below, wherein the modified wager comprises a combination of two or more bingo cards or two or more interim patterns.

4-20. The method of any one or a combination of two or more of embodiments 4-11 to 4-19 above, wherein the result of the primary game is based on a time or number of daubs required to complete an interim pattern.

4-21. A hardware storage device having instructions stored therein, which, when executed by one or more processors of a computer device, cause the one or more processors to performing the method according to any one or a combination of two or more of embodiments 4-11 to 4-20 above.

5-1. A gaming system comprising:
a display device configured to display an output to a user;
an input device configured to accept a wager from the user for a primary game, the primary game being based on a bingo game;
a processor coupled to a memory, the input device, and the display device;
wherein the gaming system is configured to:
provide a secondary game to the user;
provide an initial output from the primary game and convert the initial output to correspond with the secondary game;
receive an input from the user for the secondary game and convert the input to correspond to the primary game;
determine a result of the wager for the primary game; and
provide an output of the secondary game to the user corresponding to the result of the wager.

5-2. The gaming system of any one or a combination of two or more of embodiments 5-1 above and 5-3 to 5-10 below, wherein the initial output from the primary game comprises at least a ball call, wherein at least one ball of the ball call corresponds to a supplemental state.

5-3. The gaming system of any one or a combination of two or more of embodiments 5-1 to 5-2 above and 5-3 to 5-10 below, wherein the supplemental state of the at least one ball is based on one or more preceding balls of the ball call.

5-4. The gaming system of any one or a combination of two or more of embodiments 5-1 to 5-3 above and 5-5 to 5-10 below, wherein the supplemental state is defined as the at least one ball being part of a predetermined pattern or sequence or the Fibonacci sequence when said one or more preceding balls of the ball call is part of the predetermined pattern or sequence or the Fibonacci sequence.

5-5. The gaming system of any one or a combination of two or more of embodiments 5-1 to 5-4 above and 5-6 to 5-10 below, wherein the supplemental state corresponds to a bonus game, a bonus value, extra daubs, and/or a multiplier value.

5-6. The gaming system of any one or a combination of two or more of embodiments 5-1 to 5-5 above and 5-7 to 5-10 below, wherein the supplemental state corresponds to betting options of the secondary game.

5-7. The gaming system of any one or a combination of two or more of embodiments 5-1 to 5-6 above and 5-8 to 5-10 below, wherein the secondary game comprises roulette and the supplemental states correspond to betting options including both numbers and colors of positions on a roulette wheel.

5-8. The gaming system of any one or a combination of two or more of embodiments 5-1 to 5-7 above and 5-9 to 5-10 below, wherein determining a result of the wager for the primary game comprises comparing a bingo card and the ball call to winning patterns of a result index, each winning pattern corresponding to a reward value.

5-9. The gaming system of any one or a combination of two or more of embodiments 5-1 to 5-8 above and 5-10 below, wherein each winning pattern defines a range of the ball call, such that the winning pattern only corresponds to the reward value when the winning pattern is matched during the range of the ball call.

5-10. The gaming system of any one or a combination of two or more of embodiments 5-1 to 5-9 above, wherein each winning pattern defines a range of the ball call, such that the reward value associated with the winning pattern varies based on when in the range of the ball call the winning pattern is matched.

5-11. A method for conducting games, the method comprising:
providing a primary game to a gaming system, the primary game being based on a bingo game;
providing a secondary game to a user at the gaming system;
providing an initial output from the primary game and converting the initial output to correspond with the secondary game;
receiving an input from the user for the secondary game and converting the input to correspond to the primary game;
determining a result of the wager for the primary game; and
providing an output of the secondary game to the user corresponding to the result of the wager.

5-12. The method of any one or a combination of two or more of embodiments 5-11 above and 5-13 to 5-20 below, wherein the initial output from the primary game comprises at least a ball call, wherein at least one ball of the ball call corresponds to a supplemental state.

5-13. The method of any one or a combination of two or more of embodiments 5-11 to 5-12 above and 5-14 to 5-20 below, wherein the supplemental state of the at least one ball is based on one or more preceding balls of the ball call.

5-14. The method of any one or a combination of two or more of embodiments 5-11 to 5-13 above and 5-15 to 5-20 below, wherein the supplemental state is defined as the at least one ball being part of the Fibonacci sequence when said one or more preceding balls of the ball call is part of the Fibonacci sequence.

5-15. The method of any one or a combination of two or more of 5-11 to 5-14 above and 5-16 to 5-20 below, wherein the supplemental state corresponds to a bonus game, a bonus value, extra daubs, and/or a multiplier value.

5-16. The method of any one or a combination of two or more of embodiments 5-11 to 5-15 above and 5-17 to 5-20 below, wherein the supplemental state corresponds to betting options of the secondary game.

5-17. The method of any one or a combination of two or more of embodiments 5-11 to 5-16 above and 5-18 to 5-20 below, wherein the secondary game comprises roulette and the supplemental states correspond to betting options including both numbers and colors of positions on a roulette wheel.

5-18. The method of any one or a combination of two or more of embodiments 5-11 to 5-17 above and 5-19 to 5-20 below, wherein determining a result of the wager for the primary game comprises comparing a bingo card and the ball call to winning patterns of a result index, each winning pattern corresponding to a reward value.

5-19. The method of any one or a combination of two or more of embodiments 5-11 to 5-18 above and 5-20 below, wherein each winning pattern defines a range of the ball call, such that the winning pattern only corresponds to the reward value when the winning pattern is matched during the range of the ball call.

5-20. The method of any one or a combination of two or more of embodiments 5-11 to 5-19 above, wherein each winning pattern defines a range of the ball call, such that the reward value associated with the winning pattern varies based on when in the range of the ball call the winning pattern is matched.

5-21. A hardware storage device having instructions stored therein, which, when executed by one or more processors of a computer device, cause the one or more processors to performing the method according to any one or a combination of two or more of embodiments 5-11 to 5-20 above.

6-1. A gaming system, comprising:
a display device configured to display an output pertaining to a bingo game;
an input device configured to accept a wager on one or more outcomes of the bingo game, and to accept one or more control inputs pertaining to the bingo game;
a processor; and
a memory configured to store instructions that, when executed by the processor, cause the gaming system to execute the following steps:
present a bingo card having a plurality of spaces in a grid, wherein each space has an associated identifier and a location on the card, wherein the identifiers are assigned at random;
execute a series of calls, each call including an identifier selected at random and a daub selected at random;
select a daub for each call wherein the daub is displayed on the display device on the card in a space corresponding to the identifier in the call,
wherein, for each call, the daub is randomly assigned one or more of:
a display characteristic;
a value characteristic; or
a location characteristic;
identify a combination of daubs relative to the card that satisfies one or more winning conditions; and
award a payout according to the one or more winning conditions and the wager.

6-2. The gaming system of any one or a combination of two or more of embodiments 6-1 above and 6-3 to 6-8 below, wherein the display characteristic of the daubs comprises one or more of color, movement, and shape displayed on the display device.

6-3. The gaming system of any one or a combination of two or more of embodiments 6-1 to 6-2 above and 6-3 to 6-8 below, wherein the value characteristic comprises a monetary value, and wherein the payout is correlated to the combined value characteristics of the daubs that together satisfy the winning condition for the bingo game.

6-4. The gaming system of any one or a combination of two or more of embodiments 6-1 to 6-3 above and 6-5 to 6-8 below, wherein the location characteristic comprises a number of spaces on the bingo card that are occupied by the daub.

6-5. The gaming system of any one or a combination of two or more of embodiments 6-1 to 6-4 above and 6-6 to 6-8 below, wherein the location characteristic comprises additional spaces on the card that are occupied by the daub.

6-6. The gaming system of any one or a combination of two or more of embodiments 6-1 to 6-5 above and 6-7 to 6-8 below, wherein the location characteristic comprises a row or column wildcard value, the method further comprising receiving an input from the user where to place the daub according to the wildcard value.

6-7. The gaming system of any one or a combination of two or more of embodiments 6-1 to 6-6 above and 6-8 below, wherein the gaming system is further caused present a selection of placement of a daub according to the wildcard value.

6-8. The gaming system of any one or a combination of two or more of embodiments 6-1 to 6-7 above, wherein the value characteristic comprises whether or not the calls count toward a call limit that defines a winning condition for the bingo game.

6-9. A gaming system, comprising:
a display device configured to display an output pertaining to a bingo game;
an input device configured to accept a wager on one or more outcomes of the bingo game, and to accept one or more control inputs pertaining to the bingo game;
a processor; and
a memory configured to store instructions that, when executed by the processor, cause the gaming system to execute a method, the method comprising:
presenting a first bingo card having a plurality of first spaces in a grid;
presenting a second bingo card having a plurality of second spaces in a grid, wherein the first spaces align with the second spaces; and
executing a series of calls for the first bingo card, each call including an identifier selected at random pertaining to a first space on the first bingo card resulting in a first daub placed on the first space, wherein the first daub is applied to a second space on the second bingo card as a second daub according to one or more predetermined conditions.

6-10. The gaming system of any one or a combination of two or more of embodiments 6-9 above and 6-11 to 6-15 below, wherein the predetermined conditions include a selection by a user.

6-11. The gaming system of any one or a combination of two or more of embodiments 6-9 to 6-10 above and 6-12 to 6-15 below, wherein the predetermined conditions include a random chance executed by the processor.

6-12. The gaming system of any one or a combination of two or more of embodiments 6-9 to 6-11 above and 6-13 to 6-15 below, wherein the first bingo card and second bingo card are displayed in three dimensions on the display device.

6-13. The gaming system of any one or a combination of two or more of embodiments 6-9 to 6-12 above and 6-14 to 6-15 below, wherein the display device indicates that the first daub and second daub are related.

6-14. The gaming system of any one or a combination of two or more of embodiments 6-9 to 6-13 above and 6-15 below, wherein the selection by the user is made after presenting the user with a diminished payout as a result of the selection.

6-15. The gaming system of any one or a combination of two or more of embodiments 6-9 to 6-14 above, wherein the series of calls pertains to the first bingo card and/or to the second bingo card.

6-16. A gaming system, comprising:
a display device configured to display an output to a user pertaining to a bingo game;
an input device configured to accept a wager on one or more outcomes of the bingo game, and to accept one or more control inputs from a user pertaining to the bingo game;
a processor; and
a memory configured to store instructions that, when executed by the processor, cause the gaming system to execute a method, the method comprising:
presenting to the user two or more bingo cards each having a plurality of spaces in a grid, wherein each space has an associated identifier and a location on the card, wherein the identifiers are assigned at random;
wherein the bingo cards include first spaces and second spaces visually distinct from the first spaces;
wherein arranging two or more bingo cards relative to one another forms an image combining first spaces from one bingo card and first spaces from a second bingo card; and
wherein a winning combination of calls pertains to the image.

6-17. The gaming system of embodiment 6-16 above, further comprising receiving an input from the user to arrange the bingo cards relative to one another.

7-1. A gaming system, comprising:
a display device configured to display an output pertaining to a primary game and a secondary game;
an input device configured to accept a wager on one or more outcomes of the primary game, and to accept one or more control inputs pertaining to the secondary game;
a processor; and
a memory configured to store instructions that, when executed by the processor, cause the gaming system to execute the following steps:
present a bingo card having a plurality of spaces in a grid, wherein each space has an associated identifier and a location on the card, wherein the identifiers are assigned at random;
execute a series of calls, each call including an identifier selected at random and a daub selected at random;
select a daub for each call wherein the daub is displayed on the display device on the card in a space corresponding to the identifier in the call,
wherein, for each call, the daub is randomly assigned one or more of:
a display characteristic;
a value characteristic; or
a location characteristic;
identify a combination of daubs relative to the card that satisfies one or more winning conditions;
convert the combination of daubs and the one or more winning conditions to an output for the secondary game; and
award a payout according to the one or more winning conditions and the wager;
wherein the primary game comprises a bingo game underlying the secondary game.

7-2. The gaming system of any one or a combination of two or more of embodiments 7-1 above and 7-3 to 7-8 below, wherein the display characteristic of the daubs comprises one or more of color, movement, and shape displayed on the display device.

7-3. The gaming system of any one or a combination of two or more of embodiments 7-1 to 7-2 above and 7-3 to 7-8 below, wherein the value characteristic comprises a monetary value, and wherein the payout is correlated to the combined value characteristics of the daubs that together satisfy the winning condition for the bingo game.

7-4. The gaming system of any one or a combination of two or more of embodiments 7-1 to 7-3 above and 7-5 to 7-8 below, wherein the location characteristic comprises a number of spaces on the bingo card that are occupied by the daub.

7-5. The gaming system of any one or a combination of two or more of embodiments 7-1 to 7-4 above and 7-6 to 7-8 below, wherein the location characteristic comprises additional spaces on the card that are occupied by the daub.

7-6. The gaming system of any one or a combination of two or more of embodiments 7-1 to 7-5 above and 7-7 to 7-8 below, wherein the location characteristic comprises a row or column wildcard value, the method further comprising receiving an input from the user where to place the daub according to the wildcard value.

7-7. The gaming system of any one or a combination of two or more of embodiments 7-1 to 7-6 above and 7-8 below, wherein the gaming system is further caused present a selection of placement of a daub according to the wildcard value.

7-8. The gaming system of any one or a combination of two or more of embodiments 7-1 to 7-7 above, wherein the value characteristic comprises whether or not the calls count toward a call limit that defines a winning condition for the bingo game.

7-9. A gaming system, comprising:
a display device configured to display an output pertaining to a primary game and a secondary game, the primary game comprising a bingo game underlying the secondary game;
an input device configured to accept a wager on one or more outcomes of the bingo game, and to accept one or more control inputs pertaining to the bingo game;
a processor; and
a memory configured to store instructions that, when executed by the processor, cause the gaming system to execute a method, the method comprising:
presenting a first bingo card having a plurality of first spaces in a grid;
presenting a second bingo card having a plurality of second spaces in a grid, wherein the first spaces align with the second spaces;
executing a series of calls for the first bingo card, each call including an identifier selected at random pertaining to a first space on the first bingo card resulting in a first daub placed on the first space, wherein the first daub is applied to a second space on the second bingo card as a second daub according to one or more predetermined conditions; and
converting the first daub into an output for the secondary game.

7-10. The gaming system of any one or a combination of two or more of embodiments 7-9 above and 7-11 to 7-15 below, wherein the predetermined conditions include a selection by a user.

7-11. The gaming system of any one or a combination of two or more of embodiments 7-9 to 7-10 above and 7-12 to 7-15 below, wherein the predetermined conditions include a random chance executed by the processor.

7-12. The gaming system of any one or a combination of two or more of embodiments 7-9 to 7-11 above and 7-13 to 7-15 below, wherein the first bingo card and second bingo card are displayed in three dimensions on the display device.

7-13. The gaming system of any one or a combination of two or more of embodiments 7-9 to 7-12 above and 7-14 to 7-15 below, wherein the display device indicates that the first daub and second daub are related.

7-14. The gaming system of any one or a combination of two or more of embodiments 7-9 to 7-13 above and 7-15 below, wherein the selection by the user is made after presenting the user with a diminished payout as a result of the selection.

7-15. The gaming system of any one or a combination of two or more of embodiments 7-9 to 7-14 above, wherein the series of calls pertains to the first bingo card and/or to the second bingo card.

7-16. A gaming system, comprising:
a display device configured to display an output to a user pertaining to a primary game and a secondary game, the primary game comprising a bingo game underlying the secondary game;
an input device configured to accept a wager on one or more outcomes of the bingo game, and to accept one or more control inputs from a user pertaining to the bingo game;
a processor; and
a memory configured to store instructions that, when executed by the processor, cause the gaming system to execute a method, the method comprising:
presenting to the user two or more bingo cards each having a plurality of spaces in a grid, wherein each space has an associated identifier and a location on the card, wherein the identifiers are assigned at random;
wherein the bingo cards include first spaces and second spaces visually distinct from the first spaces;
wherein arranging two or more bingo cards relative to one another forms an image combining first spaces from one bingo card and first spaces from a second bingo card; and
wherein an output of the secondary game and a winning combination of calls pertains to the image.

7-17. The gaming system of embodiment 7-16 above, further comprising receiving an input from the user to arrange the bingo cards relative to one another.

1. A gaming system comprising:
a display device configured to display an output to a user;
an input device configured to accept a wager from the user for a primary game, the primary game being based on a bingo game;
a processor coupled to a memory, the input device and the display device;
the gaming system configured to:
provide a secondary game to the user;
receive an input from the user for the secondary game and convert the user input to the wager for the primary game;
determine a result of the wager for the primary game; and
provide an output of the secondary game to the user corresponding to the result of the wager.

2. The gaming system claim 1, wherein the bingo game comprises at least a card and a call adapted to emulate the secondary game.

3. The gaming system of claim 2, wherein the card of the bingo game includes one or more columns or rows corresponding to a die,
wherein the call of the bingo game is provided column-by-column or row-by-row, and
wherein the secondary game comprises a dice game.

4. The gaming system of claim 3, wherein the dice game comprises sic bo or craps.

5. The gaming system of claim 1, wherein the input from the user for the secondary game corresponds to selecting betting options from the secondary game,
wherein the bingo game includes final results in a result index corresponding to each of the betting options of the secondary game, and
wherein converting the user input to the wager for the primary game comprises enabling the final results in the result index corresponding to the selected betting options of the secondary game.

6. The gaming system of claim 1, wherein the user input comprises an initial input and a mid-game input.

7. The gaming system of claim 1, wherein converting the user input to the wager for the primary game comprises enabling an additional final result of the result index in the primary game.

8. The gaming system of claim 7, wherein the additional final result of the result index is a sub-pattern of a winning final result of the result index or an anti-pattern that is mutually exclusive with the winning final result of the result index.

9. The gaming system of claim 1, wherein the bingo game includes a predetermined number of cards each having a unique number in a hot spot and a call corresponding to the predetermined number of cards.

10. The gaming system of claim 9, wherein converting the user input to the wager for the primary game comprises dividing the predetermined number of cards between multiple users and identifying one winner based on comparing the call to the cards of each of the multiple users.

11. A method for conducting games, comprising:
providing a primary game to a gaming system, the primary game being based on a bingo game;
providing a secondary game to a user at the gaming system;
receiving an input from the user for the secondary game and converting the user input to a wager for the primary game;
determining a result of the wager for the primary game; and
providing an output of the secondary game to the user corresponding to the result of the wager.

12. The method of claim 11, wherein the bingo game comprises at least a card and a call adapted to emulate the secondary game.

13. The method of claim 12, wherein the card of the bingo game includes one or more columns or rows corresponding to a die,
wherein the call of the bingo game is provided column-by-column or row-by-row, and
wherein the secondary game comprises a dice game.

14. The method of claim 13, wherein the dice game comprises sic bo or craps.

15. The method of claim 11, wherein the input from the user for the secondary game corresponds to selecting betting options from the secondary game,
wherein the bingo game includes final results in a result index corresponding to each of the betting options of the secondary game, and
wherein converting the user input to the wager for the primary game comprises enabling the final results in the result index corresponding to the selected betting options of the secondary game.

16. The method of claim 11, wherein the user input comprises an initial input and a mid-game input.

17. The method of claim 11, wherein converting the user input to the wager for the primary game comprises enabling an additional final result of the result index in the primary game.

18. The method of claim 17, wherein the additional final result of the result index is a sub-pattern of a winning final result of the result index or an anti-pattern that is mutually exclusive with the winning final result of the result index.

19. The method of claim 11, wherein the bingo game includes a predetermined number of cards each having a unique number in a hot spot and a call corresponding to the predetermined number of cards.

20. The method of claim 19, wherein converting the user input to the wager for the primary game comprises dividing the predetermined number of cards between multiple users and identifying one winner based on comparing the call to the cards of each of the multiple users.
